(19) United States
(12) Patent Application Publication
(10) Pub. No.: US 2025/0095045 A1
(43) Pub. Date: Mar. 20, 2025

(54) FLEXIBLE LINKED OBJECT SYSTEM USING MACHINE LEARNING TECHNIQUES

(71) Applicant: Loop Commerce, Inc., Stamford, CT (US)

(72) Inventors: Gabriel Saunkeah, Stamford, CT (US); Paul Simpson, Stamford, CT (US); Michael Hendrickson, Stamford, CT (US)

(21) Appl. No.: 18/828,687

(22) Filed: Sep. 9, 2024

Related U.S. Application Data
(60) Provisional application No. 63/583,025, filed on Sep. 15, 2023.

(51) Int. Cl. G06Q 30/0601; G06F 16/2455

(52) U.S. Cl. CPC G06Q 30/0631; G06F 16/2455

(57) ABSTRACT

Techniques are provided for using machine learning to improve capabilities of the flexible linked objects. In an example, a method involves accessing history data associated with a profile. The method further involves generating a set of options using the history data and a machine learning model. The method further involves receiving an indication of a selection of an object from the set of options. The method further involves identifying detail information associated with the selected object. The method further involves encoding a link to the detail information in a machine-readable representation, thereby generating a flexible linked object that is associated with the machine-readable representation.

### CROSS-REFERENCE TO RELATED APPLICATIONS

This application claims the benefit of U.S. Provisional Application 63/583,025, filed on Sep. 15, 2023, which is incorporated herein by reference in its entirety.

### FIELD

The present disclosure relates to flexible linked objects and more specifically, but without limitation, using artificial intelligence to determine to improve capabilities of flexible linked objects.

### SUMMARY

Various aspects of the disclosure are discussed in detail below. While specific implementations are discussed, specific implementations are provided for illustration purposes only. A person skilled in the relevant art will recognize that other components and configurations can be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described to avoid obscuring the description. References to one or an aspect in the present disclosure can be references to the same aspect or any aspect; and such references mean at least one of the aspects.

Reference to “one aspect” or “an aspect” means that a particular feature, structure, or characteristic described in connection with the aspect is included in at least one aspect of the disclosure. The appearances of the phrase “in one aspect” in various places in the specification are not necessarily all referring to the same aspect, nor are separate or alternative aspects mutually exclusive of other aspects. Moreover, various features are described which can be exhibited by some aspects and not by others.

The terms used in this specification generally have their ordinary meanings in the art, within the context of the disclosure, and in the specific context where each term is used. Alternative language and synonyms can be used for any one or more of the terms discussed herein, and no special significance should be placed upon whether a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various aspects given in this specification.

Without intent to limit the scope of the disclosure, examples of instruments, apparatus, methods and their related results according to the aspects of the present disclosure are given below. Note that titles or subtitles can be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

In some aspects, the techniques described herein relate to a computer-implemented method, including: accessing history data associated with a profile; generating, using the history data and a machine learning model, a set of options, wherein the generating includes: providing the history data associated with the profile to the machine learning model; and receiving, from the machine learning model, the set of options; receiving, at a computing device, an indication of a selection of an object from the set of options; identifying detail information associated with the selected object, wherein the detail information includes one or more numerical values; and encoding, in a machine-readable representation, a link to the detail information in a machine-readable representation, thereby generating a flexible linked object that is associated with the machine-readable representation.

In some aspects, the techniques described herein relate to a computer-implemented method, further including: receiving, at the computing device, input data including bar code data for an additional object received via a camera of the computing device, wherein the detail information is identified by querying a merchant database using the bar code data.

In some aspects, the techniques described herein relate to a computer-implemented method, further including: associating the flexible linked object with a recipient; and transmitting, to a recipient device, a communication that associates the flexible linked object with the recipient, wherein when the communication is received at a recipient device, the recipient device extracts the detail information from the machine-readable representation and generates an activation request to activate the flexible linked object, wherein the history data is associated with history information for the recipient device.

In some aspects, the techniques described herein relate to a computer-implemented method, further including: receiving a notification from the recipient device that the recipient device has activated the flexible linked object, wherein when the notification is received from the recipient device; and updating the flexible linked object based on the notification.

In some aspects, the techniques described herein relate to a computer-implemented method, further including: receiving a second selection of a second object from the set of options; and identifying second detail information associated with the second object, wherein the second detail information includes a second value; and wherein the link further facilitates access to the second detail information via the machine-readable representation.

In some aspects, the techniques described herein relate to a computer-implemented method, further including: receiving, at the computing device, second input data associated with a second object; updating the set of options in real-time as the second input data is received to generate and updated set of options using the machine learning model with the second input data; and generating a user interface including detail information for each object selected from the updated set of options.

In some aspects, the techniques described herein relate to a computer-implemented method, further including: facilitating a transaction associated with the one or more numerical values and the selected object.

In some aspects, the techniques described herein relate to a system including: memory; and one or more processors of a serverless cloud-based system coupled to the memory, the one or more processors configured to perform operations including: accessing history data associated with a profile; generating, using the history data and a machine learning model, a set of options, wherein the generating includes: providing the history data associated with the profile to the machine learning model; and receiving, from the machine learning model, the set of options; receiving, at a computing device, an indication of a selection of an object from the set of options; identifying detail information associated with the selected object, wherein the detail information includes one or more numerical values; and encoding, in a machine-readable representation, a link to the detail information in a machine-readable representation, thereby generating a flexible linked object that is associated with the machine-readable representation.

In some aspects, the techniques described herein relate to a system, wherein the one or more processors are further configured to perform operations including: receiving, at the computing device, input data including bar code data for an additional object received via a camera of the computing device, wherein the detail information is identified by querying a merchant database using the bar code data.

In some aspects, the techniques described herein relate to a system, wherein the one or more processors are further configured to perform operations including: associating the flexible linked object with a recipient; and transmitting, to a recipient device, a communication that associates the flexible linked object with the recipient, wherein when the communication is received at a recipient device, the recipient device extracts the detail information from the machine-readable representation and generates an activation request to activate the flexible linked object, wherein the history data is associated with history information for the recipient device.

In some aspects, the techniques described herein relate to a system, wherein the one or more processors are further configured to perform operations including: receiving a notification from the recipient device that the recipient device has activated the flexible linked object, wherein when the notification is received from the recipient device; and updating the flexible linked object based on the notification.

In some aspects, the techniques described herein relate to a system, wherein the one or more processors are further configured to perform operations including: receiving a second selection of a second object from the set of options; and identifying second detail information associated with the second object, wherein the second detail information includes a second value; and wherein the link further facilitates access to the second detail information via the machine-readable representation.

In some aspects, the techniques described herein relate to a system, wherein the one or more processors are further configured to perform operations including: receiving, at the computing device, second input data associated with a second object; updating the set of options in real-time as the second input data is received to generate and updated set of options using the machine learning model with the second input data; and generating a user interface including detail information for each object selected from the updated set of options.

In some aspects, the techniques described herein relate to a system, wherein the one or more processors are further configured to perform operations including: facilitating a transaction associated with the one or more numerical values and the selected object.

In some aspects, the techniques described herein relate to a non-transitory computer readable storage medium including instructions that, when executed by one or more processors of a serverless cloud-based system, cause performance of operations including: accessing history data associated with a profile; generating, using the history data and a machine learning model, a set of options, wherein the generating includes: providing the history data associated with the profile to the machine learning model; and receiving, from the machine learning model, the set of options; receiving, at a computing device, an indication of a selection of an object from the set of options; identifying detail information associated with the selected object, wherein the detail information includes one or more numerical values; and encoding, in a machine-readable representation, a link to the detail information in a machine-readable representation, thereby generating a flexible linked object that is associated with the machine-readable representation.

In some aspects, the techniques described herein relate to a non-transitory computer readable storage medium, wherein when executed by the one or more processors, the instructions cause performance of operations including: receiving, at the computing device, input data including bar code data for an additional object received via a camera of the computing device, wherein the detail information is identified by querying a merchant database using the bar code data.

In some aspects, the techniques described herein relate to a non-transitory computer readable storage medium, wherein when executed by the one or more processors, the instructions cause performance of operations including: associating the flexible linked object with a recipient; and transmitting, to a recipient device, a communication that associates the flexible linked object with the recipient, wherein when the communication is received at a recipient device, the recipient device extracts the detail information from the machine-readable representation and generates an activation request to activate the flexible linked object, wherein the history data is associated with history information for the recipient device.

In some aspects, the techniques described herein relate to a non-transitory computer readable storage medium, wherein when executed by the one or more processors, the instructions cause performance of operations including: receiving a notification from the recipient device that the recipient device has activated the flexible linked object, wherein when the notification is received from the recipient device; and updating the flexible linked object based on the notification.

In some aspects, the techniques described herein relate to a non-transitory computer readable storage medium, wherein when executed by the one or more processors, the instructions cause performance of operations including: receiving a second selection of a second object from the set of options; and identifying second detail information associated with the second object, wherein the second detail information includes a second value; and wherein the link further facilitates access to the second detail information via the machine-readable representation.

In some aspects, the techniques described herein relate to a non-transitory computer readable storage medium, wherein when executed by the one or more processors, the instructions cause performance of operations including: receiving, at the computing device, second input data associated with a second object; updating the set of options in real-time as the second input data is received to generate and updated set of options using the machine learning model with the second input data; and generating a user interface including detail information for each object selected from the updated set of options.

### BRIEF DESCRIPTION OF THE DRAWINGS

FIG. 1 depicts an example of a flexible linked object environment, in accordance with at least one aspect;

FIG. 2 depicts an example of an environment in which a flexible linked object is generated and associated with a machine-readable label;

FIGS. 3A-3B depict examples of an environment in which a flexible linked object is provided in accordance with at least one aspect;

FIGS. 4A-4C depict an example of an environment in which a recipient of a flexible linked object, through a computing device, may scan the flexible linked object to activate and assign the flexible linked object to a particular entity in accordance with at least one aspect;

FIG. 5 depicts an example of an environment in which an assignment recommendation algorithm is dynamically trained to provide recipients of flexible linked objects with assignment recommendations when requesting activation of flexible linked objects in accordance with at least one aspect;

FIG. 6 depicts an example of an environment in which a cart object may be used in accordance with at least one aspect;

FIGS. 7A-7F depict examples of an environment in which a generator of a cart for a flexible linked object, through a computing device, may associate a set of products with the flexible linked object in accordance with at least one aspect;

FIGS. 8A-8D depict examples of an environment in which a recipient of a flexible linked object, through a computing device, can manage receipt of products in a cart with the flexible linked object in accordance with at least one aspect;

FIG. 9 depict an example of an environment in which a generative artificial intelligence (AI) machine learning system is used in creation and management of a cart for a flexible linked object in accordance with at least one aspect;

FIG. 10 illustrates an example of a method associated with cart generation with a flexible linked object, in accordance with aspects described herein;

FIG. 11 illustrates an example of a method associated with cart generation with a flexible linked object, in accordance with aspects described herein; and

FIG. 12 depicts a computing system architecture including various components in electrical communication with each other using a connection in accordance with various aspects.

In the appended figures, similar components and/or features can have the same reference label. Further, various components of the same type can be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

In the following description, for the purposes of explanation, specific details are set forth to provide a thorough understanding of certain inventive aspects. However, it will be apparent that various aspects may be practiced without these specific details. The figures and description are not intended to be restrictive. The word “exemplary” is used herein to mean “serving as an example, instance, or illustration.” Any aspect or design described herein as “exemplary” is not necessarily to be construed as preferred or advantageous over other aspects or designs.

Disclosed aspects may provide a framework for flexible linked objects. Flexible linked objects, as described herein, are objects that can be provided to intended recipients while allowing the intended recipients to activate the flexible linked objects and to assign the flexible linked objects with specific entities.

Machine learning and artificial intelligence systems can be used to provide recommendations or automated limitations on flexibility of linked objects through history data (e.g., shopping cart history) or via provider selections. Senders or generators of the flexible linked objects can generate lists associated with the flexible linked object through physical device scanning and/or generative artificial intelligence. For instance, a sender or generator of a flexible linked object can us artificial intelligence to curate or select objects such as products list associated with the flexible linked object. Recipients of the flexible objects can selectively assign these flexible linked objects when activating the flexible linked objects for use, providing these recipients with flexibility in determining which entities to which the flexible linked objects may be assigned. For instance, an activated flexible linked object such as a flexible linked gift object (or gift object) can be configured with a shopping cart that includes a set of products or objects, allowing the recipient to accept the items, or to adjust the items to be received.

Through aspects described herein, a distribution service can provide a user with a set of options for defining a particular object category for a flexible object that is to be given to a particular recipient. The object category may be associated with a set of entities to which the flexible object can be assigned. The user can use a shopping cart to improve device operation by simplifying selection of items, categories, or other identified boundaries or criteria for the flexibility provided by the object. The particular recipient receiving the flexible object can scan the flexible object to identify the particular object category associated with the flexible object and select a particular entity to which the flexible object is to be assigned. As described above, machine-learning algorithms, artificial intelligence systems, user defined criteria, lists, selected categories, or other systems selected by the user can provide options to the particular recipient beyond items provided in a shopping cart with a flexible object. Upon assignment of the flexible object to the selected entity, the flexible object is activated, and the particular recipient can use the flexible object at point-of-sale locations associated with the selected entity, based on the shopping cart details and the flexibility criteria defined by the user. Generative artificial intelligence systems and/or machine learning algorithms can be used with the flexible object, such that history data for an individual or for a category of individuals can be used in the generation or modification of the set of products associated with a cart for the flexible object.

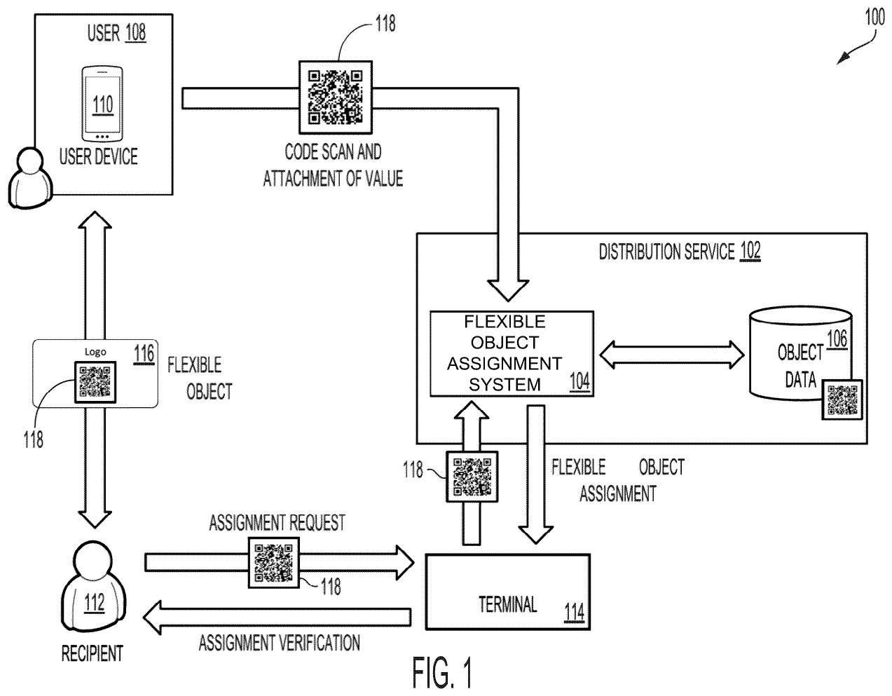

Turning now to the Figures, FIG. 1 depicts an example of a flexible linked object environment 100, in accordance with at least one aspect. In the example depicted in FIG. 1, a flexible linked object 116 is generated and provided to a recipient 112 to allow the recipient 112 to select the particular entity to which the flexible linked object 116 is to be assigned upon activation of the flexible linked object 116. In the environment 100, a user 108, through user device 110, scans a machine-readable label 118 associated with a flexible linked object 116 to assign a value or attribute to the flexible linked object 116 and define an object category for the flexible linked object 116. The machine-readable label 118 may include one or more machine-readable representations such as codes or graphics.

In some aspects, the flexible linked object 116 may be a flexible linked gift object. A flexible linked gift object may be a physical card or other object that includes a machine-readable label 118. The machine-readable label 118 may be initially unassigned. For example, data encoded in the machine-readable label 118 may not be associated with a particular monetary value associated with the flexible linked object 116. Further, the data encoded in the machine-readable label 118 may initially not be associated with a particular object category corresponding to different entities to which the flexible linked object 116 may be assigned upon activation, as described in greater detail herein. In some instances, the flexible linked object 116 may have a pre-defined monetary value that is indicated in the data encoded in the machine-readable label 118. In some cases, this pre-defined monetary value may not initially be associated with a particular object category or entity.

As illustrated in FIG. 1, the machine-readable label 118 associated with the flexible linked object 116 may be implemented as a Quick Response (QR) code that encodes identifying information associated with the flexible linked object 116, the pre-defined value associated with the flexible linked object 116 (if applicable), and a Uniform Resource Identifier (URI) corresponding to a website that may be used to assist the user 108 in associating the flexible linked object 116 with a particular object category. Further, as described in greater detail herein, through this website, the user 108 may define the monetary value associated with the flexible linked object 116 (if not previously pre-defined), as well as provide recipient information associated with the intended recipient of the flexible linked object 116. It should be noted that while QR codes are used extensively throughout the present disclosure for the purpose of illustration, other machine-readable labels may be implemented. For example, the machine-readable label 118 may be implemented using any form of one- or two-dimensional code that can be used to encode information and/or executable instructions (e.g., high capacity color barcodes, NexCode, ShotCode, Qode, Data Matrix, CrontoSign, Aztec Code, barcodes, etc.).

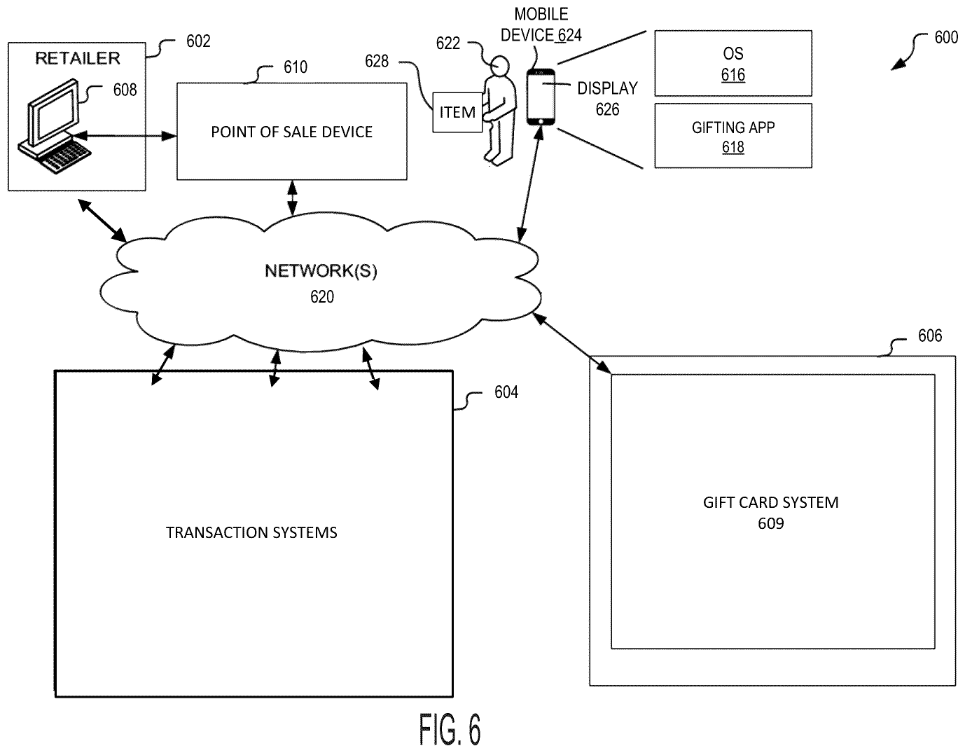

Additionally, as described in greater detail below, rather than associating a fixed value to the flexible object, the user 108 can associate one or more objects or products with the flexible object, and a prepurchase for a value of the one or more objects can set a value for the flexible object. Machine learning or generative artificial intelligence systems can be used to recommend or control modifications to the product associations in conjunction with the cart, either before or after setting of a value (e.g., via an associated payment) for the flexible object. Additional details associated with cart use, product associations, and artificial intelligence (AI)/machine learning (ML) systems is described below with respect to FIGS. 6-10.

In an aspect, when the user 108 uses user device 110 to scan the machine-readable label 118 from the flexible linked object 116, the user device 110 may automatically execute a browser application implemented on the user device 110 to access a distribution service 102 associated with the flexible linked object 116. As noted above, the machine-readable label 118 implemented on the flexible linked object 116 may encode a URI corresponding to a website through which the user 108 may associate the flexible linked object 116 with a particular object category. This website may be implemented by the distribution service 102, which may provide a web portal through which the user 108 may associate the flexible linked object 116 with a particular object category. Further, if the flexible linked object 116 has not been assigned a monetary value, the distribution service 102 may provide, through the web portal, one or more options for defining the monetary value that is to be assigned to the machine-readable label 118 and, hence, the flexible linked object 116.

In some instances, the distribution service 102 may implement a gifting application that may be installed on the user device 110 and other devices to allow users to define a flexible linked object 116 that can be provided to intended recipients. For example, when the user 108 uses their user device 110 to scan the machine-readable label 118 from the flexible linked object 116, the user device 110 may automatically execute the gifting application implemented on the user device 110. Through the gifting application, the user 108 may access the distribution service 102 to define the flexible linked object 116 that is to be provided to an intended recipient. In some instances, the gifting application may transmit, to the distribution service 102, the data encoded in the machine-readable label 118. This data may include the identifying information associated with the flexible linked object 116 and the pre-defined value associated with the flexible linked object 116, if the flexible linked object 116 has previously been assigned a pre-defined value.

The distribution service 102 may be implemented to allow the user 108 (e.g., a purchaser, a sender, etc.) to generate flexible gift objects that provide recipients an opportunity to define to which entity the flexible gift object is to be assigned. For example, as noted above, the distribution service 102 may implement a gifting application that may be installed on the user device 110 and other devices to allow users to associate a flexible linked object 116 with a particular object category to provide intended recipients with one or more options for determining which entity associated with the object category the flexible linked object 116 may be assigned to. Additionally, as noted above, the distribution service 102 may implement a web portal or website through which users may access (such as through scanning of a machine-readable label 118 implemented on a flexible linked object 116) the distribution service 102. The user device 110, upon accessing the web portal or website associated with the distribution service 102, may automatically transmit the data encoded in the machine-readable label 118 to the distribution service 102.

In an aspect, the flexible linked object distribution service 102 implements a flexible linked object that processes incoming requests to associate unassigned flexible objects with a particular object category. Further, as described in greater detail herein, the flexible linked object assignment system 104 may further process incoming requests to assign unassigned flexible gift objects to particular entities (e.g., retailers, merchants, etc.) to allow for exclusive use of these flexible gift objects for transactions associated with these particular entities. The flexible linked object flexible linked object assignment system 104 may be implemented as a computer system or application associated with the flexible linked object service 102 to provide these functionalities.

In an aspect, in response to receiving the data encoded in the machine-readable label 118 associated with the flexible linked object 116, the flexible linked object uses the provided data to query an object datastore 106 to determine whether the machine-readable label 118 can be associated with a particular object category. The object datastore 106 may include, for each machine-readable label generated by the flexible linked object distribution service 102 and implemented on a flexible object, an entry that defines one or more characteristics associated with the machine-readable label. For example, an entry corresponding to a particular machine-readable label may include a unique identifier associated with the machine-readable label, any monetary value associated with the machine-readable label, an indication as to whether the machine-readable label is assigned to a particular object category (and the corresponding object category, if so), an indication as to whether the machine-readable label is assigned to a particular entity (and the corresponding entity, if so), an indication as to whether the machine-readable label is associated with a particular recipient (and any available recipient information, if so), and the like.

If the flexible linked object assignment system 104 determines, based on an evaluation of the data associated with the machine-readable label 118, that the machine-readable label 118 is already associated with a particular object category or is already assigned to a particular entity through which exclusive use of the flexible linked object 116 has been defined, the flexible linked object assignment system 104 may transmit a notification to the user device 110 to indicate that the flexible gift object cannot be associated with a new object category. However, if the flexible linked object assignment system 104 determines that the machine-readable label 118 is not currently associated with a particular object category and has not been assigned to a particular entity, the flexible linked object assignment system 104 may provide the user 108, through the user device 110, with one or more options corresponding to different gift object categories that may be associated with the machine-readable label 118. The different gift object categories may correspond to different types of goods and/or services that may be made available through entities associated with the distribution service 102. For example, the different gift object categories may include, but are not limited to: electronics, toys, restaurants, cafés, home improvement, supermarkets, financial services, coffee, sandwiches, pizza, and the like. In some aspects, the user 108 can select flexible settings to allow purchases within a category. In some such aspects, the user 108 can place specific products in the category into a cart, and can set the value for the flexible gift object based on the products in the cart. The flexible settings can allow the recipient 112 (e.g., via a recipient device and/or the flexible linked object 116 used at the terminal 114) to make alternative purchases within limits selected by the user 108 (e.g., defined by categories and/or price limits selected by the user 108 on the user device 110, or via limits managed by an AI/ML system selected by the user 108 using the user device 110).

In an aspect, each available object category is associated with one or more entities that may provide goods and/or services related to the object category. As noted above, these entities may correspond to different retailers and merchants that may provide different goods and/or services through point-of-sale locations (e.g., brick-and-mortar storefronts, kiosks, etc.) and/or an online marketplace (e.g., websites, applications, etc.). As an example, a object category corresponding to “coffee” may be associated with one or more coffee vendors that may provide, online and/or through one or more point-of-sale locations, different coffee-related goods and/or services. As another illustrative example, a object category corresponding to “restaurants” may be associated with one or more different participating restaurants through which the flexible gift object may be used. However, it should be noted that no object category may be directly associated with an individual entity to provide recipients of flexible gift objects with an opportunity to assign the flexible gift object to an entity of their choosing. In some examples, if the object category is set to be limited to a category, the sender can select a particular instance or product, and can pay an amount associated with the product in the category, with the value associated with the flexible gift object, and available for the recipient to select delivery of the product, or of a similar product in the category, with the payment amount for the initial product used for the similar product. The sender can select an option for the automatic refund or charge of a difference amount if the similar product has a different purchase value. For such automatic charges or refunds, the sender can select a limit on the excess value (e.g., as a percentage of the value of the initial product, or a set additional charge above the value of the initial product). In some aspects, if a cart includes multiple products, a shared overage value for the entire cart can be selected. For example, if an entire cart has a value of $100, the sender can allow an automated additional payment of up to an additional $20 if the recipient selects one or more changes to the cart. In some aspects, such additional automatic charges can be conditional, such as only available if certain products are out of stock or otherwise unavailable. In some aspects, the sender can allow a specific preselected set of alternative replacement options, rather than a general category replacement option, with automated additional payments authorized as described above, or authorized for any substitution in a preapproved substitution list.

In an aspect, the flexible linked object assignment system 104 provides, in response to receiving the data encoded in the machine-readable label 118, a listing or other ordering of the available object categories that may be assigned to the machine-readable label 118. For example, if the user 108 is accessing the flexible linked object assignment system 104 through a gifting application implemented on the user device 110, the flexible linked object assignment system 104 may update an interface (e.g., graphical user interface (GUI)) associated with the gifting application to present the available gift object categories for the flexible linked object 116. As another illustrative example, if the user 108 is accessing the flexible linked object assignment system 104 through a website or web portal provided by the distribution service 102, the flexible linked object assignment system 104 may redirect the user 108 (such as through a browser application implemented on the user device 110) to a landing page through which the available gift object categories may be presented.

In some instances, the flexible linked object assignment system 104 may prompt the user 108 to provide identifying information corresponding to an intended recipient 112 of the flexible linked object 116 to provide the user 108 with tailored recommendations corresponding to different gift object categories that may be appealing to the intended recipient 112. The identifying information corresponding to a particular recipient 112 may include the recipient's name, the recipient's electronic address, the recipient's physical address, any hobbies that the recipient 112 is interested in, and the like. In some instances, the flexible linked object assignment system 104 may prompt the user to indicate if the flexible linked object 116 is being provided in commemoration of a live event associated with the intended recipient 112 (e.g., birth of a child, a birthday, an anniversary, etc.). Based on the obtained identifying information, the flexible linked object assignment system 104 may automatically construct a recipient profile associated with the intended recipient 112. In some aspects, rather than generating the profile from sender inputs, the system 104 may automatically construct a recipient profile from social media information, messaging information provided by access from the sender, or other such information. In some such aspects, a sender can interactively provide access to sender information, and receive shopping cart suggestions from a machine learning system based on the profile. The sender can then provide feedback, either in the form of selection of items from the shopping cart suggestions, profile feedback (e.g., rejecting categories identified by an automated profile generated by the AI/ML system), or any other such information which can then be used to update the profile information. Sender and recipient profiles can be stored in the system 104 for future use, and can be progressively trained over time based on sender selections, recipient feedback (e.g., acceptance and substitution selections), and any other such information.

In an aspect, the flexible linked object assignment system 104 implements one or more machine learning algorithms or artificial intelligence that are dynamically trained to provide users with recommendations corresponding to different gift object categories that may be associated with flexible gift objects and that may be appealing to recipients of these flexible gift objects. For instance, the flexible linked object assignment system 104 may implement a clustering algorithm that is dynamically trained to identify similar requests to generate flexible gift objects and similar recipient profiles based on one or more vectors (e.g., demographic information, hobbies, other provided information, etc.). In some aspects, the flexible linked object assignment system 104 can perform such clustering and obtain partial matches among other recipient profiles and/or flexible gift object requests according to these one or more vectors. In some instances, a dataset of recipient profiles and/or other flexible gift object requests may be analyzed using a clustering algorithm to identify different types of recipient profiles and/or other flexible gift object requests associated with the flexible linked object assignment system 104.

Example clustering algorithms that may trained using sample recipient profiles (e.g., recipient profiles corresponding to historical recipients of flexible gift objects, hypothetical recipient profiles corresponding to hypothetical flexible gift objects, etc.), and/or sample flexible gift object requests (e.g., actual historical flexible gift object requests, hypothetical flexible gift object requests, etc.) datasets to analyze the flexible gift object request and/or the profile of the indicated recipient so as to determine various aspects of the flexible gift object request. The example clustering algorithms may include a k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Based on the output of these algorithms, the flexible linked object assignment system 104 may determine the various aspects of the flexible gift object request.

In an aspect, the flexible linked object assignment system 104 can use the obtained identifying information associated with the intended recipient 112 as input to one or more machine learning algorithms or artificial intelligence to generate a set of object category recommendations that may be presented to the user 108. This set of object category recommendations may correspond to different gift object categories that may be associated with the flexible linked object 116 and that may correspond to different entities. From these different entities, as described in greater detail herein, an intended recipient 112 may select a particular entity that may be assigned to the flexible linked object 116 such that the flexible linked object 116 may only be used for transactions associated with the selected entity.

Once the flexible linked object assignment system 104 has generated one or more object category recommendations that may be presented to the user 108, the flexible linked object assignment system 104 may provide, through the user device 110 (such as through the gifting application or web portal/website), these one or more object category recommendations. For instance, the flexible linked object assignment system 104 may dynamically, and in real-time, update a GUI associated with the gifting application and/or the web portal/website to present the one or more object category recommendations through the user device 110. Through the GUI or other interface associated with the gifting application and/or the web portal/website, the user 108 may select a object category from the one or more object category recommendations to associate the selected object category with the flexible linked object 116 that is to be provided to the recipient 112. Based on the user's selection of a particular object category, the flexible linked object assignment system 104 may automatically, and in real-time, update the entry corresponding to the machine-readable label 118 implemented on the flexible linked object 116 to associate the machine-readable label 118 with the selected object category.

In an aspect, any selections made by the user 108 in response to the one or more object category recommendations can be used to dynamically re-train the one or more machine learning algorithms or artificial intelligence implemented to dynamically, and in real-time, provide object category recommendations to users based on any provided recipient information. For example, if the flexible linked object assignment system 104 generates, based on a particular cluster identified by the one or more machine learning algorithms or artificial intelligence, one or more object category recommendations corresponding to automotive parts, but the user selects a object category corresponding to coffee or other food-related products, the flexible linked object assignment system 104 may use this selection of an alternative object category as negative feedback indicative of a need to adjust or otherwise modify the one or more vectors and corresponding clusters maintained by the one or more machine learning algorithms or artificial intelligence such that the recipient 112, and other similarly-situated recipients are assigned similar classifications or clusters. Alternatively, if the flexible linked object assignment system 104 generates, based on a particular cluster identified by the one or more machine learning algorithms or artificial intelligence, one or more object category recommendations corresponding to baby products, and the user selects a particular object category corresponding to the provided one or more object category recommendations, the flexible linked object assignment system 104 may use this selection of a object category corresponding to baby products as positive feedback indicative of the present accuracy of the one or more vectors and corresponding clusters. This positive feedback may thus be used to further reinforce the one or more machine learning algorithms or artificial intelligence.

Based on the user's selection of a particular object category for the flexible linked object 116, the flexible linked object assignment system 104 may associate the particular object category with the machine-readable label 118 associated with the flexible linked object 116. For instance, the flexible linked object assignment system 104 may dynamically update the entry corresponding to the machine-readable label 118 associated with the flexible linked object 116 to indicate that the machine-readable label 118 is now associated with the selected object category. In some instances, the flexible linked object assignment system 104 may further update this entry to associate the machine-readable label 118 with the user 108. This may allow the recipient 112 of the flexible linked object 116 to identify the user 108 as the sender of the flexible linked object 116 when the recipient 112 scans the machine-readable label 118, as described in greater detail herein. The flexible linked object assignment system 104 may provide the user 108 with a confirmation that the flexible linked object 116 is now associated with a particular object category and a particular value (as defined by the user 108 or pre-defined by the distribution service 102). This may serve as an indication to the user 108 that the flexible linked object 116 may now be gifted to an intended recipient, such as recipient 112.

The recipient 112, upon receiving the flexible linked object 116, may scan the machine-readable label 118 implemented on the flexible linked object 116 to begin an activation process for the flexible linked object 116. For example, as illustrated in FIG. 1, the recipient 112 may scan the machine-readable label 118 associated with the flexible linked object 116 using a terminal 114. The terminal 114 may be associated with a particular retailer or merchant. As noted above, the machine-readable label 118 may encode a URI corresponding to a website or web portal associated with the distribution service 102. In some instances, the machine-readable label 118 may further encode a network address (e.g., Internet Protocol (IP) address, Media Access Control (MAC) address, etc.) associated with the distribution service 102. Using this encoded data, the terminal 114 may transmit a request to the flexible linked object assignment system 104 to determine whether the flexible linked object 116 can be assigned to the retailer or merchant associated with the terminal 114. The request may include the encoded data extracted from the machine-readable label 118.

In response to the request from the terminal 114, the flexible linked object assignment system 104 may use the received encoded data to query the object datastore 106 to identify the entry corresponding to the machine-readable label 118. As noted above, the encoded data may include a unique identifier associated with the machine-readable label 118. Accordingly, the flexible linked object assignment system 104 may query the object datastore 106 to identify an entry corresponding to this unique identifier. If the flexible linked object assignment system 104 identifies an entry corresponding to the unique identifier and, hence, the machine-readable label 118, the flexible linked object assignment system 104 may evaluate the entry in real-time to determine whether the flexible linked object 116 may be assigned to the retailer associated with the terminal 114. For example, if the machine-readable label 118 is currently assigned to another retailer such that use of the flexible linked object 116 is limited to transactions associated with this other retailer, the flexible linked object assignment system 104 may determine that the flexible linked object 116 may not be assigned to the retailer associated with the terminal 114. As another illustrative example, if the flexible linked object assignment system 104 determines that the flexible linked object 116 has not been assigned to a particular retailer or merchant but is otherwise associated with a selected object category, the flexible linked object assignment system 104 may determine whether the retailer associated with the terminal 114 corresponds to the selected object category. For instance, if the terminal 114 is associated with an automotive parts supplier but the object category associated with the flexible linked object 116 corresponds to baby products, the flexible linked object assignment system 104 may determine that the flexible linked object 116 cannot be assigned to the automotive parts supplier. However, if the terminal 114 is associated with a retailer that sells clothing and other supplies for infants and children, the flexible linked object assignment system 104 may determine that the flexible linked object 116 may be assigned to the particular retailer.

If the flexible linked object assignment system 104 determines that the flexible linked object 116 may be assigned to the particular retailer associated with the terminal 114, the flexible linked object assignment system 104 may transmit a request or instruction to the terminal 114 to prompt the recipient 112 for verification of the assignment of the flexible linked object 116 to this retailer. In response to the request or instruction, the terminal 114 (such as through a display element or GUI implemented on the terminal 114) may prompt the recipient 112 to verify that they would like to have the flexible linked object 116 assigned to the particular retailer for exclusive use in transactions associated with the retailer. If the recipient 112 verifies that the flexible linked object 116 is to be assigned for use with the particular retailer, the terminal 114 may provide the recipient's verification to the flexible linked object assignment system 104. In response to this verification, the flexible linked object assignment system 104 may update the entry corresponding to the machine-readable label 118 implemented on the flexible linked object 116 to indicate that the machine-readable label 118 is now assigned to the particular retailer. Thus, if the recipient 112 attempts to use the flexible linked object 116 for transactions not associated with the particular retailer, the transactions may be rejected, as the flexible linked object 116 is assigned for use exclusively with the particular retailer.

In an aspect, the recipient 112 can activate the flexible linked object 116 for use with a particular retailer or merchant through their own computing device. For example, the recipient 112 may use their own computing device to scan the machine-readable label 118 to submit an activation request to the flexible linked object assignment system 104. As noted above, the machine-readable label 118 implemented on the flexible linked object 116 may encode a URI corresponding to a website or web portal associated with the distribution service 102. In some instances, if the recipient 112 implements the gifting application on their computing device, when the recipient 112 uses their computing device to scan the machine-readable label 118 from the flexible linked object 116, the computing device may automatically execute the gifting application. Through the gifting application, the recipient 112 may access the distribution service 102 to activate the flexible linked object 116. In some instances, the gifting application may automatically transmit, to the distribution service 102, the data encoded in the machine-readable label 118. This data may include the unique identifier associated with the machine-readable label 118, as described above.

In response to receiving the encoded data associated with the machine-readable label 118 implemented on the flexible linked object 116, the flexible linked object assignment system 104 may query the object datastore 106 to identify an entry corresponding to the machine-readable label 118. Through this entry, the flexible linked object assignment system 104 may determine whether the machine-readable label 118 and, hence, the flexible gift object is already assigned to a particular retailer or merchant. Further, from this entry, the flexible linked object assignment system 104 may determine the value assigned to the flexible linked object 116 (as defined by the user 108 or pre-defined by the distribution service 102 upon purchase of the flexible linked object 116). In some instances, the entry corresponding to the machine-readable label 118 may include identifying information associated with the user 108 that has provided the flexible linked object 116 to the recipient 112. The identifying information may include the name of the user 108, a physical address associated with the user 108, an electronic mail address associated with the user 108, and the like. In some instances, the entry may include any custom messages or greetings defined by the user 108 when associating the flexible linked object 116 with a particular object category. For example, the user 108 may provide a custom message that states, “Congratulations on your promotion!,” “Happy Birthday!,” or any other greeting that may be germane to the purpose for which the flexible linked object 116 is being given to the recipient 112. This custom message may be provided to the recipient 112 through their computing device (such as through the gifting application or other application used to access the flexible linked object assignment system 104).

In an aspect, if the machine-readable label 118 has not been assigned to a particular retailer or merchant but is otherwise associated with a particular object category, the flexible linked object assignment system 104 may identify a set of retailers and merchants that are associated with the particular object category. As an example, if the particular object category corresponds to baby products or other baby-related goods and services, the flexible linked object assignment system 104 may automatically, and in real-time, identify any retailers and merchants that may provide baby-related goods and services. These retailers and merchants may have pre-existing relationships with the distribution service 102 and may provide information corresponding to the goods and/or services that they provide. This information may be used by the distribution service 102 to categorize each of these retailers and merchants along different gift object categories. This may allow the flexible linked object assignment system 104 to automatically, and in real-time, identify the retailers and merchants that may be associated with an indicated object category. In some instances, the distribution service 102 may associate different retailers and merchants with the different gift object categories regardless of whether these retailers and merchants have an existing relationship with the distribution service 102 or not. For example, the distribution service 102 may interact with one or more financial institutions, retailer systems, credit reporting agencies, consumer organizations, and the like to obtain information corresponding to the goods and/or services that may be provided by different retailers and merchants that may be used to categorize these retailers and merchants along the different gift object categories.

In an aspect, based on the identified object category associated with the flexible linked object 116, the flexible linked object assignment system 104 may provide the recipient 112 with one or more recommendations corresponding to one or more particular retailers or merchants that may be desirable to the recipient 112 for assignment of the flexible linked object 116. For example, in an aspect, the flexible linked object assignment system 104 may use identifying information associated with the recipient 112 (as provided by the user 108 or the recipient 112), any available historical information associated with the recipient 112 (e.g., past purchase histories, past gift redemption histories, etc.), and the object category associated with the flexible linked object 116 as input to one or more machine learning algorithms or artificial intelligence dynamically trained to generate assignment recommendations to recipients, such as recipient 112. In some instances, the flexible linked object assignment system 104 may implement a clustering algorithm that is dynamically trained to generate assignment recommendations for different recipients of flexible gift objects according to any known information associated with these recipients and the gift object categories associated with corresponding flexible gift objects.

The clustering algorithm implemented by the flexible linked object assignment system 104 may be dynamically trained to identify similar recipients and flexible gift objects based on one or more vectors (e.g., demographic information, recipient interests, event or purpose for gifting of the flexible gift objects, historical information associated with the recipients, monetary value associated with the flexible gift objects, etc.). In some aspects, the flexible linked object assignment system 104 can perform such clustering and obtain partial matches among other recipient profiles and/or other flexible gift objects according to these one or more vectors. In some instances, a dataset of recipient profiles and/or other flexible gift objects may be analyzed using a clustering algorithm to identify different types of recipient profiles and/or flexible gift objects associated with the flexible linked object assignment system 104. The clustering algorithm may be dynamically trained using sample recipient profiles (e.g., recipient profiles corresponding to historical recipients of flexible gift objects, hypothetical recipient profiles corresponding to hypothetical flexible gift objects, etc.) and/or sample flexible gift objects (e.g., actual historical flexible gift objects and corresponding assignments, hypothetical flexible gift objects and corresponding hypothetical assignments, etc.) that may be included in one or more datasets. These one or more datasets may be used to dynamically train the clustering algorithm to analyze a recipient profile associated with the recipient 112 and/or the characteristics of the flexible linked object 116 (e.g., object category associated with the flexible linked object 116, the monetary value assigned to the flexible linked object 116, information corresponding to the user 108 that generated the flexible linked object 116, recipient information provided by the user 108, any custom messages provided by the user 108 for the flexible linked object 116, etc.) to generate one or more assignment recommendations that may be provided to the recipient 112 for assignment of the flexible linked object 116 to a particular retailer or merchant.

In some instances, the flexible linked object assignment system 104 may prompt the recipient 112 for additional information that may be used to provide the recipient 112 with tailored assignment recommendations for their flexible linked object 116. For example, the flexible linked object assignment system 104 may prompt the recipient 112 to provide identifying information corresponding to the recipient 112 (e.g., name, physical address, electronic mail address, etc.) that may be used by the flexible linked object assignment system 104 to determine whether an existing recipient profile associated with the recipient 112 is available for evaluation. For instance, if the recipient 112 has previously received flexible gift objects from other users and has assigned these flexible gift objects to different retailers and/or merchants, the flexible linked object assignment system 104 may use the provide recipient information to identify a recipient profile that includes historical data corresponding to these previously received flexible gift objects and corresponding assignments. Further, from the recipient profile, the flexible linked object assignment system 104 may discern any recipient interests, hobbies, life events, and the like that may be used to inform (using the one or more machine learning algorithms or artificial intelligence) what retailers and/or merchants associated with the selected object category may be of interest to the recipient 112. In some instances, the recipient profile may include historical information corresponding to recipient purchases made through different retailers and/or merchants that may be used to identify any favored retailers and/or merchants that the recipient 112 may often frequent. Through evaluation of this historical information, the flexible linked object assignment system 104 may generate one or more assignment recommendations that include any favored retailers and/or merchants that correspond to the selected object category associated with the flexible linked object 116.

In an aspect, the flexible linked object assignment system 104 provides to the recipient 112 a set of selection options corresponding to different retailers and/or merchants to which the flexible linked object 116 may be assigned. For instance, if the recipient 112 accesses the distribution service 102 through a gifting application implemented on the recipient's computing device, the flexible linked object assignment system 104 may automatically, and in real-time, update an interface associated with the gifting application to present this set of selection options. As another illustrative example, if the recipient 112 accesses the distribution service 102 through a website or web portal associated with the distribution service 102, the flexible linked object assignment system 104 may redirect the recipient 112 to a landing page associated with the distribution service 102, through which the recipient 112 may be presented with this set of selection options.

In an aspect, the set of selection options are sorted according to the determined likelihood of the recipient 112 selecting a corresponding option. For example, any selection options corresponding to the assignment recommendations generated by the flexible linked object assignment system 104 may be prioritized over other selection options corresponding to the object category associated with the flexible linked object 116. As another example, the set of selection options may be ordered according to the known frequency at which the recipient 112 has purchased goods and/or services from the different retailers and/or merchants associated with the set of selection options. In some instances, the set of selection options may be alternatively sorted according to one or more other criteria. For example, the set of selection options may be ordered alphabetically. As another example, the set of selection options may be ordered according to the proximity between the recipient's physical address and locations associated with the myriad retailers and/or merchants associated with the object category associated with the flexible linked object 116.

In an aspect, if the recipient 112 selects, from the presented set of selection options, a particular retailer or merchant to whom the flexible linked object 116 is to be assigned, the flexible linked object assignment system 104 updates the entry corresponding to the machine-readable label 118 implemented on the flexible linked object 116 to assign the machine-readable label to the particular retailer or merchant. For instance, the flexible linked object assignment system 104 may update the entry corresponding to the machine-readable label 118 to replace the association between the machine-readable label 118 and the previously selected object category with an indication of the assignment of the machine-readable label 118 to the selected retailer or merchant. Through this update of the entry corresponding to the machine-readable label 118, the flexible linked object assignment system 104 may automatically assign the flexible linked object 116 to the selected retailer or merchant such that the flexible linked object 116 may only be used for transactions associated with the selected retailer or merchant.

In an aspect, once the assignment has been completed, the flexible linked object assignment system 104 may transmit data corresponding to the machine-readable label 118 to one or more retailer systems associated with the selected retailer or merchant to allow the selected retailer or merchant to process transactions associated with the flexible linked object 116. The data may include the unique identifier corresponding to the machine-readable label 118 and the monetary amount associated with the machine-readable label 118 and the flexible linked object 116. This may allow the retailer or merchant to process transactions involving the flexible linked object 116 locally (such as through a terminal 114 associated with the retailer or merchant) without requiring access to the distribution service 102 for processing the transaction.

If the flexible linked object assignment system 104 generated, through one or more machine learning algorithms or artificial intelligence, one or more assignment recommendations that were presented to the recipient 112 prior to assignment of a particular retailer or merchant to the flexible linked object 116, the flexible linked object assignment system 104 may use the recipient's selection of a particular retailer or merchant as feedback that may be used to dynamically, and in real-time, update the one or more machine learning algorithms or artificial intelligence. For instance, if the flexible linked object assignment system 104 generates, based on a particular cluster identified by the one or more machine learning algorithms or artificial intelligence, one or more assignment recommendations corresponding to retailers that do not have locations near the recipient 112 and/or that the recipient 112 has no history of frequenting (whether physically or online), and the recipient 112 selects a different retailer that was not recommended by the flexible linked object assignment system 104, the flexible linked object assignment system 104 may use this alternative selection of this different retailer as negative feedback that is indicative of a need to adjust or otherwise modify the one or more vectors and corresponding clusters maintained by the one or more machine learning algorithms or artificial intelligence such that the recipient 112, and other similarly-situated recipients (e.g., recipients receiving flexible gift objects associated with similar gift object categories, recipients having similar purchase histories, recipients having similar interests or life events, etc.) are assigned similar classifications or clusters. Alternatively, if the flexible linked object assignment system 104 generates, based on a particular cluster identified by the one or more machine learning algorithms or artificial intelligence, one or more assignment recommendations corresponding to retailers that the recipient 112 is known to frequent and/or have locations near the recipient 112, and the recipient 112 selects a retailer associated with the one or more assignment recommendations, the flexible linked object assignment system 104 may use this selection of this retailer as positive feedback indicative of the present accuracy of the one or more vectors and corresponding clusters. This positive feedback may thus be used to further reinforce the one or more machine learning algorithms or artificial intelligence.

Once the flexible linked object 116 has been assigned to a particular retailer, merchant, or other entity through which transactions may be performed using the flexible linked object 116, the flexible linked object assignment system 104 may provide the recipient 112 with an assignment verification to indicate that the flexible linked object 116 has been activated for use in transactions associated with the particular retailer, merchant, or other entity. The recipient 112 may proceed to use the flexible linked object 116 at locations and at online marketplaces associated with the particular retailer, merchant, or other entity to whom the flexible linked object 116 is assigned. If the recipient 112 attempts to use the flexible linked object 116 for transactions associated with other retailers, merchants, or entities that are not assigned to the flexible linked object 116, these transactions may be automatically declined. As noted above, once the assignment has been completed, the flexible linked object assignment system 104 may transmit data corresponding to the machine-readable label 118 to one or more retailer systems associated with the selected retailer or merchant to allow the selected retailer or merchant to process transactions associated with the flexible linked object 116. Since other retailers, merchants, and other entities other than the selected retailer or merchant may not have access to this data, these other retailers, merchants, and other entities may be unable to process transactions using the flexible linked object 116, as the machine-readable label 118 associated with the flexible linked object 116 may be unrecognizable or unknown to these other retailers, merchants, and other entities.

In an aspect, the flexible linked object assignment system 104 monitors, in real-time, new data associated with the recipient 112 to dynamically determine whether to recommend a re-assignment of the flexible linked object 116 to another retailer or merchant associated with the object category associated with the flexible linked object 116. As an example, the flexible linked object assignment system 104 may automatically, and in real-time, obtain location data corresponding to the recipient 112, such as through a gifting application or other application implemented on the recipient's computing device. The location data may include Global Positioning System (GPS) location data, Internet Protocol (IP)-based geolocation data, Wi-Fi positioning data, cellular trilateration data, and the like. The flexible linked object assignment system 104 may use the obtained location data in real-time to determine whether to provide the recipient 112 with a recommendation to re-assign the flexible linked object 116 to another retailer or merchant. For instance, if the flexible linked object assignment system 104 determines that the recipient 112 has been at a location for a threshold period of time (e.g., a week, two week, a month, etc.) where the retailer or merchant assigned to the flexible linked object 116 does not maintain a location or otherwise does not maintain a presence at the location, the flexible linked object assignment system 104 may use the one or more machine learning algorithms or artificial intelligence to identify other retailers or merchants that may be recommended to the recipient 112 for re-assignment of the flexible linked object 116. Based on these new assignment recommendations, the recipient 112 may opt to re-assign the flexible linked object 116 to another retailer or merchant or to maintain the assignment of the flexible linked object 116 with the current retailer or merchant. The recipient's response to the new assignment recommendations may be used to update the one or more machine learning algorithms or artificial intelligence, similar to the process described above.

In an aspect, the flexible linked object assignment system 104 further monitors, in real-time, transaction data corresponding to the flexible linked object 116 and transaction data associated with the recipient 112 to determine whether to generate one or more new assignment recommendations for the recipient 112. For example, if the flexible linked object assignment system 104 determines, based on the transaction data corresponding to the flexible linked object 116, that the flexible linked object 116 has not been used for transactions associated with the assigned retailer or merchant for a pre-defined period of time (e.g., a week, two weeks, a month, etc.), the flexible linked object assignment system 104 may provide the recipient 112 with one or more new assignment recommendations corresponding to other retailers and/or merchants that the recipient 112 may re-assign the flexible linked object 116 to. The flexible linked object assignment system 104 may use the one or more machine learning algorithms or artificial intelligence to identify these other retailers or merchants that may be recommended to the recipient 112 for re-assignment of the flexible linked object 116. Based on these new assignment recommendations, the recipient 112 may opt to re-assign the flexible linked object 116 to another retailer or merchant or to maintain the assignment of the flexible linked object 116 with the current retailer or merchant.

In an aspect, the distribution service 102 is associated with one or more other entities that may maintain transaction data corresponding to the recipient 112. For example, the distribution service 102 may be associated with a financial institution that provides different credit and/or payment instruments to consumers, such as recipient 112. If the financial institution maintains an account associated with the recipient 112, the flexible linked object assignment system 104 may obtain, in real-time, transaction data from the account. The flexible linked object assignment system 104 may evaluate the transaction data to identify any spending trends associated with the recipient 112 including, but not limited to, the frequency at which the recipient 112 may engage in transactions with different retailer and/or merchants over time. In an aspect, if the flexible linked object assignment system 104 determines that the recipient 112 has not used their flexible linked object 116 over a threshold period of time for transactions associated with the assigned retailer or merchant, the flexible linked object assignment system 104 may use the identified spending trends associated with the recipient 112 to determine whether to generate one or more new assignment recommendations according to the object category associated with the flexible linked object 116. The flexible linked object assignment system 104 may generate these one or more new assignment recommendations using the one or more machine learning algorithms or artificial intelligence, as described above.

In some instances, the recipient 112 can submit a request to the flexible linked object assignment system 104 to re-assign the flexible linked object 116 to another retailer, merchant, or other entity for use in transactions associated with this other retailer, merchant, or other entity. For example, the recipient 112, using their computing device, may scan the machine-readable label 118 associated with the flexible linked object 116 to access the flexible linked object assignment system 104 and to provide the data encoded in the machine-readable label 118. In response to obtaining this data, the flexible linked object assignment system 104 may query the object datastore 106 to identify the current assignment associated with the flexible linked object 116. The flexible linked object assignment system 104 may provide information to the recipient 112 corresponding to the present assignment associated with the flexible linked object 116. Further, the flexible linked object assignment system 104 may provide the recipient 112 with one or more options for re-assigning the flexible linked object 116 to another retailer, merchant, or entity associated with the object category associated with the flexible linked object 116. These one or more options, in an aspect, can be generated using the one or more machine learning algorithms or artificial intelligence, as described above. For instance, the one or more options may be provided based on newly generated assignment recommendations corresponding to other retailers, merchants, or entities that may be appealing to the recipient 112 for assignment to the flexible linked object 116.

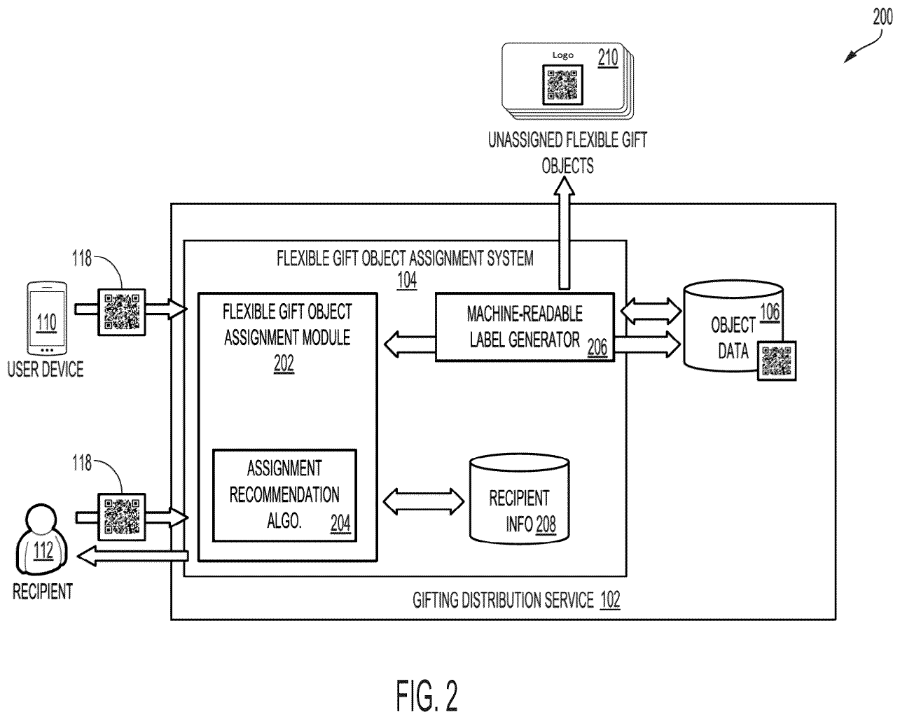

FIG. 2 depicts an example of an environment 200 in which a flexible linked object is generated and associated with a machine-readable label 118. In the example depicted, the flexible linked object can be assigned to a particular entity upon activation of the flexible gift object. In the environment 200, the distribution service 102, through the flexible linked object assignment system 104, may implement a machine-readable label generator 206 that may generate unique machine-readable labels that may be implemented on unassigned flexible gift objects 210. The machine-readable label generator 206 may be implemented as a computer system or application associated with the flexible linked object assignment system 104. Each unique machine-readable label generated by the machine-readable label generator 206 may be associated with a unique identifier that may be encoded into the machine-readable label. Further, if a machine-readable label is to be associated with a pre-determined monetary value, the machine-readable label generator 206 may further encode this pre-determined monetary value into the machine-readable label. As the machine-readable label generator 206 generates new machine-readable labels, the machine-readable label generator 206 may provide these new machine-readable labels to another entity (e.g., a printer, a gift card manufacturer, etc.) to implement these new machine-readable labels on unassigned flexible gift objects 210. This may allow users to obtain unassigned flexible gift objects 210 to request association of these unassigned flexible gift objects 210 to particular gift object categories, as described above.

In an aspect, the machine-readable label generator 206 encodes, on each machine-readable label generated for implementation on a flexible gift object, a URI corresponding to a website or web portal through which users may associate a flexible gift object with a particular gift category, assign a monetary value to the flexible gift object, provide recipient information that may be used to dynamically provide the user and the recipient with various tailored recommendations for the flexible gift object, and the like. Additionally, or alternatively, the machine-readable label generator 206 may further encode, onto a machine-readable label, executable instructions that, when processed and executed by a computing device upon scanning of the machine-readable label, may cause the computing device to execute a gifting application implemented on the computing device. The gifting application may be associated with the distribution service 102 and may provide the computing device with access to the flexible linked object assignment system 104 through one or more application programming interfaces (APIs). In some instances, if the computing device does not implement the gifting application, the executable instructions may cause the computing device to download or otherwise obtain and install the gifting application. Alternatively, if the computing device does not implement the gifting application but the data encoded on the machine-readable label includes a URI corresponding to the website or web portal associated with the distribution service 102, the computing device may execute a browser application implemented on the computing device and use the URI to access this website or web portal.

In some instances, the unassigned flexible gift objects 210 may, by default, be assigned with a particular object category. For example, particular unassigned flexible gift objects 210 may be associated with a “coffee” object category, whereby these unassigned flexible gift objects 210 may, by default, be limited for use for transactions involving coffee-related purchases. As another example, particular unassigned flexible gift objects 210 may be associated with a “baby shower” object category, whereby these unassigned flexible gift objects 210 may, by default, be limited for use for transactions involving baby-related purchases from retailers and merchants that sell clothing and other supplies for infants and children. For these particular unassigned flexible gift objects 210, the machine-readable label generator 206 may associate the data encoded in the machine-readable labels implemented on these particular unassigned flexible gift objects 210 to pre-defined object category.

As the machine-readable label generator 206 generates a new machine-readable label for a new unassigned flexible gift object 210, the machine-readable label generator 206 may create a new entry corresponding to this new machine-readable label in the object datastore 106. This new entry may be used to define one or more characteristics associated with the machine-readable label. For example, within the entry corresponding to a particular machine-readable label, the machine-readable label generator 206 may include a unique identifier associated with the machine-readable label, any pre-defined monetary value associated with the machine-readable label, an indication as to whether the machine-readable label is assigned to a particular object category (and the corresponding object category, if so), and the like. As noted above, the machine-readable label may encode data that may be used to uniquely identify the machine-readable label and the flexible gift object that implements the machine-readable label. Thus, using this data, the flexible linked object assignment system 104 may be able to query the object datastore 106 to identify the entry corresponding to this machine-readable label.

In an aspect, a user, through user device 110, a user can scan a machine-readable label 118 associated with an unassigned flexible gift object 210 to make the flexible gift object available for activation. For example, when the user, through their user device 110, scans the machine-readable label 118 implemented on an unassigned flexible gift object 210, the user may be re-directed to the flexible linked object assignment system 104 associated with the distribution service 102 to perform an initial assignment of the unassigned flexible gift object 210. For example, if the machine-readable label 118 encodes a URI corresponding to the distribution service 102, the user device 110 may automatically execute a browser application implemented on the user device 110 and use the encoded URI to access the distribution service 102. Alternatively, if the machine-readable label 118 encodes executable instructions that, when executed by the user device 110, may cause the user device 110 to execute a gifting application associated with the distribution service 102, the user device 110 may process these executable instructions to determine if the user device 110 implements the gifting application and, if so, may execute these executable instructions to initiate the gifting application on the user device 110. Alternatively, if the user device 110 does not implement the gifting application, the user device 110 may automatically obtain the gifting application from the distribution service 102 (such as through a network location through which the gifting application is made available) and install the gifting application on the user device 110 for execution of the gifting application.

As noted above, the distribution service 102 may implement a flexible linked object assignment system 104 that processes incoming requests to associate unassigned flexible gift objects with a particular object category. Further, as described in greater detail herein, the flexible linked object assignment system 104 may further process incoming requests to assign unassigned flexible gift objects to particular entities (e.g., retailers, merchants, etc.) to allow for exclusive use of these flexible gift objects for transactions associated with these particular entities. In some instances, if an unassigned flexible gift object is, by default, assigned to a particular object category, the flexible linked object assignment system 104 may allow users to provide identifying information associated with an intended recipient of the flexible gift object. As described herein, this identifying information may be used to dynamically generate assignment recommendations for the intended recipient when the intended recipient submits a request to activate the flexible gift object.

In an aspect, and as illustrated in FIG. 2, the flexible linked object assignment system 104 may implement a flexible gift object assignment module 202, which may be implemented to process incoming requests from users looking to define a flexible gift object for delivery to a recipient. Further, the flexible gift object assignment module 202 may be implemented to process incoming requests from recipients of flexible gift objects to assign these flexible gift objects to particular entities such that these flexible gift objects may only be used for transactions associated with these particular entities. The flexible gift object assignment module 202, in an aspect, is implemented on a special purpose computing device or system that is configured to process these incoming requests and automatically update entries associated with machine-readable labels associated with different flexible gift objects to associate these flexible gift objects to particular gift object categories and to assign these flexible gift objects to particular entities according to the corresponding gift object categories associated with these flexible gift objects. Further, as described in greater detail herein, this special purpose computing device or system may implement one or more machine learning algorithms or artificial intelligence (such as the assignment recommendation algorithm 204) to provide users and recipients with tailored recommendations corresponding to possible gift object categories and corresponding entities that may be associated and assigned to a particular flexible gift object.

The flexible gift object assignment module 202 may receive data encoded on a machine-readable label 118 associated with a particular flexible gift object from a user device 110 at any time. For instance, if the user uses their user device 110 to scan the machine-readable label 118, resulting in execution of a gifting application implemented on the user device 110, the gifting application, through one or more APIs, may automatically transmit the data encoded on the machine-readable label 118 to the flexible gift object assignment module 202. Alternatively, if the data encoded on the machine-readable label 118 causes the user device 110 to execute a browser application and use a URI encoded on the machine-readable label 118 to access a website or web portal associated with the distribution service 102, the browser application may automatically pass the data encoded on the machine-readable label 118 to the flexible gift object assignment module 202 through the website or web portal.

In response to receiving the data encoded in the machine-readable label 118, the flexible gift object assignment module 202 may query the object datastore 106 to identify an entry corresponding to the machine-readable label 118. As noted above, the machine-readable label generator 206 may create an entry for each machine-readable label that is implemented on an unassigned flexible gift object 210. This entry may be keyed according to the unique identifier associated with the corresponding machine-readable label such that, in response to a query including a unique identifier corresponding to the machine-readable label, the flexible gift object assignment module 202 may be able to identify the entry corresponding to the machine-readable label from the object datastore 106.

In an aspect, the flexible gift object assignment module 202 evaluates the entry corresponding to the machine-readable label 118 to determine whether the machine-readable label 118 is already associated with a particular object category and/or is already assigned to a particular entity for exclusive use with that particular entity. If the flexible gift object assignment module 202 determines that the machine-readable label 118 is already assigned to a particular entity for exclusive use with that particular entity, the flexible gift object assignment module 202 may indicate that the flexible gift object cannot be associated with a object category, as the flexible gift object has already been activated for use with the particular entity. In an aspect, if the flexible gift object assignment module 202 determines that the machine-readable label 118 is already associated with a flexible gift object, as pre-defined by the distribution service 102 or as defined by a user (e.g., the user associated with the user device 110, another user, etc.), the flexible gift object assignment module 202 may indicate that the flexible gift object has already been associated with a particular object category and, thus, prevent the user from changing the object category associated with the flexible gift object. In some instances, if the flexible gift object assignment module 202 determines that the flexible gift object was associated with a particular object category by the user associated with the user device 110, and the flexible gift card has not been activated by a recipient 112, the flexible gift object assignment module 202 may allow the user to associate the flexible gift object to another object category.

If the flexible gift object assignment module 202 determines that the machine-readable label 118 is not currently associated with a particular object category and has not been assigned to a particular entity, the flexible gift object assignment module 202 may provide a user, through the user device 110, with one or more options corresponding to different gift object categories that may be associated with the machine-readable label 118. The one or more options provided to the user device 110 by the flexible gift object assignment module 202 may be organized in the form of a listing or other ordering of the available gift object categories that may be assigned to the machine-readable label 118. As noted above, the different gift object categories may correspond to different types of goods and/or services that may be made available by entities associated with the distribution service 102. Further, the different gift object categories may correspond to different types of entities (retailer, merchants, etc.) according to the types of goods and/or services provided by these entities. These entities may provide different goods and/or services through locations (e.g., brick-and-mortar storefronts, kiosks, etc.) and/or online marketplaces (e.g., websites, applications, etc.). To provide recipients with flexibility in assigning flexible gift objects to different entities, no object category may be directly associated with an individual entity.

In an aspect, the flexible gift object assignment module 202 can prompt the user to provide identifying information associated with an intended recipient 112 of the flexible gift object. This identifying information may be used by the flexible gift object assignment module 202 to provide the user, through the user device 110, with one or more tailored recommendations corresponding to different gift object categories that may be associated with the flexible gift object and that may be appealing to the intended recipient 112. The identifying information that may be provided to the flexible gift object assignment module 202 may include the intended recipient's name, the intended recipient's physical address, the intended recipient's electronic mail address, any known interests or hobbies associated with the intended recipient 112, and the like. Additionally, the user may indicate, with the identifying information, the specific purpose for which the flexible gift object is being provided to the intended recipient 112. For example, the user may indicate that the flexible gift object is being given to the intended recipient 112 as a birthday gift for the intended recipient's child. As another example, the user may indicate that the flexible gift object is being given to the intended recipient 112 for the recipient's upcoming hiking trip through the Pyrenees. This provided information may be used to construct a recipient profile that may be stored in a recipient information datastore 208 for use in generating tailored recommendations for gift object categories that may be provided to users looking to provide intended recipients with flexible gift objects, as well as for use in generating, for these intended recipients, tailored recommendations for particular entities that may be assigned to these flexible gift objects.

In an aspect, the flexible gift object assignment module 202 can use any provided identifying information associated with the intended recipient to determine whether the flexible linked object assignment system 104 maintains, within the recipient information datastore 208, an existing recipient profile corresponding to the intended recipient. For example, the flexible gift object assignment module 202 may use the provided recipient information provided by the user to query the recipient information datastore 208 to determine whether an existing recipient profile corresponding to the intended recipient 112 is available. The existing recipient profile may have previously been generated in response to earlier requests to associate different flexible gift objects for the intended recipient 112 to different gift object categories. Further, the existing recipient profile may have previously been used to provide users and the intended recipient 112 with different object category recommendations and different assignment recommendations for these different flexible gift objects. In some instances, the existing recipient profile may include additional and/or alternative identifying information or characteristics associated with the intended recipient 112. For example, if the distribution service 102 is associated with a financial institution through which the intended recipient 112 may maintain a line of credit, the distribution service 102 may automatically update the recipient profile in real-time as this line of credit is used for different transactions. This information, as described in greater detail herein, may be used to identify any spending trends associated with the intended recipient 112 that may be used to generate tailored recommendations for gift object categories and corresponding entities that may be appealing to the intended recipient 112.

As illustrated in FIG. 2, the flexible gift object assignment module 202 may implement an assignment recommendation algorithm 204, which may be dynamically trained in real-time to provide users with recommendations corresponding to different gift object categories that may be associated with their flexible gift objects and that may be appealing to the intended recipients of these flexible gift objects. The assignment recommendation algorithm 204, in an aspect, is a clustering algorithm that is dynamically trained in real-time to identify similar requests for associating flexible gift objects with particular gift object categories and similar recipient profiles (based on the provided or otherwise obtained identifying information associated with intended recipients) based on one or more vectors of similarity (e.g., recipient demographic information, recipient hobbies or interests, recipient spending trends, purpose for providing a flexible gift object, etc.). In some instances, the flexible gift object assignment module 202, in training and using the assignment recommendation algorithm 204, may perform such clustering and obtain partial matches among other recipient profiles and/or requests to associated flexible gift objects to different gift object categories according to these one or more vectors of similarity. In an aspect, the flexible gift object assignment module 202 can use a dataset of recipient profiles (real and/or hypothetical) and corresponding requests (real and/or hypothetical) to generate the various clusters associated with the assignment recommendation algorithm 204.

In an aspect, in response to the request from the user device 110 to associate the flexible gift object to a object category, the flexible gift object assignment module 202 may use any available recipient information associated with the intended recipient 112 and any other known information corresponding to the flexible gift object (e.g., monetary value assigned to the flexible gift object, etc.) as input to the assignment recommendation algorithm 204 to generate a set of object category recommendations that may be provided to the user. As noted above, these object category recommendations may correspond to different gift object categories that may be appealing to the intended recipient 112, as determined through a processing of the available recipient information associated with the intended recipient 112. The flexible gift object assignment module 202 may provide these different object category recommendations to the user through their user device 110, which may allow the user to evaluate these recommendations and select a particular object category that is to be associated with the flexible gift object.

A selection of a particular object category for the flexible gift object can be used as feedback that may inform the flexible gift object assignment module 202 as to how the assignment recommendation algorithm 214 is to be updated to provide accurate or desired recommendations. For example, if the user selects a particular object category that was not recommended by the assignment recommendation algorithm 214 based on its evaluation of the provided recipient information and the characteristics of the flexible gift object, the flexible gift object assignment module 202 may adjust or otherwise modify the one or more vectors and corresponding clusters maintained by the assignment recommendation algorithm 214 such that the intended recipient 112 and other similarly-situated recipients are assigned similar classifications or clusters. This re-assignment may result in the assignment recommendation algorithm 214 generating more accurate or appealing object category recommendations for the user and other users. Alternatively, if the user selects a object category that was recommended by the assignment recommendation algorithm 214, the flexible gift object assignment module 202 may use this selection as a positive indicator of the assignment recommendation algorithm 214 generating accurate or appealing recommendations based on the current one or more vectors and corresponding clusters.

Once the user has provided their selection of a particular object category that is to be associated with the flexible gift object, the flexible gift object assignment module 202 may update the entry corresponding to the machine-readable label 118 implemented on the flexible gift object to associate this machine-readable label 118 with the selected object category. In some instances, the flexible gift object assignment module 202 may further associate the machine-readable label 118 with identifying information associated with the user that is to provide the flexible gift object to the intended recipient 112. For instance, the flexible gift object assignment module 202 may prompt the user to provide their name, physical address, electronic mail address, and the like that may be provided to the intended recipient 112 when activating the flexible gift object. Additionally, the flexible gift object assignment module 202 may prompt the user to provide a greeting or message that may be provided to the intended recipient 112 when the intended recipient 112 submits a request to activate the flexible gift object. The greeting or message may be provided as an audial, pictorial, and/or textual message that may be provided to the intended recipient 112.

In an aspect, the flexible gift object assignment module 202 can provide the user with confirmation of the association of the flexible gift object with the selected object category and of the monetary value associated with the flexible gift object. The confirmation may further include a set of instructions that the user may provide to the intended recipient 112 with regard to the activation process for the flexible gift object. This set of instructions, for instance, may include an instruction for the intended recipient 112 to scan the flexible gift object using their computing device or a terminal associated with a desired retailer for activating the flexible gift object and for assigning the flexible gift object to a particular retailer, merchant, or other entity. The confirmation, when received by the user through their user device 110, may serve as an indication to the user that they may now be able to provide the flexible gift object to the intended recipient 112 for their use.

When the intended recipient 112 receives a flexible gift object from a user, the recipient 112 may scan the machine-readable label 118 implemented on the flexible gift object to activate the flexible gift object for exclusive use with a particular retailer, merchant, or other entity. For instance, using a computing device, the recipient 112 may scan the machine-readable label 118 to extract the data encoded in the machine-readable label 118. As noted above, the machine-readable label 118 may encode a URI corresponding to a website or web portal associated with the distribution service 102. Further, the machine-readable label 118 may encode executable instructions that, when executed by the computing device used by the recipient 112, may cause the computing device to execute a gifting application associated with the distribution service 102. In an aspect, the machine-readable label 118 can further encode a network address (e.g., IP address, MAC address, etc.) associated with the distribution service 102 that may be used by a terminal (should the recipient attempt to activate the flexible gift object at a location) to transmit a request to the flexible gift object assignment module 202 to determine whether the flexible gift object can be assigned to the retailer or merchant associated with the terminal.

In response to obtaining the data extracted from the machine-readable label 118, the flexible gift object assignment module 202 may query the object datastore 106 to determine whether the machine-readable label 118 has been associated with a particular object category and to determine the monetary value associated with the flexible gift object. Further, if the user (e.g., sender of the flexible gift object) has provided a greeting or other message for the recipient 112, the flexible gift object assignment module 202 may retrieve this greeting or other message from the entry corresponding to the machine-readable label 118. In an aspect, if the machine-readable label 118 was scanned through a terminal associated with a particular retailer or merchant (e.g., the data provided to the flexible gift object assignment module 202 includes identifying information associated with the terminal and/or the particular merchant or retailer, etc.), the flexible gift object assignment module 202 may determine whether the flexible gift object may be assigned to the retailer or merchant associated with this terminal. For example, if the machine-readable label 118 is currently assigned to another retailer such that use of the flexible gift object is limited to transactions associated with this other retailer, the flexible gift object assignment module 202 may determine that the flexible gift object may not be assigned to the retailer or merchant associated with the terminal. As another example, if the flexible gift object assignment module 202 determines that the flexible gift object has not been assigned to a particular retailer or merchant but is otherwise associated with a selected object category, the flexible gift object assignment module 202 may automatically, and in real-time, determine whether the retailer or merchant associated with the terminal corresponds to the object category associated with the flexible gift object. If the particular retailer or merchant does not correspond to the object category associated with the flexible gift object, the flexible gift object assignment module 202 may provide an indication that the flexible gift object cannot be assigned to the particular retailer or merchant. Alternatively, if the particular retailer or merchant does correspond to the object category associated with the flexible gift object, the flexible gift object assignment module 202 may assign this particular retailer or merchant to the flexible gift object, as described herein.

If the recipient 112 submits a request to activate the flexible gift object through their own computing device or any other computing device that is not associated with a particular retailer or merchant, the flexible gift object assignment module 202 identifies a set of retailers and merchants corresponding to the particular object category associated with the flexible gift object. The flexible gift object assignment module 202 may automatically provide the recipient 112 with a listing or other ordering of the set of retailers and merchants corresponding to this particular object category. For instance, if the recipient 112 accessed the distribution service 102 through a gifting application implemented on the recipient's computing device, the flexible gift object assignment module 202 may dynamically, and in real-time, update a GUI associated with the gifting application to present the set of retailers and merchants corresponding to the object category associated with the flexible gift object. As another illustrative example, if the recipient 112 accessed the distribution service 102 through a website of web portal implemented by the distribution service 102, the flexible gift object assignment module 202 may redirect the recipient 112 to a landing page through which the recipient 112 may be presented with the set of retailers and merchants corresponding to the object category associated with the flexible gift object.

In an aspect, the flexible gift object assignment module 202 can prompt the recipient 112 to provide identifying information associated with the recipient 112 that may be used to provide the recipient 112 with tailored recommendations corresponding to different retailers, merchants, and/or other entities that may be appealing to the recipient 112 for the given object category. For instance, the flexible gift object assignment module 202 may prompt the recipient 112 to provide their name, physical address, electronic mail address, and/or any other information that may be uniquely associated with the recipient 112. Using the provided identifying information, the flexible gift object assignment module 202 may query the recipient information datastore 208 to determine whether an existing recipient profile associated with the recipient 112 is available. As noted above, a recipient profile may indicate any spending trends associated with the recipient 112 that may be used to generate tailored recommendations for retailers, merchants, and/or other entities associated with a particular object category that may be appealing to the intended recipient 112. Further, the recipient profile may include historical information corresponding to previous assignments made by the recipient 112 for previously received flexible gift objects. In some instances, if the user (e.g., sender of the flexible gift object) previously provided recipient information corresponding to the recipient 112, this recipient information may be associated with the machine-readable label 118. Accordingly, the flexible gift object assignment module 202 may automatically obtain the identifying information associated with the recipient 112 from the object datastore 106 and use this identifying information to query the recipient information datastore 208 without requiring the recipient 112 to be prompted for this identifying information.

In an aspect, the flexible gift object assignment module 202 may use the object category associated with the flexible gift object and the obtained recipient information (as provided by the recipient 112 and/or obtained from the recipient information datastore 208) as input to the assignment recommendation algorithm 204 to automatically, and in real-time, generate one or more assignment recommendations that may be provided to the recipient 112. These one or more assignment recommendations may correspond to one or more particular retailers, merchants, or other entities associated with the object category that may be appealing to the recipient 112 for assignment of the flexible gift object. In some instances, if the flexible gift object assignment module 202 determines that additional information associated with the recipient 112 may be beneficial in providing more accurate recommendations to the recipient 112, the flexible gift object assignment module 202 may prompt the recipient 112 for this additional information. This additional information may be used to supplement the existing recipient profile associated with the recipient 112 maintained in the recipient information datastore 208.

As the assignment recommendation algorithm 204 generates one or more assignment recommendations for the recipient 112, the flexible gift object assignment module 202 may provide these assignment recommendations to the recipient 112 as a set of assignment selection options corresponding to different retailers, merchants, and/or other entities to which the flexible gift object may be assigned. For instance, if the recipient 112 accesses the distribution service 102 through a gifting application implemented on the recipient's computing device, the flexible gift object assignment module 202 may automatically, and in real-time, update an interface associated with the gifting application to present this set of assignment selection options. As another illustrative example, if the recipient 112 accesses the distribution service 102 through a website or web portal associated with the distribution service 102, the flexible gift object assignment module 202 may redirect the recipient 112 to a landing page associated with the distribution service 102, through which the recipient 112 may be presented with this set of selection options.

As noted above, the set of assignment selection options may be automatically sorted based on a determined likelihood of the recipient 112 selecting a corresponding assignment selection option. For example, any assignment selection options corresponding to the assignment recommendations generated by the assignment recommendation algorithm 204 may be prioritized over other selection options corresponding to the object category associated with the flexible linked object 116 that may not have been recommended by the assignment recommendation algorithm 204. As another example, the set of assignment selection options may be ordered according to the known frequency at which the recipient 112 has purchased goods and/or services from the different retailers, merchants, and/or other entities associated with the set of assignment selection options, as determined through the recipient profile associated with the recipient 112. In some instances, the set of assignment selection options may be alternatively sorted according to one or more other criteria. For example, the set of assignment selection options may be ordered alphabetically. As another example, the set of assignment selection options may be ordered according to the proximity between the recipient's physical address and point-of-sale locations associated with the myriad retailers and/or merchants associated with the object category associated with the flexible gift object.

If the recipient 112 selects a particular retailer, merchant, or other entity that is to be assigned to the flexible gift object for exclusive use of the flexible gift object with this particular retailer, merchant, or other entity, the flexible gift object assignment module 202 may automatically update the entry corresponding to the machine-readable label 118 implemented on the flexible gift object to complete this assignment. The resulting entry, for instance, may include an indication of the object category associated with the machine-readable label 118, as well as an indication of the retailer, merchant, or other entity that has been assigned to the machine-readable label 118. Through this update, the flexible gift object may be designated for use exclusively with the assigned retailer, merchant, or other entity.

As noted above, once a flexible gift object has been assigned to a particular retailer, merchant, or other entity, the flexible linked object assignment system 104 may transmit data corresponding to the machine-readable label 118 to one or more systems associated with the assigned retailer, merchant, or other entity to allow the assigned retailer, merchant, or other entity to process transactions associated with the flexible gift object. This data may include the unique identifier corresponding to the machine-readable label 118 and the monetary amount associated with the flexible linked object 116. This may allow the assigned retailer, merchant, or other entity to process transactions involving the flexible gift object locally (such as through a point-of-sale terminal associated with the assigned retailer, merchant, or other entity) without requiring access to the distribution service 102 for processing the transaction.

In an aspect, any selections made by the recipient 112 for assignment of the flexible gift object to a particular retailer, merchant, or other entity from the provided assignment recommendations and other assignment selection options may be used to dynamically, and in real-time, update the assignment recommendation algorithm 204. For instance, if the recipient 112 selects a particular retailer, merchant, or other entity that was not recommended by the assignment recommendation algorithm 204 through its assignment recommendations, the flexible gift object assignment module 202 may denote this selection as negative feedback that is indicative of a need to adjust or otherwise modify the one or more vectors and corresponding clusters maintained by the assignment recommendation algorithm 204 such that the recipient 112, and other similarly-situated recipients (e.g., recipients receiving flexible gift objects associated with similar gift object categories, recipients having similar purchase histories, recipients having similar interests or life events, etc.) are assigned similar classifications or clusters, thereby improving the accuracy of the assignment recommendations generated by the assignment recommendation algorithm 204. Alternatively, if the recipient 112 assigns the flexible gift object to a particular retailer, merchant, or other entity that was recommended by the assignment recommendation algorithm 204, the flexible gift object assignment module 202 may use this selection of the particular retailer, merchant, or other entity as positive feedback that may be used to further reinforce the assignment recommendation algorithm 204.

In response to the recipient's selection of a particular retailer, merchant, or other entity that is to be assigned to the flexible gift object, and once the flexible gift object assignment module 202 has updated the entry corresponding to the machine-readable label 118 associated with the flexible gift object to record this assignment, the flexible gift object assignment module 202 may provide the recipient 112 with a notification to indicate that the flexible gift object has been activated for exclusive use with the selected retailer, merchant, or other entity. This may allow the recipient 112 to use the flexible gift object for transactions associated with the selected retailer, merchant, or other entity. Further, if the recipient 112 attempts to use the flexible gift object for transactions associated with other retailers, merchants, or other entities that are not assigned to the flexible gift object, these transactions may be automatically declined.

In an aspect, the flexible gift object assignment module 202 can continue to monitor transactions associated with the flexible gift object, as well as any spending trends associated with the recipient 112, in real-time to determine whether to provide the recipient 112 with one or more recommendations for re-assigning the flexible gift object to another retailer, merchant, or other entity. As noted above, the flexible gift object assignment module 202 may automatically, and in real-time, obtain location data associated with the recipient 112 (such as through a gifting application or other application implemented on the recipient's computing device), that may be used to determine whether to provide the recipient 112 with a recommendation to re-assign the flexible gift object to another retailer, merchant, or other entity. Returning to an earlier illustrative example, if the flexible gift object assignment module 202, through evaluation of the location data associated with the recipient 112, determines that the recipient 112 has been at a location for a threshold period of time where the assigned entity does not maintain a point-of-sale location or otherwise does not maintain a presence at the location, the flexible gift object assignment module 202 may use the assignment recommendation algorithm 204 described herein to identify other retailers, merchants, or other entities that may correspond to this location and that may be recommended to the recipient 112 for re-assignment of the flexible gift object. The recipient 112 may evaluate these new assignment recommendations and determine whether to re-assign the flexible gift object to another retailer, merchant, or other entity. This determination by the recipient 112 may be used to dynamically update the assignment recommendation algorithm 204, similar to the process described above for updating the assignment recommendation algorithm 204 according to recipient selection of an assignment option for the flexible gift object.

As noted above, the flexible linked object assignment system 104 may maintain, in a recipient information datastore 208, a recipient profile corresponding to each recipient of a flexible gift object. A recipient profile corresponding to the recipient 112 may include data corresponding to spending trends associated with recipient 112, as determined through an evaluation of transactions associated with the recipient 112 and provided through one or more financial institutions, credit reporting agencies, and other entities associated with the distribution service 102. In an aspect, the flexible gift object assignment module 202 may, in real-time, monitor these transactions and corresponding spending trends associated with the recipient 112 to determine whether to provide the recipient 112 with one or more recommendations for re-assigning the flexible gift object to another retailer, merchant, or other entity. Returning to an earlier illustrative example, if the flexible gift object assignment module 202 determines that the flexible gift object has not been used for transactions associated with the assigned retailer, merchant, or other entity over a threshold period of time, the flexible gift object assignment module 202 may use the assignment recommendation algorithm 204 to generate one or more new assignment recommendations corresponding to other retailers, merchants, or entities that may be assigned to the flexible gift object. Based on the recipient's response to these new assignment recommendations (e.g., request to re-assign the flexible gift object to another retailer, merchant, or other entity, rejection of the new assignment recommendations, etc.), the flexible gift object assignment module 202 may dynamically update the assignment recommendation algorithm 204.

In some instances, the recipient 112 may desire to re-assign the flexible gift object to another retailer, merchant, or other retailer absent any recommendations from the flexible gift object assignment module 202. For instance, the recipient 112, using their computing device, may scan the machine-readable label 118 to access the flexible gift object assignment module 202 and request re-assignment of the associated flexible gift object to another retailer, merchant, or other retailer. In response to obtaining the data encoded on the machine-readable label 118, the flexible gift object assignment module 202 may query the object datastore 106 to identify the current assignment associated with the flexible gift object. The flexible gift object assignment module 202 may provide information corresponding to the present assignment to the recipient 112. Additionally, the flexible gift object assignment module 202 may provide the recipient 112 with one or more options for re-assigning the flexible gift object to another retailer, merchant, or entity associated with the object category associated with the flexible gift object. These one or more assignment options may be generated using the assignment recommendation algorithm 204, as described above. These one or more assignment options, for instance, may be provided based on newly generated assignment recommendations corresponding to other retailers, merchants, or entities that may be appealing to the recipient 112 and that may be assigned to the flexible gift object. If the recipient 112 selects another retailer, merchant, or entity for assignment to the flexible gift object, the flexible gift object assignment module 202 may update the entry corresponding to the machine-readable label 118 implemented on the flexible gift object to reflect this change in assignment.

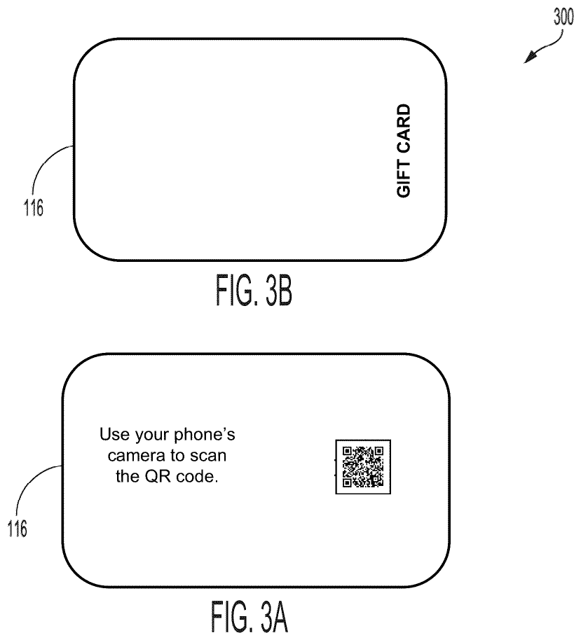

FIGS. 3A-3B depict examples of an environment 300 in which a flexible linked object 116 is provided in accordance with at least one aspect. In the environment 300, and as illustrated in FIGS. 3A-3B, the flexible linked object 116 may be implemented as a physical card that includes one or more elements that may be used to indicate one or more characteristics of the flexible linked object 116 and that may be used to both associate the flexible linked object 116 with a particular object category and to assign the flexible linked object 116 to a particular retailer, merchant, or other entity associated with the particular object category. For example, as illustrated in FIG. 3A, the flexible linked object 116 may include an image that is representative of a object category that is assigned to the flexible linked object 116 by default. For instance, the image of cupcakes and cups of coffee (as illustrated in FIG. 3A) may serve as an indication that the flexible linked object 116 is associated with a “coffee” object category, whereby the flexible linked object 116, by default, is to be limited for use in transactions involving coffee-related purchases. In some instances, the image presented on the flexible linked object 116 may be generic, in that the image may not be representative of a particular object category that is, by default, associated with the flexible linked object 116. This may provide the gifting distribution service with flexibility in customizing the appearance of flexible gift objects for different purposes.

As illustrated in FIG. 3B, the flexible linked object 116, on an obverse side of the flexible linked object 116, may include a unique machine-readable label 118 that may initially be unassigned to a particular retailer, merchant, or other entity. For instance, when a sender of the flexible linked object 116 first obtains the flexible linked object 116 (such as through the gifting distribution service or other entity that makes unassigned flexible gift objects available for purchase), the machine-readable label 118 may not be associated with a particular retailer, merchant, or other entity. However, if the flexible linked object 116 is, by default, associated with a particular object category, the machine-readable label 118 may be associated with this particular object category. Alternatively, if the flexible linked object 116 is not initially associated with a particular object category, the machine-readable label 118 may also be unassociated with any object category.

As noted above, the machine-readable label 118 may encode data that may be used to uniquely identify the machine-readable label 118 and the flexible linked object 116 that implements the machine-readable label 118. This data may include a unique identifier associated with the machine-readable label 118 and the flexible linked object 116. Further, this unique identifier may be associated with an entry in an object datastore maintained by the gifting distribution service, through which the gifting distribution service may associate the machine-readable label 118 with a particular object category, a particular retailer, merchant, or other entity, and with a monetary value, as described above. In addition to encoding data that may uniquely identify the machine-readable label 118 and the flexible linked object 116, the machine-readable label 118 may further encode a URI corresponding to a website or web portal through which users may associate the flexible linked object 116 with a particular gift category, assign a monetary value to the flexible linked object 116, provide recipient information that may be used to dynamically provide the user and the recipient with various tailored recommendations for the flexible linked object 116, and the like. Additionally, and or alternatively, the machine-readable label 118 may encode executable instructions that, when processed and executed by a computing device upon scanning of the machine-readable label 118, may cause the computing device to execute a gifting application implemented on the computing device. The gifting application may be associated with the gifting distribution service and may provide the computing device with access to the gifting distribution service through one or more APIs, as described above.

It should be noted that while a QR code is used to represent the machine-readable label 118 in FIG. 3B, flexible gift objects may be implemented with different types of machine-readable labels. For example, the machine-readable label 118 may be implemented using any form of one- or two-dimensional code that can be used to encode information and/or executable instructions (e.g., high capacity color barcodes, NexCode, ShotCode, Qode, Data Matrix, CrontoSign, Aztec Code, barcodes, etc.).

A sender of the flexible linked object 116 may scan the machine-readable label 118 using their computing device to access the gifting distribution service, as described above, to associate the flexible linked object 116 with a particular object category. If the flexible linked object 116 is already associated with a particular object category by default, the sender of the flexible linked object 116 may be prompted to assign a monetary value to the flexible linked object 116 (if not already assigned upon purchase of the flexible linked object 116 or otherwise assigned by default). Additionally, through the gifting distribution service, the sender of the flexible linked object 116 may be prompted to provide any information associated with the intended recipient, which may be used to dynamically generate one or more assignment recommendations that may be presented to the recipient when they scan the machine-readable label 118, as described above. In some instances, through the gifting distribution service, the sender of the flexible linked object 116 may further provide a custom greeting or message that may be presented to the recipient when they scan the machine-readable label 118. The information provided by the sender of the flexible linked object 116 may be associated with the entry corresponding to the machine-readable label 118 maintained by the gifting distribution service. This may allow the gifting distribution service to automatically retrieve this information from the entry when the recipient scans the machine-readable label 118 to request assignment of the flexible linked object 116 to a particular retailer, merchant, or other entity.

In some instances, the flexible linked object 116 may include one or more instructions for scanning the machine-readable label 118 to assign the flexible linked object 116 to a particular retailer, merchant, or other entity. For example, as illustrated in FIG. 3B, the flexible linked object 116 may include the instruction “Use your phone's camera to scan the QR code and get your gift.” This instruction may indicate, to a recipient of the flexible linked object 116, that they are to use their computing device (e.g., a mobile phone, etc.) to scan the machine-readable label 118 implemented on the flexible linked object 116 to activate the flexible linked object 116. As noted above, the machine-readable label 118 may encode a URI corresponding to a website or web portal provided by the gifting distribution service, through which the recipient may assign the flexible linked object 116 to a particular retailer, merchant, or other entity. Additionally, the machine-readable label 118 may further encode executable instructions that, when executed by the recipient's computing device, may cause the computing device to execute a gifting application associated with the gifting distribution service. Through this gifting application, the recipient may be presented with different assignment selection options for assigning the flexible linked object 116 to a particular retailer, merchant, or other entity, as described above.

Once the recipient of the flexible linked object 116 has assigned the flexible linked object 116 to a particular retailer, merchant, or other entity through the gifting distribution service, the flexible linked object 116 may be deemed activated for exclusive use with the particular retailer, merchant, or other entity. As noted above, if the recipient attempts to use the flexible linked object 116 with a different retailer, merchant, or other entity other than the one assigned to the flexible linked object 116, any corresponding transactions associated with this different retailer, merchant, or other entity may be automatically rejected or otherwise not recognized by the different retailer, merchant, or other entity. In some instances, the recipient may scan the machine-readable label 118 at any time after assignment to a different retailer, merchant, or other entity to access the gifting distribution service to request re-assignment of the flexible linked object 116 to a different retailer, merchant, or other entity, as described above.

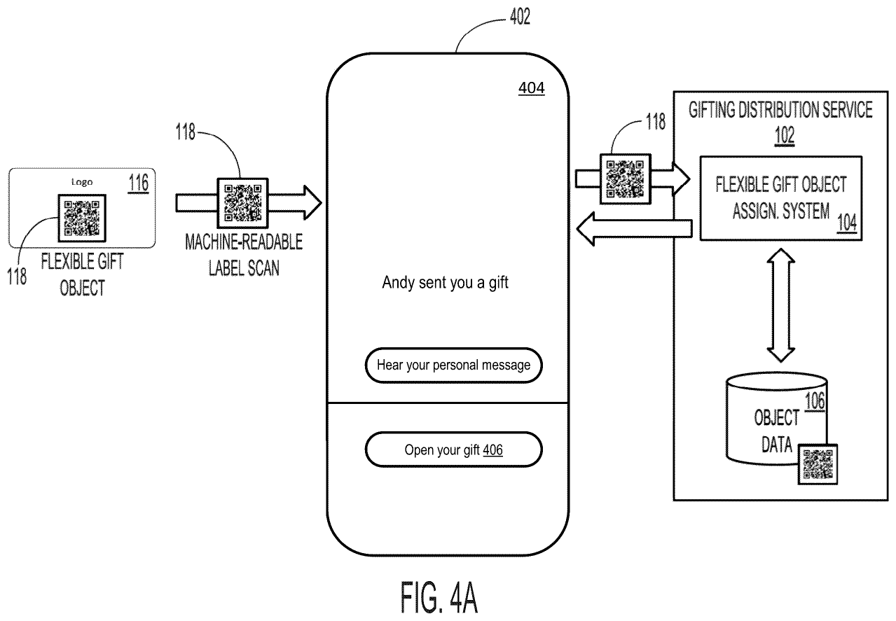

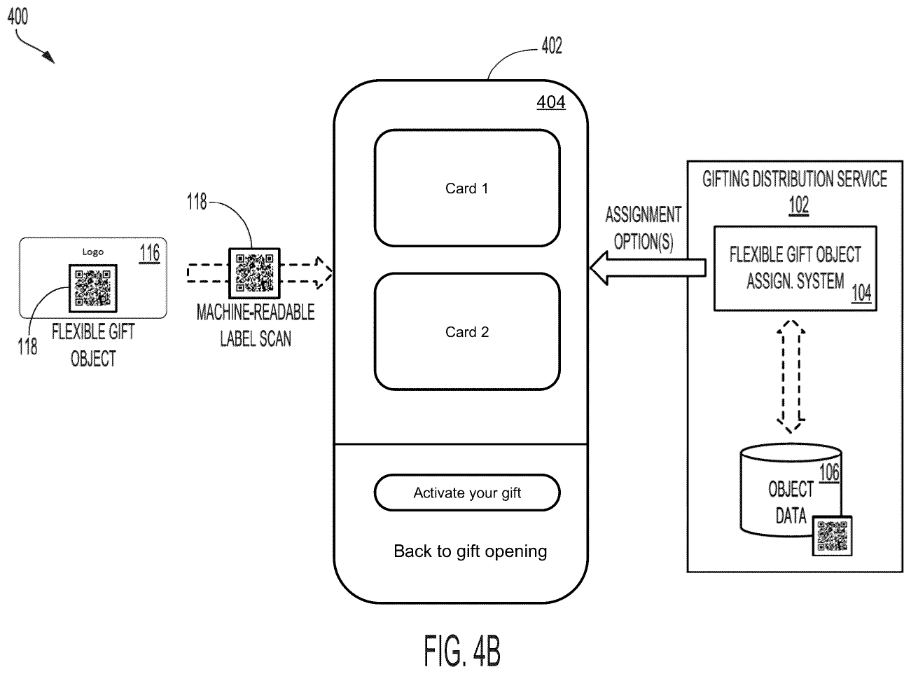

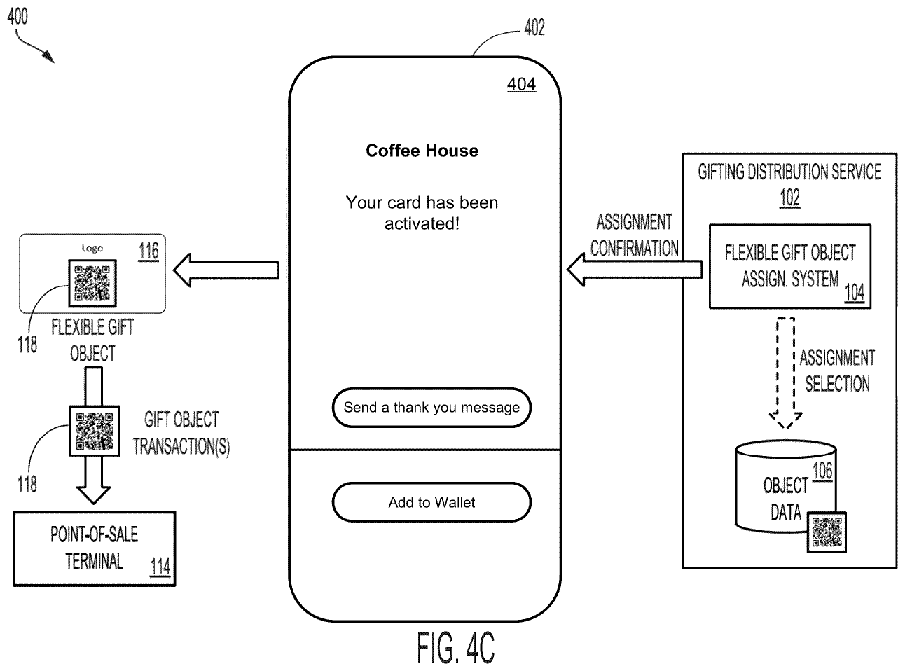

FIGS. 4A-4C depict an example of an environment 400 in which a recipient of a flexible linked object 116, through a computing device 402, may scan the flexible linked object 116 to activate and assign the flexible linked object 116 to a particular entity in accordance with at least one aspect. In the environment, and as illustrated in FIG. 4A, a recipient of a flexible linked object 116 may use their computing device 402 to scan a machine-readable label 118 implemented on the flexible linked object 116 to request activation of the flexible linked object 116. As noted above, and illustrated in FIG. 3B, the flexible linked object 116 may include a set of instructions that may instruct the recipient to scan the machine-readable label 118 using their computing device 402 to redeem their gift (e.g., activate the flexible linked object 116 for their use).

As noted above, the machine-readable label 118 may encode a URI corresponding to a website or web portal provided by the distribution service 102, through which the recipient may assign the flexible linked object 116 to a particular retailer, merchant, or other entity. Additionally, the machine-readable label 118 may further encode executable instructions that, when executed by the recipient's computing device 402, may cause the computing device 402 to execute a gifting application associated with the distribution service 102. Through this gifting application, the recipient may be presented with different assignment selection options for assigning the flexible linked object 116 to a particular retailer, merchant, or other entity, as described in greater detail herein.

As illustrated in FIG. 4A, when the recipient uses their computing device 402 to scan the machine-readable label 118, the distribution service 102, through the flexible linked object assignment system 104, may update the computing device 402 to provide a GUI 404 through which the recipient may receive their gift. The GUI 404 may be provided through a website or web portal associated with the distribution service 102. For instance, if the machine-readable label 118 encodes the URI corresponding to this website or web portal, and the computing device 402 does not implement a gifting application associated with the distribution service 102, the computing device 402 may automatically execute a browser application implemented on the computing device 402. The browser application may automatically use the URI encoded in the machine-readable label 118 to access the website or web portal associated with the distribution service 102. In some instances, the GUI 404 may be provided through the gifting application provided by the distribution service 102 and that may be implemented on the computing device 402. For instance, if the computing device 402 implements this gifting application, the computing device 402 may automatically execute the gifting application in response to the executable instructions encoded on the machine-readable label 118 and obtained upon scanning of the machine-readable label 118. The gifting application may access the flexible linked object assignment system 104 through one or more APIs implemented by the distribution service 102. Accordingly, the flexible linked object assignment system 104, through these APIs, may provide the GUI 404 to the gifting application.

In an aspect, when the recipient scans the machine-readable label 118 using their computing device 402, the computing device 402 may provide (such as through the gifting application or the website/web portal provided by the distribution service 102) the data encoded on the machine-readable label 118 to the flexible linked object assignment system 104. As noted above, the encoded data may include a unique identifier associated with the machine-readable label 118 and the flexible linked object 116. In response to receiving the data encoded in the machine-readable label 118 associated with the flexible linked object 116, the flexible linked object assignment system 104 uses the provided data to query an object datastore 106 to identify an entry corresponding to the machine-readable label 118. An entry corresponding to the machine-readable label 118 may indicate the object category that is associated with the flexible linked object 116 as defined by a sender of the flexible linked object 116 or by default by the distribution service 102. Additionally, this entry corresponding to the machine-readable label 118 may indicate the monetary value associated with the flexible linked object 116 and that may be available to the recipient. In some instances, the entry may further include identifying information associated with the sender of the flexible linked object 116. For example, the sender of the flexible linked object 116 may provide their name, physical address, electronic mail address, and the like. Further, in some instances, the entry may include a custom greeting or message provided by the sender of the flexible linked object 116 that may be presented to the recipient when the recipient accesses the distribution service 102 to activate their flexible linked object 116.

Based on the information included in the entry corresponding to the machine-readable label 118, the flexible linked object assignment system 104 may dynamically, and in real-time, update the GUI 404 to provide the recipient with information regarding their flexible linked object 116. For example, as illustrated in FIG. 4A, the flexible linked object assignment system 104 may present, through the GUI 404, information corresponding to the sender of the flexible linked object 116. For instance, as illustrated in FIG. 4A, the flexible linked object assignment system 104 can update the GUI 404 to provide an indication of who has provided the flexible linked object 116 to the recipient (e.g., “Andy sent you a gift”). Further, through the GUI 404, the flexible linked object assignment system 104 may provide the recipient with an option to receive any custom greetings or messages provided by the sender of the flexible linked object 116. For example, as illustrated in FIG. 4A, the flexible linked object assignment system 104 may indicate that the sender of the flexible linked object 116 (e.g., “Andy”) has provided an audial “personal message” for the recipient. Accordingly, through the GUI 404, the flexible linked object assignment system 104 may provide one or more interface elements that may be used by the recipient to access any custom greetings or messages provided by the sender of the flexible linked object 116.

Through the GUI 404, the flexible linked object assignment system 104 may further provide the recipient with an option to begin the activation process for the flexible linked object 116. For example, as illustrated in FIG. 4A, the flexible linked object assignment system 104 may provide the recipient with an activation button 406 or other interface element that, when selected, may cause the computing device 402 to transmit a request to the flexible linked object assignment system 104 to initiate an assignment process for assigning a particular retailer, merchant, or other entity to the flexible linked object 116 according to the object category associated with the flexible linked object 116. Accordingly, when the recipient selects the activation button 406, the flexible linked object assignment system 104 may begin to identify a set of possible assignment options corresponding to the object category associated with the flexible linked object 116.

As illustrated in FIG. 4B, the recipient has selected the activation button 406 and the flexible linked object assignment system 104 has updated the GUI 404 to provide the recipient with a set of assignment options for the flexible linked object 116. As noted above, the flexible linked object assignment system 104 may implement an assignment recommendation algorithm that is dynamically trained, in real-time, to provide assignment recommendations corresponding to different retailers, merchants, and/or other entities associated with a particular object category and that may be appealing to the recipient. In an aspect, the flexible linked object assignment system 104 uses the object category associated with the flexible linked object 116 and any available recipient information (as provided by the recipient 112 through their computing device 402 and/or obtained from the recipient information datastore, as described above) as input to the assignment recommendation algorithm to automatically, and in real-time, generate the one or more assignment recommendations that may be provided to the recipient. In some instances, if the flexible linked object assignment system 104 determines that additional information associated with the recipient may be beneficial in providing more accurate recommendations to the recipient, the flexible linked object assignment system 104 may prompt the recipient, through the GUI 404, for this additional information. This additional information may be used to supplement the existing recipient profile associated with the recipient, as described above.

Any recommendations generated by the assignment recommendation algorithm implemented by the flexible linked object assignment system 104 may be presented to the recipient through the GUI 404 as a set of assignment selection options corresponding to different retailers, merchants, and/or other entities to which the flexible linked object 116 may be assigned. For example, as illustrated in FIG. 4B, the flexible linked object assignment system 104, through the GUI 404, may provide the recipient with various graphical representations of different retailers, merchants, and/or other entities to which the flexible linked object 116 may be assigned. These various graphical representations may further represent the different assignment options available to the recipient, thus allowing the recipient to select a particular graphical representation of a retailer, merchant, or other entity to indicate their selection of a particular assignment option. As illustrated in FIG. 4B, a graphical representation of a particular retailer, merchant, or other entity may include identifying information corresponding to this particular retailer, merchant, or other entity. For instance, a particular graphical representation may include the name of the entity, any trademarks or logos associated with the entity, information corresponding to any of the goods and/or services provided by the entity, information corresponding to different point-of-sale locations associated with the entity, and the like.

In some instances, the graphical representation of the different assignment selection options presented to the recipient through the GUI 404 may be automatically sorted based on a determined likelihood of the recipient selecting a corresponding assignment selection option. As noted above, any assignment selection options corresponding to the assignment recommendations generated by the assignment recommendation algorithm may be prioritized over other selection options corresponding to the object category associated with the flexible linked object 116 that may not have been recommended by the assignment recommendation algorithm. Alternatively, in some instances, the set of assignment selection options presented through the GUI 404 may be ordered by the flexible linked object assignment system 104 according to the known frequency at which the recipient 112 has purchased goods and/or services from the different retailers, merchants, and/or other entities associated with the set of assignment selection options. The graphical representation of the different assignment selection options presented to the recipient through the GUI 404 may be sorted, in some instances, alphabetically without regard to any known recipient trends or to the generated assignment selection option recommendations. As another example, the graphical representation of the different assignment selection options may be sorted according to the proximity between the recipient's physical address and point-of-sale locations associated with the corresponding retailers, merchants, and other entities associated with these assignment selection options.

The recipient, through the GUI 404, can select a particular assignment selection option corresponding to a particular retailer, merchant, or other entity. For example, through the GUI 404, the recipient may select a graphical representation of a particular retailer, merchant, or other entity to indicate their request to assign the flexible linked object 116 to this particular retailer, merchant, or other entity. When a recipient selects a particular graphical representation of a particular retailer, merchant, or other entity, the flexible linked object assignment system 104 may, in real-time, update the GUI 404 to provide the recipient with verification regarding their selection. When the recipient selects the graphical representation corresponding to “Philz Coffee,” the flexible linked object assignment system 104 may dynamically update the GUI 404 to highlight this graphical representation corresponding to “Philz Coffee®” and supplement this graphical representation with a checkmark that may be superimposed over this graphical representation. However, it should be noted that the flexible linked object assignment system 104 may use any mechanism for providing the recipient with verification of their selection of a particular assignment selection option through the GUI 404 (e.g., text verification, boxing of the option, removing any unselected options, increasing the size of the graphical representation associated with selected option, decreasing the size of the graphical representations associated with any unselected options, etc.).

In an aspect, when the recipient selects a particular assignment selection option through the GUI 404, the flexible linked object assignment system 104 can dynamically update the GUI 404 to provide the recipient with one or more options to confirm their selection and finalize assignment of the flexible linked object 116 to the selected retailer, merchant, or other entity. The flexible linked object assignment system 104 may update the GUI 404 to allow the recipient to select an activation button 408 through which the recipient may confirm their selection of a particular assignment option and to submit a request to activate the flexible linked object 116 with the retailer, merchant, or other entity associated with the particular assignment option. Once the recipient selects the activation button 408, the computing device 402 may transmit the recipient's selection of the particular assignment selection option and a corresponding request to assign the flexible linked object 116 to the retailer, merchant, or other entity associated with the particular assignment selection option.

In response to the assignment request from the recipient, the flexible linked object assignment system 104 may record the particular assignment selection option selected by the recipient in the entry corresponding to the machine-readable label 118 implemented on the flexible linked object 116. The updated entry in the object datastore 106 may include an indication of the object category associated with the machine-readable label 118, as well as an indication of the retailer, merchant, or other entity that has been assigned to the machine-readable label 118. Through this update, the flexible gift object may be designated for use exclusively with the assigned retailer, merchant, or other entity.

Once the flexible linked object assignment system 104 has updated the entry corresponding to the machine-readable label 118 implemented on the flexible linked object 116 to assign the flexible linked object 116 to the selected retailer, merchant, or other entity, the flexible linked object assignment system 104 may update the GUI 404 to indicate that the flexible linked object 116 has been activated for exclusive use with the selected retailer, merchant, or other entity. For example, as illustrated in FIG. 4C, the flexible linked object assignment system 104 may update the GUI 404 to indicate that the recipient may now use their flexible linked object 116 at any Peet's Coffee® point-of-sale location. Further, the flexible linked object assignment system 104 may provide, through the GUI 404, instructions for how to use the flexible linked object 116 at point-of-sale locations associated with the selected retailer, merchant, or other entity. For example, as illustrated in FIG. 4C, the flexible linked object assignment system 104 may instruct the recipient to scan the machine-readable label 118 at any terminal 114 associated with the assigned recipient, merchant, or other entity to be able to use the flexible linked object 116 for transactions associated with the assigned recipient, merchant, or other entity.

As noted above, once a flexible linked object 116 has been assigned to a particular retailer, merchant, or other entity, the flexible linked object assignment system 104 may transmit data corresponding to the machine-readable label 118 implemented on the flexible linked object 116 to one or more systems associated with the assigned retailer, merchant, or other entity. This may allow the assigned retailer, merchant, or other entity to process transactions associated with the flexible linked object 116 when the recipient scans the machine-readable label 118 through a point-of-sale terminal 114 associated with the assigned retailer, merchant, or other entity. This data may include the unique identifier corresponding to the machine-readable label 118 and the monetary amount associated with the flexible linked object 116. This may allow the assigned retailer, merchant, or other entity to process transactions involving the flexible gift object locally (such as through a point-of-sale terminal 114 associated with the assigned retailer, merchant, or other entity) without requiring access to the distribution service 102 for processing of the transaction.

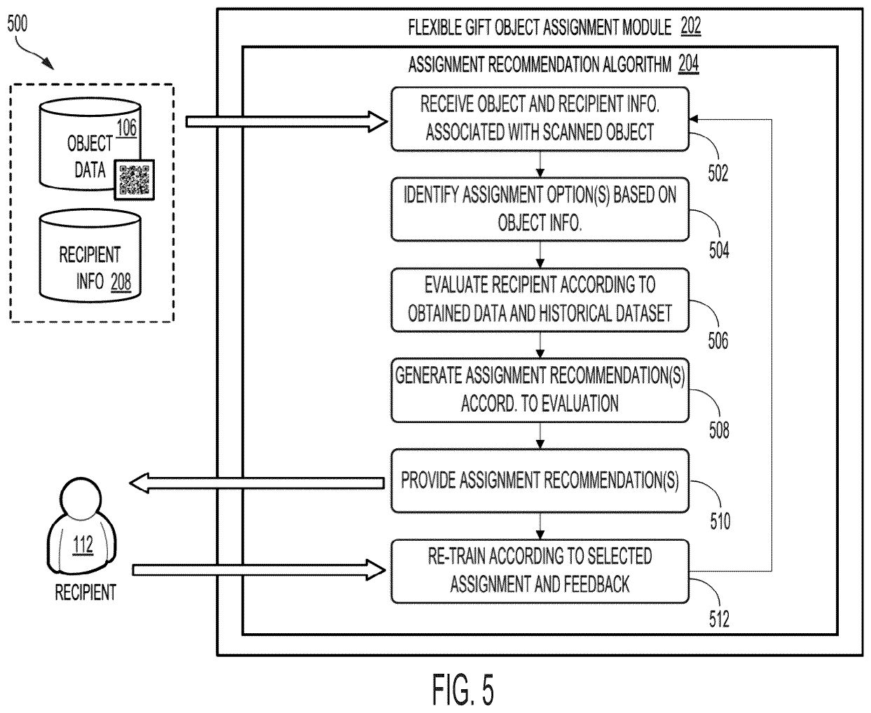

FIG. 5 depicts an example of an environment 500 in which an assignment recommendation algorithm 204 is dynamically trained to provide recipients of flexible gift objects with assignment recommendations when requesting activation of flexible gift objects in accordance with at least one aspect. As noted above, a recipient 112 of a flexible gift object may scan the machine-readable label implemented on the flexible gift object to access the flexible gift object assignment system to request assignment of the flexible gift object to a particular retailer, merchant, or other entity. Through this request, the recipient's computing device may transmit data extracted from the machine-readable label that may be used to uniquely identify the machine-readable label and identify one or more characteristics of the flexible gift object that implements the machine-readable label. For instance, the data extracted from the machine-readable label may include a unique identifier corresponding to the machine-readable label and, hence, the flexible gift object.

The flexible gift object assignment module 202, in an aspect, uses the unique identifier corresponding to the machine-readable label and provided by the recipient 112, to identify an entry corresponding to the machine-readable label from an object datastore 106. As noted above, the entry corresponding to the machine-readable label may indicate the object category associated with the flexible gift object, as well as the monetary value assigned to the flexible gift object, information corresponding to the sender of the flexible gift object, a custom greeting or message provided by the sender of the flexible gift object, and identifying information associated with the intended recipient (e.g., recipient 112) of the flexible gift object (e.g., recipient name, recipient electronic mail address, etc.). If the entry includes identifying information associated with the intended recipient, the flexible gift object assignment module 202 may query a recipient information datastore 208 to obtain additional information associated with the recipient 112 that may be used to provide tailored recommendations to the recipient 112 corresponding to different retailers, merchants, and/or other entities that may be appealing to the recipient 112 for assignment to the flexible gift object, as described herein. Alternatively, the flexible gift object assignment module 202 may prompt the recipient to provide additional information about the recipient 112 that may be used to provide these tailored recommendations.

In the environment 500, the flexible gift object assignment module 202 may provide the obtained information corresponding to the machine-readable label implemented on the flexible gift object, as well as any available information corresponding to the recipient 112, to the assignment recommendation algorithm 204 to generate these tailored recommendations corresponding to different retailers, merchants, and/or other entities that may be appealing to the recipient 112 for assignment to the flexible gift object. Thus, at step 502, the assignment recommendation algorithm 204 may receive information corresponding to the flexible gift object and to the intended recipient of the flexible gift object.

At step 504, the assignment recommendation algorithm 204 may identify a set of assignment options based on the information associated with the flexible gift object. As noted above, the flexible gift object may be associated with a particular object category. For example, a sender of the flexible gift object may scan an unassigned flexible gift object to assign a monetary value to the flexible gift object and to indicate the object category for the flexible gift object. Alternatively, the flexible gift object may, by default (e.g., without user intervention), be assigned with a particular object category. A object category may be associated with different retailers, merchants, and other entities that may provide goods and/or services related to the object category. Returning to an earlier illustrative example, a object category corresponding to “coffee” may be associated with one or more coffee vendors that may provide, online and/or through one or more point-of-sale locations, different coffee-related goods and/or services. As another illustrative example, a object category corresponding to “restaurants” may be associated with one or more different participating restaurants through which the flexible gift object may be used. Thus, based on the identified object category associated with the flexible gift object, the assignment recommendation algorithm 204 can identify the different retailers, merchants, and other entities that are associated with this particular object category.

At step 506, the assignment recommendation algorithm 204 may evaluate the obtained recipient information corresponding to the recipient 112 according to the identifying information associated with the recipient 112 (as provided by the sender of the flexible gift object or the recipient 112), any available historical information associated with the recipient 112 (e.g., past purchase histories, past gift redemption histories, etc.), and the object category associated with the flexible gift object. The assignment recommendation algorithm 204 may use this provided information to identify similar recipients and flexible gift objects based on one or more vectors of similarity (e.g., demographic information, recipient interests, event or purpose for gifting of the flexible gift objects, historical information associated with the recipients, monetary value associated with the flexible gift objects, etc.). The assignment recommendation algorithm 204 may obtain partial matches among other recipient profiles and/or other flexible gift objects according to these one or more vectors of similarity. Through these partial matches, the assignment recommendation algorithm 204 may identify a particular cluster that best matches the characteristics of the recipient 112 and of the corresponding flexible gift object provided to the recipient 112. From this cluster, the assignment recommendation algorithm 204, at step 508, may identify a set of retailers, merchants, and/or other entities associated with the object category that may be recommended to the recipient 112 as possible assignment selection options for the flexible gift object.

At step 510, the assignment recommendation algorithm 204 may provide the generated assignment recommendations to the recipient 112. As noted above, as the assignment recommendation algorithm 204 generates one or more assignment recommendations for the recipient 112, the flexible gift object assignment module 202 may provide these assignment recommendations to the recipient 112 as a set of assignment selection options corresponding to different retailers, merchants, and/or other entities to which the flexible gift object may be assigned. For instance, if the recipient 112 accesses the gifting distribution service through a gifting application implemented on the recipient's computing device, the flexible gift object assignment module 202 may automatically, and in real-time, update an interface associated with the gifting application to present this set of assignment selection options. As another illustrative example, if the recipient 112 accesses the gifting distribution service through a website or web portal associated with the gifting distribution service, the flexible gift object assignment module 202 may redirect the recipient 112 to a landing page associated with the gifting distribution service, through which the recipient 112 may be presented with this set of selection options.

The assignment recommendation algorithm 204 may provide, for the generated assignment recommendations, a sorting or other listing of the corresponding assignment selection options according to a determined likelihood of the recipient 112 selecting a corresponding assignment selection option. For instance, the set of assignment selection options recommended by the assignment recommendation algorithm 204 may be prioritized over any other available assignment selection options that are not recommended by the assignment recommendation algorithm 204. In some instances, the flexible gift object assignment module 202 may evaluate the assignment recommendations generated by the assignment recommendation algorithm 204 and rank these assignment recommendations according to a known frequency at which the recipient 112 has engaged the corresponding retailers, merchants, and/or other entities associated with these assignment recommendations. As another illustrative example, the flexible gift object assignment module 202 may sort the set of assignment selection options according to the recipient's proximity to point-of-sale locations associated with the myriad retailers and/or merchants associated with the generated assignment recommendations. In some instances, the set of assignment selection options may be sorted based on objective criteria not associated with the recipient 112. For example, the set of assignment selection options may be sorted alphabetically or based on a popularity of the set of assignment selection options amongst a set of recipients associated with the gifting distribution service over time.

At step 512, the assignment recommendation algorithm 204 may be re-trained or otherwise updated according to the recipient's selection of a particular assignment selection option for their flexible gift object. For instance, if the recipient 112 selects a particular retailer, merchant, or other entity that was not recommended by the assignment recommendation algorithm 204, the flexible gift object assignment module 202 may denote this selection as negative feedback that is indicative of a need to adjust or otherwise modify the one or more vectors and corresponding clusters maintained by the assignment recommendation algorithm 204 such that the recipient 112, and other similarly-situated recipients are assigned similar classifications or clusters, thereby improving the accuracy of the assignment recommendations generated by the assignment recommendation algorithm 204. Alternatively, if the recipient 112 assigns the flexible gift object to a particular retailer, merchant, or other entity that was recommended by the assignment recommendation algorithm 204, the flexible gift object assignment module 202 may use this selection of the particular retailer, merchant, or other entity as positive feedback that may be used to further reinforce the assignment recommendation algorithm 204.

It should be noted that the operations performed by the assignment recommendation algorithm 204, as illustrated in FIG. 5, may be performed simultaneously for any number of recipients of flexible gift objects, in real-time, and as these recipients submit requests to active their flexible gift objects for use with selected retailers, merchants, and/or other entities. For instance, the assignment recommendation algorithm 204 may generate and provide different assignment recommendations to different recipients in real-time as their requests are received by the flexible gift object assignment module 202. Further, as different recipients make different assignment option selections, the assignment recommendation algorithm 204 may be continuously re-trained or otherwise updated in real-time as these assignment option selections are made by these recipients.

FIG. 6 depicts an example of an environment 600 in which a cart object may be used in accordance with at least one aspect. Environment 600 includes systems which can generate data that can be merged or otherwise used with a flexible gift card in accordance with aspects described herein. The example environment 600 includes a retailer operating merchant system 602, transaction systems 604, and a gift card system 609. In some systems, aspects can be merged or implemented in various configurations. The elements and connections between elements in environment 600 are an example, and other implementations and configurations are possible within the scope of the described aspects. Aspects are described below in the context of a gifting app 618 of a customer 622 mobile device 624 being used to activate a flexible gift object with one or more items 628 in a cart associated with the flexible gift object. In other implementations, a point of sale device 610, or a merchant scanning device can be used in place of the gifting app 618 operating on the mobile device 624. The retailer (e.g., a merchant) includes a retail computing system 608 having information on item(s) 628. A scanning device, the mobile device 624, a device 610, or another such device can scan barcodes of item(s) 628 to receive information associated with the device in software associated with flexible gift objects as described above. The information can be presented to the customer 622 as part of prepayment and/or activation of a flexible gift object in conjunction with the gift card system 609. The gift card system 609 can manage activation of flexible gift objects as described above, as well as use of a cart associated with a flexible gift object and other systems to manage values (e.g., payment or purchase values) and flexibility of item selection (e.g., set by category or other rules associated with a flexible gift object). As items 628 are scanned and/or loaded into a cart, the gift card system 609 can present options associated with flexible gift object functionality to the customer 622, including AI/ML suggestions for alternative items as described above. As a customer 622 scans additional items 628 in the merchant store (e.g., bar codes, stock keeping unit values, etc., using a camera of the mobile device 624) the gift card system 609 can continuously update profile information, suggestions, and other information for a flexible gift object cart. The gift card system can further facilitate a prepayment when the items 628 in a cart are finalized, so that the items in the virtual cart associated with the flexible gift object are fully paid for. A recipient can then accept the objects in the cart, reject the objects in the cart, or modify the objects in the cart as detailed further below. The device 610 of FIG. 6 can include various systems for communicating with mobile device 624, including storing information about a flexible gift object cart to facilitate information for a sender or a recipient who is physically present in the merchant location. The communication systems can include Bluetooth®, WiFi®, or other wireless network systems for communication. In some examples, rather than communicating using local wireless communications, a code or other matching mechanism can be used to match application(s) associated with a merchant interface for the gifting application 618 with device 610 via a wide area network (e.g., the Internet) to allow communications and dynamic synchronization between device 610 and mobile device 624. In various implementations, the mobile device 624 can access various communication channels, including short message service (SMS), text, application-based communications, e-mail, web browsers, or other such communication channels.

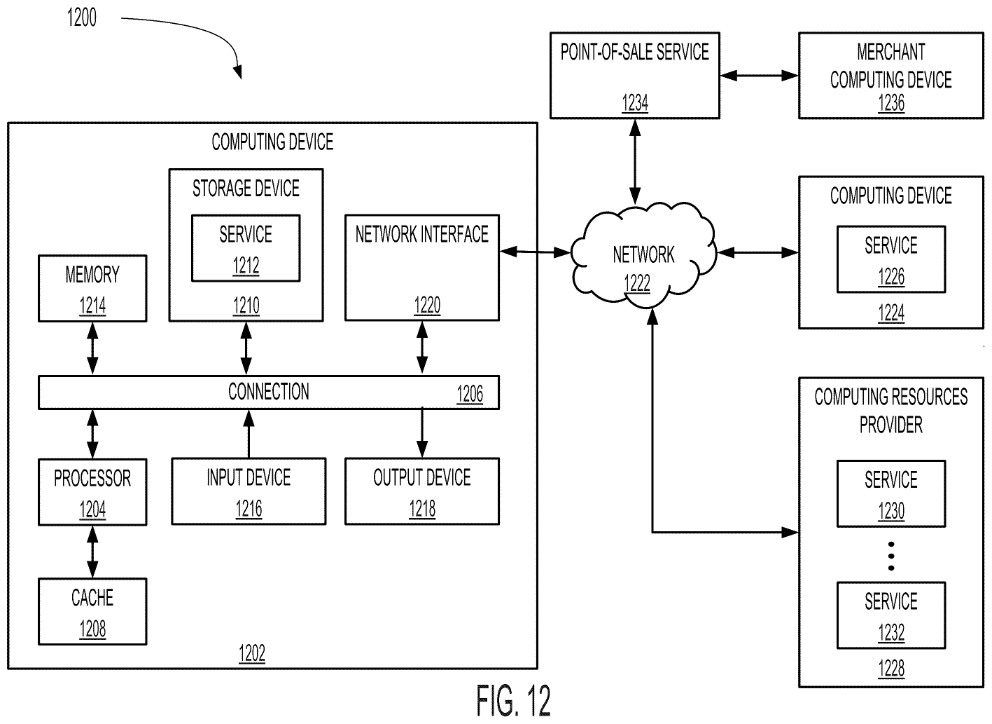

Once a connection is established between device 610 and mobile device 624, custom tender operations can be performed using application(s) or web code including the merchant interface for the gifting application 618 as described below. Additionally, other implementations of Device 610 can include a credit card scanner or other payment input, a keypad, or other such elements. Additional examples of a Device 610 can be a tablet device, a smartphone, a laptop computer, or any other such device that can be accessed by a customer, either directly, or through an employee of the retailer. The retail computing system 608 may be directly connected or connected by one or more networks 620 to the Device 610. The retail computing system 608 and the Device 610 may each be implemented by one or more computing devices, which may each be implemented as a computing device with architecture 1200 described below and illustrated in FIG. 12.

Referring to FIG. 6, the Device 610 is configured to be operated by a customer 622 having the mobile device 624 (e.g., a cellular telephone) with a display device 626 (e.g., a conventional touch screen) executing an operating system (OS) 616 and a merchant interface for the gifting application 618 along with one or more applications. For example, a customer 622 may prepay for one or more items 628 in a flexible object cart using the Device 610. The customer 622 may also use the Device 610 and the mobile device 624 to apply for credit to use an existing credit account (e.g., using an authenticating entity), or to access an offer associated with a transaction. Similarly, a recipient customer device 623 may present the flexible gift object at the Device 610 to purchase physical items 628 prepaid for as part of the flexible gift object configuration.

The transaction systems 604 can include one or more computing devices that can include implement a security gateway, a web server, a proxy server, an application processing service, a SMS module, or other elements to facilitate prepayment of cart objects associated with a flexible gift object, and to authorize and/or authenticate a transaction using the flexible gift object when a recipient uses the flexible gift object to obtain the physical objects that were prepaid for as part of the flexible gift object activation and/or configuration. The transaction systems 604 can also include one or more authentication computing devices configured to communicate over the network(s) 620. The authentication computing device(s) may implement a Uniform Resource Locator (“URL”) generator, a device authentication service, an SMS service, a pre-fill service, and/or a token service, as part of systems that generate data that can be processed by a data validation service.

As described herein, the mobile device 624 (e.g., customer device) can be used in conjunction with Device 610 to establish secure communications between customer 622, merchant system 602, and gift card system 609 to facilitate a transaction and gift using a flexible gift object as described herein. In some contexts, a customer 622 is concerned about privacy and financial communications, in particular with respect to a retailer employee that may be communicating with customer 622. A customer 622 can additionally have concerns about data being communicated with retailer system 608 being visible to checkout employees of the retailer in ways that customer 622 can wish to avoid, such as the possibility of a credit request being rejected.

Devices and separate systems, such as those described above in FIG. 6, can generate massive amounts of data (e.g., billions of data elements, terabytes of data, or more). Separate systems, such as retailer system 608, transaction systems 604, gift card system 609, and any number of systems interacting with the mobile device 624 of the customer 622 can generate matching data in different formats. In accordance with aspects described herein, any such data can be used by ML/AI systems for profile information to provide recommendations and/or generative AI output in the gifting app 618 (e.g., either to a sender or recipient user) based on various types of training and input data.

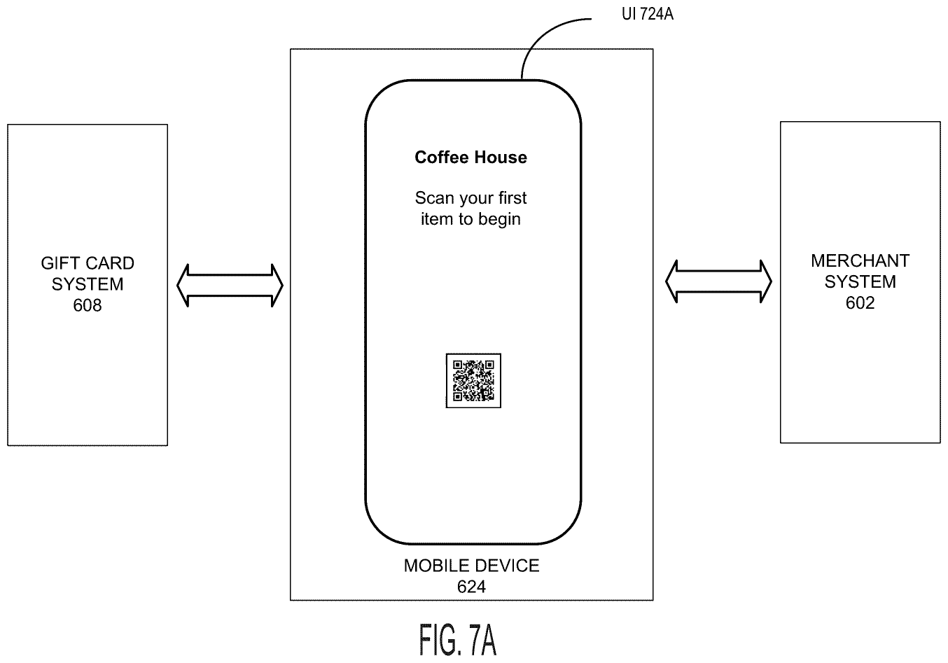

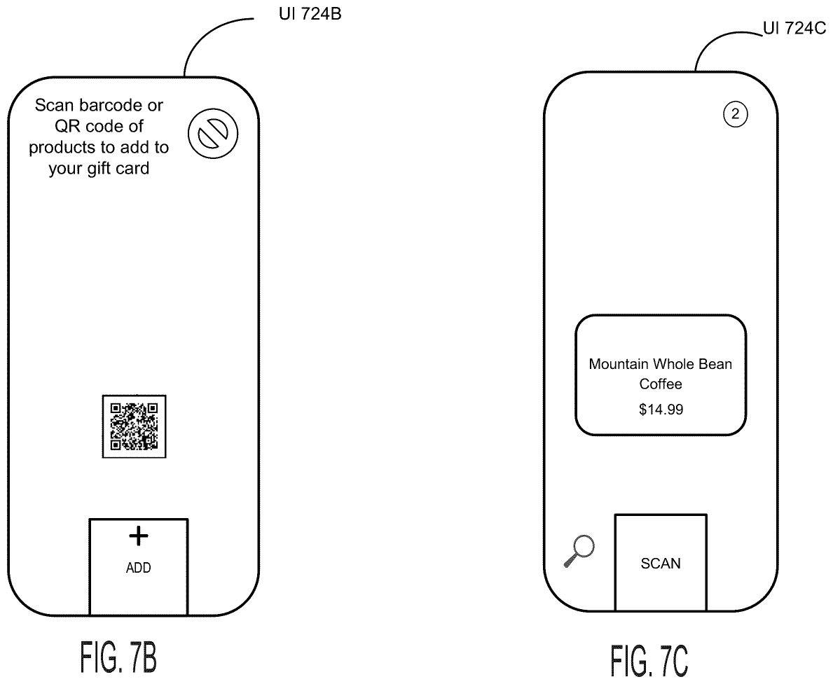

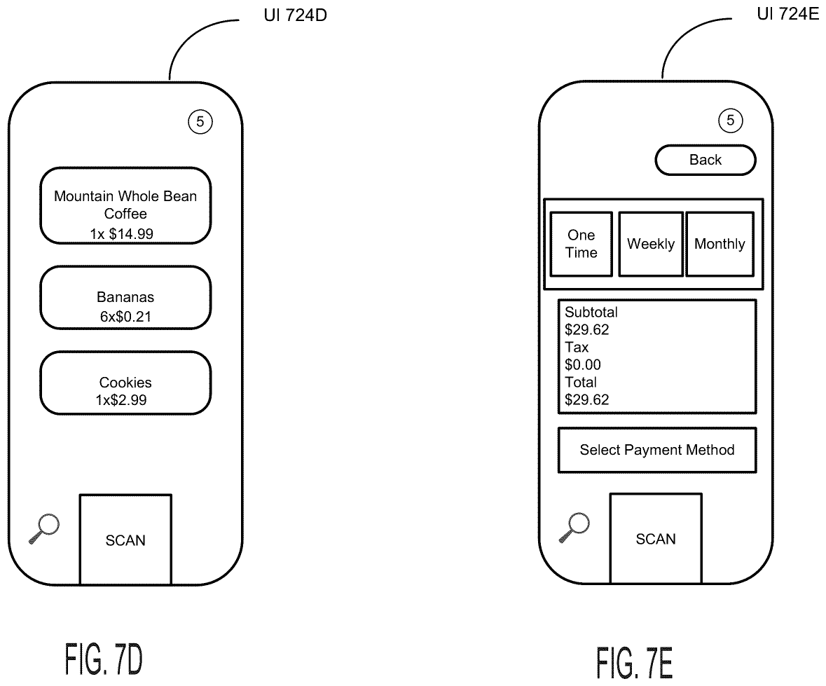

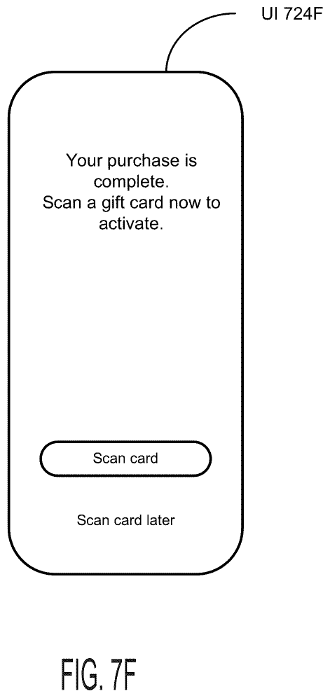

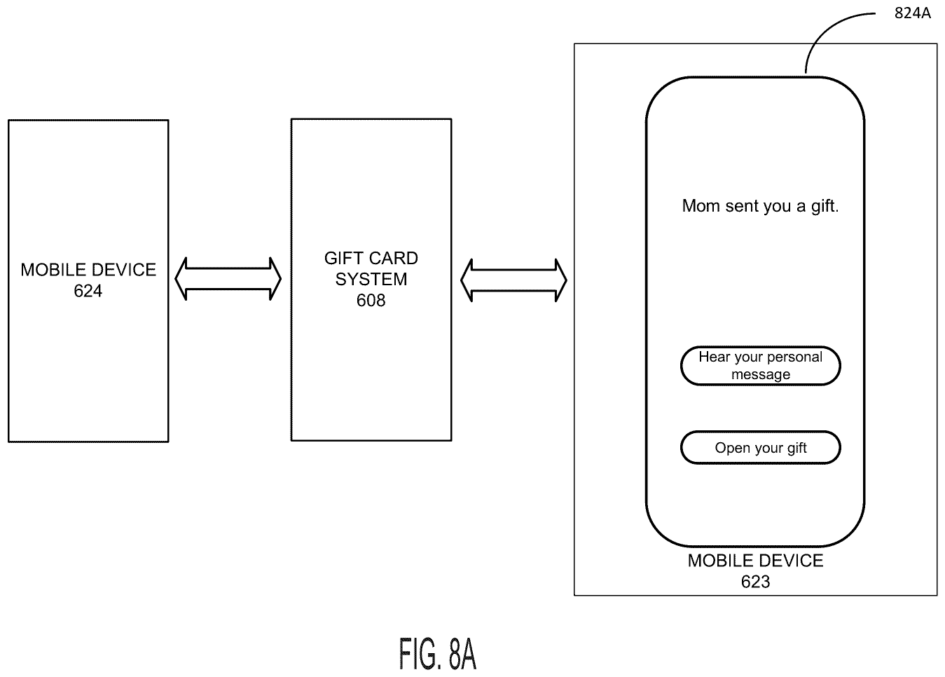

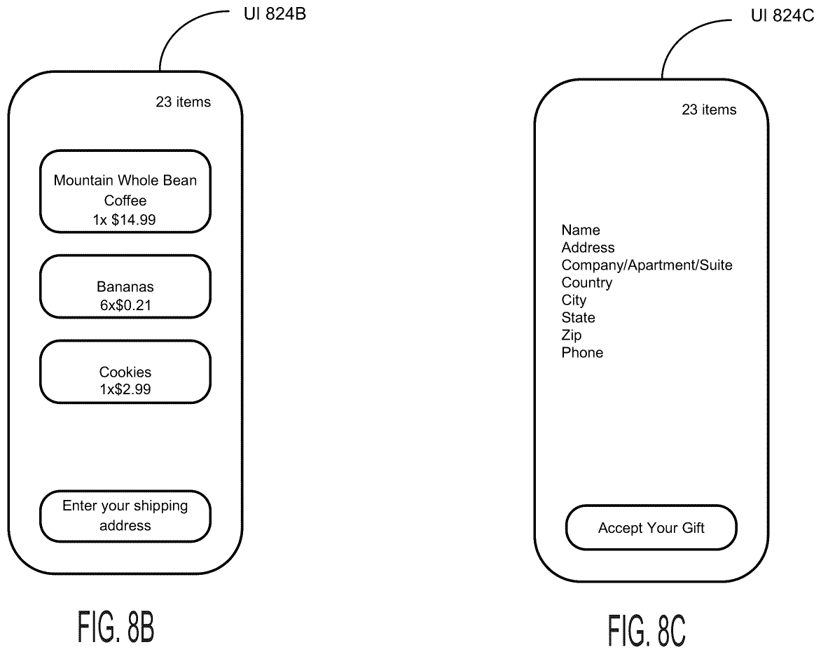

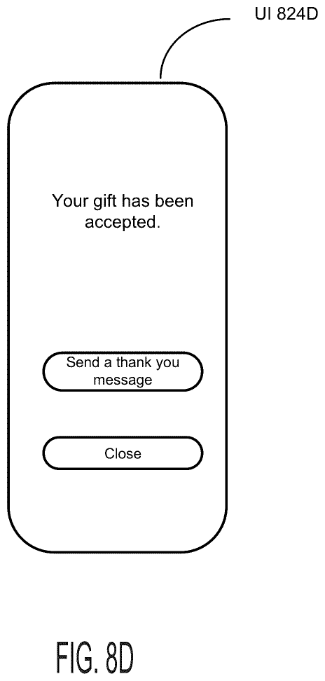

Environment 600 includes the gift card system 609, the merchant system 602, and the mobile device 624 executing a gifting application that can be used to facilitate operations for a flexible gift object as described above (e.g., activation operations as described in FIGS. 2-5, etc.). After a flexible gift object is initially activated and set for configuration with a shopping cart, the mobile device 624 can be used in a merchant environment to scan gift objects and load details of the scanned objects into a shopping cart of the flexible gift object. FIGS. 7A-7F and 8A-8D describe user interfaces and interactions between devices (e.g., merchant systems, gift card systems, mobile devices configured as specialized computing systems for sending and receiving ownership and information associated with a flexible gift object, etc.).

FIGS. 7A-7F depict examples of an environment in which a generator of a cart for a flexible linked object, through a computing device, may associate a set of products with the flexible linked object in accordance with at least one aspect. For example, FIG. 7A illustrates a user interface 724A that can be used as part of a gifting application 618 to scan gift objects. For example, in a merchant location, the mobile device 624 can include a camera that can be used to capture images of a gift object, including physical structure of the object, bar codes on object packaging, stock-keeping-unit (SKU) numbers, previously generated lists or bundles associated with an identifier for a set of objects, or other such details of an object. FIG. 7B illustrates an example of an image of an object (e.g., a bag of coffee beans) within an additional user interface 724B. The user can tap an add element to store the illustrated image seen within the UI 724B, and information (e.g., a packaging code as illustrated) associated with the object can be extracted from the image captured from the UI 724B. The mobile device 624 can use this information to interact with the merchant system and/or the gift card system 609 to gather further information about the scanned object. In some aspects, the UI is used to capture image data, the image data is processed at the mobile device, and the processed data is sent to the gift card system 609. The gift card system 609 can then either return key object information, such as price, to the mobile device 624, or can communicate with the merchant system 602 regarding the key object information.

In some aspects, a prompt communication can generate a UI similar to the UI is discussed herein with a set of pre-identified periodic items. (e.g., weekly, monthly, etc. “subscription” or “staple” items). In some aspects, an automatically generated communication can be sent as a prompt at a selected interval to prompt a user to purchase a set list of items for a flexible gift object. Such a prompt communication can automatically generate a shopping cart, and can allow generation or purchase of the preselected objects from a list in accordance with other aspects of flexible object operation described herein.

FIG. 7C illustrates an additional UI 724C that includes key information about the gift object, along with an option to add one or more instances of the gift object to the shopping cart of the flexible gift object. The UI 724C additionally includes information about the number of objects already associated with (e.g., virtually placed in) the shopping cart (e.g., in the upper right corner of the UI 724C). The UI 724C additionally includes descriptive text about the scanned gift object, along with the cost information, as part of the key object information accessed as part of the scan operation using the gifting application 618. In some aspects, key information for a purchaser can be different than key information for a recipient. In some aspects, a purchaser can be prompted to provide a description that can be added to the key information presented to a recipient, including personalized reminders or personalized notes on the product generated by the purchaser and provided as key information to the recipient.

FIG. 7D illustrates a shopping cart UI 724D depicting overview information for a plurality of objects in a shopping cart for a flexible gift object in accordance with aspects described herein. The UI 724D, in addition to including identifying text, an object, and a count (e.g., quantity) value for objects in the shopping cart, includes a payment element that allows a transaction for the value of the objects in the shopping cart to be completed. FIG. 7E includes UI 724E that has elements for facilitating completion of the transaction for the value of the objects in the shopping cart, as a transaction between the mobile device 624 and the transaction systems 604. FIG. 7F includes UI 724F with an activation interface. In some aspects, the flexible gift object can be activated prior to completion of a transaction loading value onto the flexible gift object. In other aspects, a shopping cart can be loaded and payment completed prior to activation of the flexible gift object. In either case, activation of the flexible gift object can be performed in accordance with any aspect described above.

FIGS. 8A-8D depict examples of an environment in which a recipient of a flexible linked object, through a computing device, can manage receipt of products in a cart with the flexible linked object in accordance with at least one aspect. For example, FIGS. 8A-8D illustrate user interfaces that can be implemented as part of a gifting application 618 at a recipient mobile device 623 (e.g., receiving data associated with a flexible gift object configured and/or activated by a sender mobile device 624). After a sender mobile device 624 has configured a flexible gift object, a recipient can be identified via the gift card system 609 and the gifting application 618 operating on the sender mobile device 624. The recipient mobile device 623 can receive a communication with details of the flexible gift object, and can use information in the communication to generate UI 824A, providing a notification associated with the flexible gift object. The UI 824A can include an element that allows direct access to an audio, video, text, or other gifting message that accompanies the flexible gift object. The UI 824 can also include an opening element that links to a list of gift objects associated with the flexible gift object.

FIG. 8B illustrates a UI 824B that can be linked from the notification UI 824A, and includes a list of gift objects associated with the flexible gift object. In some aspects, the UI 824B can include an interface for requesting changes to the list of objects. As described above, in some aspects, a machine-learning algorithm can be used to automatically identify parameters for adjusting the objects without sender approval. Another UI element can provide a link to a shipping UI to allow the recipient to provide information on delivery of accepted objects from the flexible gift object shopping cart, as illustrated in UI 824C of FIG. 8C.

FIG. 8D illustrates a gift acceptance UI 824D. The gift acceptance UI 824D can be displayed on a display of the recipient mobile device 623 in a UI flow link from any other UI of a gifting acceptance operation of a gifting application 618. The gift acceptance UI 824D can provide a linking element to a response message interface that allows immediate generation of a video, audio, or text message as a response to the gifted flexible gift object.

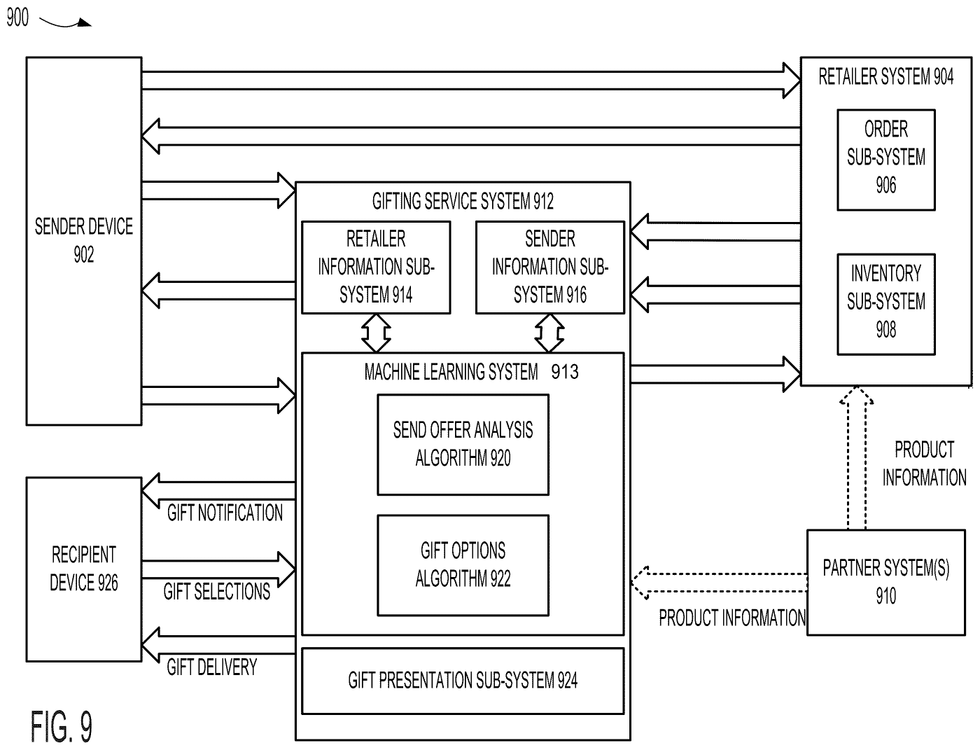

FIG. 9 depicts an example of an environment 900 in which a sender device 902 (e.g., such as the sender mobile device 624) interacts with a retailer system 904 (e.g., the merchant system 602) and a gifting services system 912 (e.g., the gifting system 609) to conduct a transaction. Any device of FIG. 9 may be a computing device such as the computing device 1202 described herein at least in connection with FIG. 12, and configured by software to operate as a special purpose computing device to implement improvements associated with a flexible gift object in accordance with aspects described herein.

As an example, a consumer may use a gifting application (e.g., gifting application 618) of the sender device 902 to scan or browse product offerings of a retailer associated with the retailer system 904. While the consumer accesses various information or channels offering information on product(s) of the retailer (e.g., via scanning products physically as described in FIGS. 7A-7F, scanning Quick Response (QR) codes etc.).

In one or more aspects, a shopping cart configuration communication with the gifting service system 912 or the retailer system 904 can access information from an order sub-system 906 and/or an inventory sub-system 908 of the retailer system to provide key object information on objects loaded into a shopping cart of a flexible gift object and to provide this information to the gifting services system 912 and a shopping cart UI to facilitate a transaction to load a value associated with shopping cart objects onto a flexible gift object.

The transaction can, in some aspects, be performed exclusively between the sender device 902 and the gifting service system 912, or can involve the retailer system 904 being notified of the flexible gift object transaction (e.g., without an associated recipient acceptance).

Following acceptance of objects in a shopping cart, the order sub-system 906 is configured to interact with the gifting service system 912 and/or the recipient device 926 to obtain various details needed to complete the transaction such as, for example, information about the consumer (e.g., contact information such as an email address), payment information by which retailer will receive payment (e.g., associated with a previously completed gifting transaction with the sender device 902 facilitated by the gifting service system 912), and/or delivery information (e.g., address to which the one or more products are to be sent). Any other information may be obtained without departing from the scope of aspects described herein.

The order sub-system 906 may also interact with other portions of the retailer system 904. As an example, the order sub-system 906 may interact with an inventory sub-system 908 of the retailer system 904. The inventory sub-system 908 may be implemented on a computing device of the retailer system 904. Alternatively, the inventory sub-system 908 may be implemented as an application or other executable process on one or more computing devices of the retailer system 904. The order sub-system 906 may interact with the inventory sub-system 908 to verify that the product that the consumer seeks to purchase is available, any possible variations (e.g., different sizes, colors, packaged quantities, etc.) that may be available to be selected from, and/or any other information about the product that may be presented to the consumer via the sender device 902. The information from the sub-system 908 can be used by gifting and offer algorithms of machine learning system 913.

In one or more aspects, once relevant information has been obtained from the sender device 902, such as the information described above, the consumer may be presented with a mechanism for completing the transaction. As an example, the gifting service system 912 may provide a button in a user interface in a gifting application browser application of the sender device 902 that, if selected by the consumer, facilitates payment associated with the objects in a shopping cart.

In one or more aspects, product information may be information related to any product that may be offered by the retailer system 904. Product information may be additional information related to the one or more products purchased as a result of the transaction that resulted from the interaction between the sender device 902 and the gifting service system 912 during configuration and/or activation of the shopping cart. Product information may include categorization information defining what one or more categories of products that a given product is in. Product information may include product pricing information. Product information may include identification of products that a retailer wants to be associated with a gift to be offered to a consumer when the product is purchased. Product information may include identification of one or more specific gifts to be associated with a given product. For example, product information may include information indicating that a specific brand of products should be associated with one or more gift options that may be offered to a consumer when a product of the brand is purchased. Product information may include any information related to products that may be offered as gifts to consumers that purchase a product from the retailer. Product information may include information related to inventory levels of one or more products of a retailer and/or of one or more gift options that may be offered to a consumer when one or more products are purchased. Product information may be dynamically updated. As an example, a retailer or partner of a retailer may provide updated and/or new product information from time to time, which may be used to dynamically update the product information. In some aspects, the machine learning system 913 can use product information with history information associated with prior gift transactions and received feedback from gift recipients to manage limits on shopping cart adjustments, and/or to suggest shopping cart substitutions. For example, if a shopping cart includes an object known to be unavailable in an area associated with a recipient (e.g., due to inventory sub-system 908 information, shipping restriction data, etc.), the machine learning system 913 can recommend substitution items with alternate prices, increased payments associated with possible variations or substitutions on items expected to be unavailable, or other adjustments to a shopping cart and flexible gift object configuration. Similarly, in some aspects, a user can select preferences that can be used to impact recommendations. For example, a user can select a preference for local products (e.g., associated with production within a certain distance), generic products, lower cost products, products correlated with higher ratings on social media or a merchant feedback site, or other such criteria for recommendations.

In one or more aspects, a retailer system 904 may be associated with one or more partner systems 910. In one or more aspects, a partner system 910 is associated with a partner of the retailer associated with the retailer system 904. In one or more aspects, a partner is any entity that has a relationship with the retailer. As an example, a partner may be another retailer or other entity that offers products (e.g., goods and/or services). In one or more aspects, a partner may desire to provide its products as gifts to consumers that purchase products from the retailer associated with the retailer system 904. For example, a partner may be seeking to gain customers for its products. To that end, the partner may enter into an agreement with the retailer such that the retailer will offer one or more products of the partner as gifts when a consumer purchases one or more products from the retailer. Such an agreement may indicate, for example, that when a certain product, product category, brand, etc. is purchased from the retailer by a consumer (i.e., a purchaser), the retailer will offer the consumer one or more products of the partner as a gift. As another example, the partner may seek to have the retailer offer one or more partner products as gifts to purchasers that purchase one or more products from a retailer within a certain timeframe. As another example, the partner may seek to have the retailer offer one or more products of the partner to purchasers that purchase one or more products from the retailer and are associated with certain characteristics (e.g., have certain demographic characteristics, spent above a certain amount on the purchase, etc.). In one or more aspects, in order for one or more partner products to be offered as gifts to purchasers who purchase one or more products from the retailer, the partner system 910 may provide product information. Such product information may be provided to the retailer system 904. The retailer system 904 may, in turn, provide the partner product information to the gifting service system 912 (as described above) as part of the product information provided by the retailer system 904. Additionally or alternatively, the partner system 910 may provide the partner product information to the gifting service system 912. The information from the partner system 910 can be used by the machine learning system 913 to recommend alternative items or replacement items in accordance with aspects described herein. For example, in some aspects, a gifting service system 912 can allow limitations set by a retailer system 904 or sender device 902 to limit replacement suggestions or substitutions selected by a recipient device 926 to items associated with the retailer system 904 or the partner system(s) 910. In some aspects, conditional substitutions can be authorized, such as substitutions from partner system(s) 910 when a machine learning algorithm of the machine learning system indicates that an item or appropriate substitution from the inventory sub-system 908 of the retailer system 904 is likely to be unavailable.

In one or more aspects, sender information provided to the gifting service system 912 may include additional information related to the consumer. For example, the consumer may have created an account with the retailer, and the retailer system may maintain a customer profile associated with the consumer. All or any portion of the information maintained in such a consumer profile may be provided to the gifting service system 912. As another example, the retailer system 904 may provide any information related to any number of consumers to the gifting service system as history information or sender information. Sender information may include any information about a consumer such as, for example, demographic information (e.g., name, age, location, etc.), purchase history with the retailer, etc., which may be obtained by the gifting service system 912 from a retailer, and/or sources other than the retailer system 904 (e.g., previous interactions with a consumer, cookies, browser extensions, social media platforms, etc.). Sender information related to a particular consumer and/or to one or more groups of consumers may be referred to as historical sender information. In one or more aspects, historical sender information is dynamically updated in real-time. As an example, updates may be added to the historical sender information as consumers make purchases from retailers, decide whether or not to send gifts received as a result of purchases to separate recipients, etc.

In one or more aspects, the gifting service system 912 includes a retailer information sub-system 914. In one or more aspects, the retailer information sub-system 914 includes a datastore (not shown) that stores any data received from or otherwise obtained and related to the retailer associated with retailer system 904. As such, the retailer information sub-system 914 may store all or any portion of the product information received from the retailer system 904, all or any portion of any order confirmation details received from the retailer system 904, etc. Such product information, as described above, may include information related to retailer and/or partner products that may be offered as a gift to a consumer that purchased one or more products from the retailer system 904 (e.g., product name, product images, product details, various product customization options, product inventory information, etc.).

In one or more aspects, the gifting service system 912 includes a sender information sub-system 916. The sender information sub-system 916 may be one or more computing devices such as the computing device 1202 described herein at least in connection with FIG. 12, or any portion of such computing devices. In one or more aspects, the sender information sub-system 916 includes a datastore (not shown) for storing any information related to consumers that may become senders of a gift received as a result of purchasing one or more products from a retailer associated with the retailer system 904. Such information may be obtained, for example, from the sender information received from the retailer system 904. Such information may further include information about potential senders obtained by the gifting service system 912 obtained from any other source for any other purpose. As an example, the gifting service system 912 may have interacted with the potential sender previously (e.g., for sending a previous gift received with a previous purchase, providing gifting services, etc.) and obtained information about the potential sender through the interaction. As another example, sender information stored in the sender information sub-system 916 may include data related to potential senders obtained via various online sources (e.g., cookies, clickstream data, search data, purchase data, user profile data, etc.), data corresponding to content presented on a website or application (e.g., dates, product details, images, videos, other advertisements, comments, news stories and headlines, etc.), data obtained from e-mails or social media posts/comments, etc.

In one or more aspects, the gifting service system 912 includes a machine learning system 913. The machine learning system 913 may be implemented on one or more computing devices of the gifting service system 912, such as the computing device 1202 described herein at least in connection with FIG. 12, or any portion of such computing devices. Additionally or alternatively, the machine learning system 913 may be implemented as an application or other executable process on one or more computing devices of the gifting service system 912.

The machine learning system 913 may include a send offer analysis algorithm 920 that is configured to analyze history data, shopping cart selections, product information, sender information stored in the retailer information sub-system 914 and/or the sender information sub-system 916, or any other such information to provide alternatives, substitutions, additional complementary gifts, or other information to the sender device. The send offer analysis algorithm can additionally be used to identify suggested recipients, and gifting proposals for suggested recipients or recipients identified by a sender device using any such information related to a recipient (e.g., history information, social information, interaction information, etc.). The send offer analysis algorithm 920 may be implemented on one or more computing devices of the gifting service system 912, such as the computing device 1202 described herein at least in connection with FIG. 12, or any portion of such computing devices. Additionally or alternatively, the send offer analysis algorithm 920 may be implemented as an application or other executable process on one or more computing devices of the gifting service system 912.

In one or more aspects, the send offer analysis algorithm 920 is invoked by the gifting service system 912 in response to receiving or otherwise obtaining or determining order confirmation details associated with a purchase of one or more products from the retailer system 904. The send offer analysis algorithm 920 may include any number of rules to be evaluated to determine whether a purchase associated with the order confirmation details qualifies to receive an offer to send a gift received as a result of the purchase to a separate recipient. The send offer analysis algorithm 920 may include rules that associate specific products, categories of product, certain brands, etc. with a gift with purchase. For example, the send offer analysis algorithm 920 may include a rule that indicates that any purchase that includes a purchase of a product of a particular brand qualifies to receive an offer to send a gift received as a result of the purchase to a separate recipient.

Various machine learning techniques may be combined with sender device 902 selected preferences as part of the send offer analysis algorithm 920 without departing from the scope of aspects described herein. For example, a sender device may place value variation limits on suggestions or machine-learning suggested substitutions, such as items valued up to a certain percentage or amount over a selected value. Similarly, a service may place other limits on substitutions. For example, the flexible object system can have food group criteria (e.g., fruits and vegetables, alcohol, etc.) In some aspects, substitutions can be limited to a shared group with an original item, or a sender can select groups that are acceptable for substitution. Alternatively, a sender can select groups that are not acceptable for substitution, and allow flexibility for any category not blacklisted. Additional techniques can be used or selected for identifying, using the send offer analysis algorithm, alternative items prior to sending a flexible gift object. As an example, a clustering machine learning algorithm (e.g., k-means clustering algorithms, fuzzy c-means (FCM) algorithms, expectation-maximization (EM) algorithms, hierarchical clustering algorithms, density-based spatial clustering of applications with noise (DBSCAN) algorithms, etc.) may be used to identify whether the order details, product information, and/or sender information associated with or existing at the time of a given purchase include characteristics similar to other purchases for which an offer to send a gift was made and resulted in the acquisition of a new customer for the retailer.

In one or more aspects, the gift options algorithm 922 may be or include a machine learning model that is trained to determine what one or more substitution options should be presented to the recipient of a flexible gift object. The gift options algorithm 922 may operate within limits determined by sender selections and/or options that were presented to the sender by the send offer analysis algorithm 920. As an example, such a machine learning model may use information from key item details, product information, and/or sender information to predict what potential gift options are more likely to be preferred by a recipient. To that end, the machine learning model may be trained to predict which one or more particular gifts of the currently available gift options, when presented to the recipient are more likely to cause selection or acceptances associated with the flexible gift object, or to increase positive sentiment by a recipient of the flexible gift object.

As an example, the trained machine learning model may be trained to determine that consumers having certain demographic characteristics, living in a certain geographic region, and that made a purchase of a particular brand of product are more likely to select or have a greater positive sentiment when a certain gift option is presented to the recipient. The gift options algorithm 922 of the machine learning model may be dynamically updated via continuous training over time to improve its predictive accuracy for recipient sentiment and/or selection preferences by adding order confirmation details, product data, and/or sender data associated with purchases for which an offer to send a gift was provided to a consumer, the gift options presented in the offer, and the results of whether the offer resulted in the acceptance of the gift by the recipient, or other such feedback information thereby allowing the machine learning model to better predict gift options that are more likely to result in the sending of a gift.

In one or more aspects, the gift notification is transmitted to the recipient device 926 using a communication channel selected by the sender, which may include using at least a portion of the recipient identifier provided by the sender. For example, if email was selected as the communication channel, the gift notification may be transmitted using an email address of the recipient provided by the sender. As another example, if text message was selected as the communication channel, then a phone number of the recipient associated with the recipient device 926 may be used to send the gift notification.

In one or more aspects, when the recipient, via the interactive element on the page, selects to continue the gift redemption process, the recipient may be navigated to another page generated by the gift presentation sub-system 924 of the gifting service system 912 that provides various options to the recipient. Such options may include, but are not limited to, the option to accept the gift selected by the sender, or to exchange the gift for another gift from the retailer or a partner of the retailer. The page may include one or more alternate gifts that the recipient could choose to exchange for the gift selected by the sender. The alternate gifts may be presented using an image, a name, and/or details of the one or more alternate gifts. The page may also include an image, name, and or details related to the gift selected by the sender (e.g., for the sake of comparison by the recipient with the one or more alternate gift options).

In one or more aspects, the alternate gift options presented to the recipient are the same as the other gift options that were presented to the sender. In some aspects, a sender may select a subset of substitution items that were presented to the sender as acceptable options for substitution, while rejecting other substitution items presented to the sender, so that the recipient is presented with a list of acceptable substitutes curated by the machine learning system 913, and then filtered by the sender device 902. In some such aspects, the transaction for the shopping cart may be based on a highest cost substitution item. If the recipient device 926 accepts the lower cost alternative, the balance can be automatically refunded to the sender, allowing selection of an expensive substitution item without an additional purchase transaction by the sender device 902.

In one or more aspects, the one or more gift options presented to the recipient may depend on when the recipient selects to redeem a gift (e.g., the timing and availability of the selection to redeem the gift). As an example, the gifting service system 912 may transmit the gift notification in the form of an email. In such a scenario, the recipient may not immediately open the email, or may open the email but not immediately select to redeem the gift. Thus, the one or more gift options that would be presented to the recipient may have changed since the time of the purchase. For example, some or all of the gift options that would have been presented if the consumer had elected to send a gift near the time of the purchase may no longer be available (e.g., there were 9000 of a particular retailer gift, but no more remain in the retailer's inventory). Therefore, the gift options algorithm 922 may be invoked at the time the recipient selects to redeem the gift from the flexible gift object shopping cart to present gift options that are available at the time of the selection.

In one or more aspects, once the recipient has selected to continue with the gift selected by the sender, or selected an alternate gift, the recipient may be presented with various customization options (e.g., size, color, etc.) and requests for information (e.g., address to send the gift to, preferred delivery options, a digital wallet address (e.g., for cryptographic currency, non-fungible tokens, etc.). The customization options and request for information may be presented to the recipient on a subsequent page generated by the gift presentation sub-system 924 of the gifting service system 912. In one or more aspects, the recipient is also optionally presented with an option to send a thank you to the sender for the gift. Although the above description contemplates various presentations and pages provided to the recipient to complete the gift redemption process, all or any portion of the presentations and pages may be combined into a single page, or divided differently into separate pages, without departing from the scope of aspects described herein.

In one or more aspects, once the recipient has made all necessary selections and provided the requested information (which may be referred to collectively as gift selections), the gift selections associated with the flexible gift object are transmitted from the recipient device 926 to the gifting service system 912. In one or more aspects, based at least in part on the gift selections, the gift presentation sub-system 924 of the gifting service system 912 initiates delivery of the selected gift to the recipient. The method of delivery may be based on a selection made by the recipient during the gift redemption process by which the recipient indicated a preferred method of delivery. As an example, the gift may be a gift card, and the recipient may have selected to receive the gift card as a virtual gift card delivered via email. As another example, the gift may be a physical object, and the recipient may have provided a physical address to which the gift is shipped. The gifting service system 912 may perform the delivery of the gift. Additionally or alternatively, the gifting service system may provide information related to the planned delivery to the retailer system 904 and/or the partner system 910, and the retailer system 904 and/or partner system 910 may perform the delivery of the gift to the recipient. In one or more aspects, regardless of which entity performs the delivery of the gift, information related to the recipient may be provided to the retailer system 904 and/or to the partner system(s) 910, thereby providing the retailer and/or partner(s) with a potential new customer (i.e., the recipient). In one or more aspects, all or any portion of any information obtained related to the sender and/or the recipient is used by the gifting service system 912 to dynamically update historical data maintained by the gifting service system 912, which may be used to dynamically update the machine learning models of the send offer analysis algorithm 920 and/or the gift options algorithm 922 by adding the obtained information in real-time to the training data sets for the machine learning models.

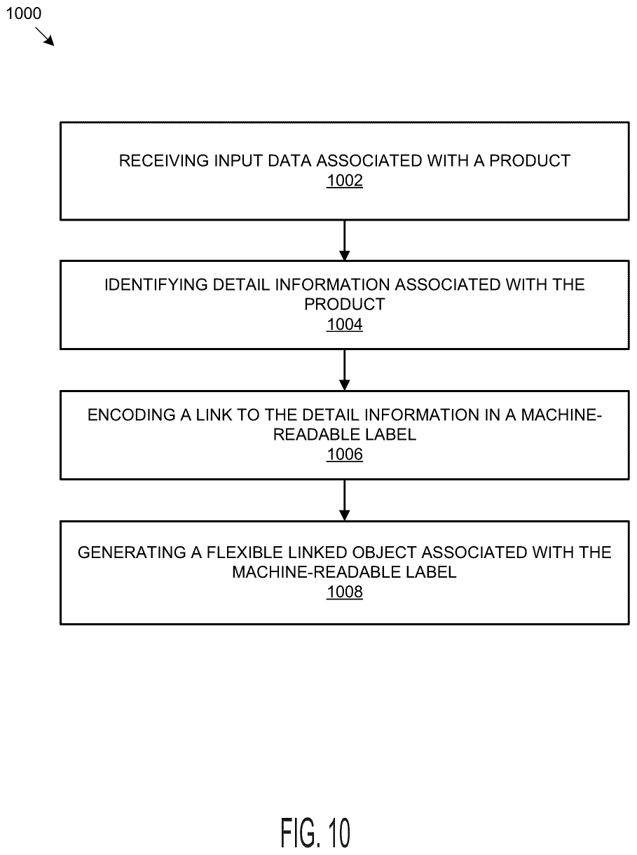

FIG. 10 illustrates an example of a method 1000 associated with cart generation with a flexible linked object, in accordance with aspects described herein. The method 1000 can be implemented using any computing device described herein, such as a special purpose computer using the computing system architecture 1200. Instructions for performing the operations of method 1000 can be stored on a non-transitory storage medium.

Method 1000 can include block 1002, which can involve receiving, at a computing device, input data. The input data can be associated with a product. Input data can include, for example, product names, pricing, availability, version information, sell by dates, and so forth. In some aspects, the input data includes bar code data for a product received via a camera of the computing device. In some aspects, the detail information is identified by querying a merchant database using the bar code data.

Method 1000 can include block 1004, which involves identifying detail information associated with the product. The detail information can be obtained by analyzing the input data. The information can include numerical values such as a purchase value.

Method 1000 can include block 1006, which involves encoding a link to the detail information in a machine-readable label, for example, on in a machine-readable representation. In some aspects, the machine-readable label includes a Quick Response (QR) code.

Method 1000 can include block 1008, which involves generating a flexible linked object. The flexible linked object can be associated with the machine-readable label.

In some aspects, the method 1000 further includes associating the flexible linked object with a recipient. In some aspects, the method 1000 further includes generating an offer (e.g., a gifting offer) or object that associates the flexible linked object with a recipient and identifying information associated with the recipient.

In some aspects, the method 1000 further includes transmitting the offer. When the gifting offer is received at a recipient device, the recipient device can extract the detail information from the machine-readable label and generates an activation request to activate the flexible linked object.

In some aspects, the method 1000 further includes receiving a notification that a recipient device has activated the flexible linked object and accepted an offer. In some aspects, when the notification is received from the recipient device, a second payment associated with the product is automatically initiated, and the flexible linked object is updated with details of the second payment.

In some aspects, the method 1000 further includes receiving, at the computing device, input data associated with one or more products. The method can further include identifying detail information associated with the products. The detail information can include a total purchase value. The method can further include generating a shopping cart interface for the products. The shopping cart interface can include the detail information associated with the products including the total purchase value. The method can further include encoding a link to the shopping cart interface in the machine-readable label.

In some aspects, the method 1000 further includes automatically receiving a set of recommendations corresponding a partial recipient use of one or more of gift items encoded in the link to the detail information. In some cases, when the set of recommendations is received from a gifting server, the set of recommendations is generated using a machine learning algorithm trained using history data to generate the set of recommendations from the partial recipient acceptance of the plurality of gift items.

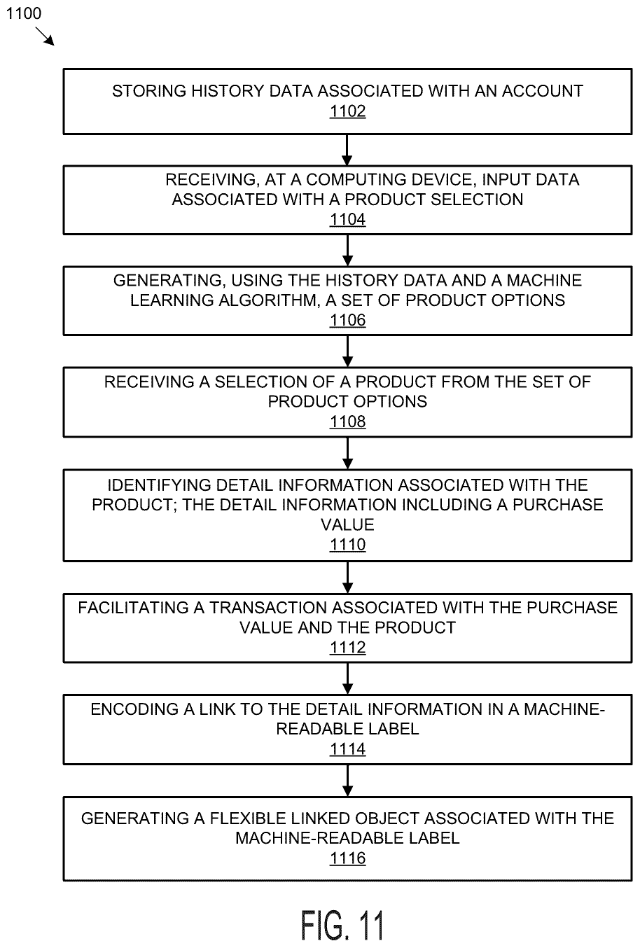

FIG. 11 illustrates an example of a method 1100 associated with cart generation with a flexible linked object, in accordance with aspects described herein. The method 1100 can be implemented using any computing device described herein, such as a special purpose computer using the computing system architecture 1200. Instructions for performing the operations of method 1100 can be stored on a non-transitory storage medium.

The method 1100 may include block 1102, which involves storing history data associated with an account. Non-limiting examples of history data include information about past purchases and demographic information. The history data may be accessed by a computing device.

In some aspects, input data may include bar code data for a product received via a camera of the computing device. In some aspects, detail information is identified by querying a merchant database using the bar code data. The detail information may include one or more numerical values. Examples of numerical values include price and quantity.

The method 1100 may include block 1104, which involves receiving, at a computing device, input data associated with a product selection. In some cases, a set of options, optionally including product options, may be provided to the computing device. The set of options may be generated based on the history data. In some cases, machine learning is used. For instance, the history data may be provided to a trained machine learning model. In return, the machine learning model returns or outputs the set of options. The method 1100 may include block 1106, which involves generating, using the history data and a machine learning algorithm, a set of product options.

The method 1100 may include block 1108, which involves receiving a selection of a product from the set of product options. The method 1100 may include block 1110, which involves identifying detail information associated with the product. The detail information can include a purchase value. The method 1100 includes block 1112, which includes facilitating a transaction associated with the purchase value and the product. The method 1100 includes block 1114, which includes encoding a link to the detail information in a machine-readable label. The method 1100 includes block 1116, which includes generating a flexible linked object that is associated with the machine-readable label.

In some aspects, the method 1100 further includes associating the flexible linked object with a recipient. The flexible linked object may be a flexible gift object. The method 1100 may therefore further include generating a gifting offer. The gifting offer can associate the flexible gift object with a recipient and identifying information associated with the recipient. The method 1100 may further include transmitting a gifting offer. In some aspects, when the gifting offer is received at a recipient device, the recipient device extracts the detail information from the machine-readable label and generates an activation request to activate the flexible gift object. The history data may be associated with purchase history information for the recipient device.

In some aspects, the method 1100 further includes receiving a notification that a recipient device has activated the flexible gift object and accepted a gifting offer. When the notification is received from the recipient device, a second payment associated with the product may be automatically initiated, and updating the flexible gift object with details of the second payment.

In some aspects, the method 1100 further involves receiving a second selection of a second product from the set of product options. Method 1100 may further involve identifying second detail information associated with the second product. The second detail information may include a second purchase value. Method 1100 may further involve facilitating the transaction using the second purchase value, value, and the product. The link may further facilitate access to the second detail information via the machine-readable label.

In some aspects, the method 1100 further includes receiving, at the computing device, second input data associated with a second product. Method 1100 may further involve updating the set of product options in real-time as the second input data is received to generate and update set of product options using the machine learning algorithm with the second input data. Method 1100 may further involve generating a shopping cart interface including detail information for each product selected from the updated set of product options.

In some aspects, the method 1100 further includes automatically receiving a set of recommendations corresponding a partial recipient use of gift items encoded in the link to the detail information. In some aspects, when the set of recommendations is received from a gifting server, the set of recommendations is generated using a machine learning algorithm trained using history data to generate the set of recommendations from the partial recipient acceptance of the plurality of gift items.

FIG. 12 illustrates a computing system architecture 1200, including various components in electrical communication with each other, in accordance with some aspects. Elements of the computing architecture 1200 can be configured as a special purpose computing device to perform the details of aspects for shopping cart configuration associated with a flexible gift object as described herein. The example computing system architecture 1200 illustrated in FIG. 12 includes a computing device 1202, which has various components in electrical communication with each other using a connection 1206, such as a bus, in accordance with some implementations. The example computing system architecture 1200 includes a processor 1204 that is in electrical communication with various system components, using the connection 1206, and including the system memory 1214. In some aspects, the system memory 1214 includes read-only memory (ROM), random-access memory (RAM), and other such memory technologies including, but not limited to, those described herein. In some aspects, the example computing system architecture 1200 includes a cache 1208 of high-speed memory connected directly with, in close proximity to, or integrated as part of the processor 1204. The system architecture 1200 can copy data from the memory 1214 and/or the storage device 1210 to the cache 1208 for quick access by the processor 1204. In this way, the cache 1208 can provide a performance boost that decreases or eliminates processor delays in the processor 1204 due to waiting for data. Using modules, methods and services such as those described herein, the processor 1204 can be configured to perform various actions. In some aspects, the cache 1208 may include multiple types of cache including, for example, level one (L1) and level two (L2) cache. The memory 1214 may be referred to herein as system memory or computer system memory. The memory 1214 may include, at various times, elements of an operating system, one or more applications, data associated with the operating system or the one or more applications, or other such data associated with the computing device 1202.

Other system memory 1214 can be available for use as well. The memory 1214 can include multiple different types of memory with different performance characteristics. The processor 1204 can include any general purpose processor and one or more hardware or software services, such as service 1212 stored in storage device 1210, configured to control the processor 1204 as well as a special-purpose processor where software instructions are incorporated into the actual processor design. The processor 1204 can be a completely self-contained computing system, containing multiple cores or processors, connectors (e.g., buses), memory, memory controllers, caches, etc. In some aspects, such a self-contained computing system with multiple cores is symmetric. In some aspects, such a self-contained computing system with multiple cores is asymmetric. In some aspects, the processor 1204 can be a microprocessor, a microcontroller, a digital signal processor (“DSP”), or a combination of these and/or other types of processors. In some aspects, the processor 1204 can include multiple elements such as a core, one or more registers, and one or more processors such as an arithmetic logic unit (ALU), a floating point unit (FPU), a graphics processing unit (GPU), a physics processing unit (PPU), a digital system processing (DSP) unit, or combinations of these and/or other such processing units.

To enable user interaction with the computing system architecture 1200, an input device 1216 can represent any number of input mechanisms, such as a microphone for speech, a touch-sensitive screen for gesture or graphical input, keyboard, mouse, motion input, pen, and other such input devices. An output device 1218 can also be one or more of a number of output mechanisms known to those of skill in the art including, but not limited to, monitors, speakers, printers, haptic devices, and other such output devices. In some instances, multimodal systems can enable a user to provide multiple types of input to communicate with the computing system architecture 1200. In some aspects, the input device 1216 and/or the output device 1218 can be coupled to the computing device 1202 using a remote connection device such as, for example, a communication interface such as the network interface 1220 described herein. In such aspects, the communication interface can govern and manage the input and output received from the attached input device 1216 and/or output device 1218. As may be contemplated, there is no restriction on operating on any particular hardware arrangement and accordingly the basic features here may easily be substituted for other hardware, software, or firmware arrangements as they are developed.

In some aspects, the storage device 1210 can be described as non-volatile storage or non-volatile memory. Such non-volatile memory or non-volatile storage can be a hard disk or other types of computer readable media which can store data that are accessible by a computer, such as magnetic cassettes, flash memory cards, solid state memory devices, digital versatile disks, cartridges, RAM, ROM, and hybrids thereof.

As described above, the storage device 1210 can include hardware and/or software services such as service 1212 that can control or configure the processor 1204 to perform one or more functions including, but not limited to, the methods, processes, functions, systems, and services described herein in various aspects. In some aspects, the hardware or software services can be implemented as modules. As illustrated in example computing system architecture 1200, the storage device 1210 can be connected to other parts of the computing device 1202 using the system connection 1206. In an aspect, a hardware service or hardware module such as service 1212, that performs a function can include a software component stored in a non-transitory computer-readable medium that, in connection with the necessary hardware components, such as the processor 1204, connection 1206, cache 1208, storage device 1210, memory 1214, input device 1216, output device 1218, and so forth, can carry out the functions such as those described herein.

The disclosed processes for generating and executing experience recommendations can be performed using a computing system such as the example computing system illustrated in FIG. 12, using one or more components of the example computing system architecture 1200. An example computing system can include a processor (e.g., a central processing unit), memory, non-volatile memory, and an interface device. The memory may store data and/or and one or more code sets, software, scripts, etc. The components of the computer system can be coupled together via a bus or through some other known or convenient device.

In some aspects, the processor can be configured to carry out some or all of methods and functions for generating and executing experience recommendations described herein by, for example, executing code using a processor such as processor 1204 wherein the code is stored in memory such as memory 1214 as described herein. One or more of a user device, a provider server or system, a database system, or other such devices, services, or systems may include some or all of the components of the computing system such as the example computing system illustrated in FIG. 12, using one or more components of the example computing system architecture 1200 illustrated herein. As may be contemplated, variations on such systems can be considered as within the scope of the present disclosure.

This disclosure contemplates the computer system taking any suitable physical form. As example and not by way of limitation, the computer system can be an embedded computer system, a system-on-chip (SOC), a single-board computer system (SBC) (such as, for example, a computer-on-module (COM) or system-on-module (SOM)), a desktop computer system, a laptop or notebook computer system, a tablet computer system, a wearable computer system or interface, an interactive kiosk, a mainframe, a mesh of computer systems, a mobile telephone, a personal digital assistant (PDA), a server, or a combination of two or more of these. Where appropriate, the computer system may include one or more computer systems; be unitary or distributed; span multiple locations; span multiple machines; and/or reside in a cloud computing system which may include one or more cloud components in one or more networks as described herein in association with the computing resources provider 1228. Where appropriate, one or more computer systems may perform without substantial spatial or temporal limitation one or more steps of one or more methods described or illustrated herein. As an example, and not by way of limitation, one or more computer systems may perform in real time or in batch mode one or more steps of one or more methods described or illustrated herein. One or more computer systems may perform at different times or at different locations one or more steps of one or more methods described or illustrated herein, where appropriate.

The processor 1204 can be a conventional microprocessor such as an Intel® microprocessor, an AMD® microprocessor, a Motorola® microprocessor, or other such microprocessors. One of skill in the relevant art will recognize that the terms “machine-readable (storage) medium” or “computer-readable (storage) medium” include any type of device that is accessible by the processor.

The memory 1214 can be coupled to the processor 1204 by, for example, a connector such as connector 1206, or a bus. As used herein, a connector or bus such as connector 1206 is a communications system that transfers data between components within the computing device 1202 and may, in some aspects, be used to transfer data between computing devices. The connector 1206 can be a data bus, a memory bus, a system bus, or other such data transfer mechanism. Examples of such connectors include, but are not limited to, an industry standard architecture (ISA″ bus, an extended ISA (EISA) bus, a parallel AT attachment (PATA″ bus (e.g., an integrated drive electronics (IDE) or an extended IDE (EIDE) bus), or the various types of parallel component interconnect (PCI) buses (e.g., PCI, PCIe, PCI-104, etc.).

The memory 1214 can include RAM including, but not limited to, dynamic RAM (DRAM), static RAM (SRAM), synchronous dynamic RAM (SDRAM), non-volatile random access memory (NVRAM), and other types of RAM. The DRAM may include error-correcting code (EEC). The memory can also include ROM including, but not limited to, programmable ROM (PROM), erasable and programmable ROM (EPROM), electronically erasable and programmable ROM (EEPROM), Flash Memory, masked ROM (MROM), and other types or ROM. The memory 1214 can also include magnetic or optical data storage media including read-only (e.g., CD ROM and DVD ROM) or otherwise (e.g., CD or DVD). The memory can be local, remote, or distributed.

As described above, the connector 1206 (or bus) can also couple the processor 1204 to the storage device 1210, which may include non-volatile memory or storage and which may also include a drive unit. In some aspects, the non-volatile memory or storage is a magnetic floppy or hard disk, a magnetic-optical disk, an optical disk, a ROM (e.g., a CD-ROM, DVD-ROM, EPROM, or EEPROM), a magnetic or optical card, or another form of storage for data. Some of this data may be written, by a direct memory access process, into memory during execution of software in a computer system. The non-volatile memory or storage can be local, remote, or distributed. In some aspects, the non-volatile memory or storage is optional. As may be contemplated, a computing system can be created with all applicable data available in memory. A typical computer system will usually include at least one processor, memory, and a device (e.g., a bus) coupling the memory to the processor.

Software and/or data associated with software can be stored in the non-volatile memory and/or the drive unit. In some aspects (e.g., for large programs) it may not be possible to store the entire program and/or data in the memory at any one time. In such aspects, the program and/or data can be moved in and out of memory from, for example, an additional storage device such as storage device 1210. Nevertheless, it should be understood that for software to run, if necessary, it is moved to a computer readable location appropriate for processing, and for illustrative purposes, that location is referred to as the memory herein. Even when software is moved to the memory for execution, the processor can make use of hardware registers to store values associated with the software, and local cache that, ideally, serves to speed up execution. As used herein, a software program is assumed to be stored at any known or convenient location (from non-volatile storage to hardware registers), when the software program is referred to as “implemented in a computer-readable medium.” A processor is considered to be “configured to execute a program” when at least one value associated with the program is stored in a register readable by the processor.

The connection 1206 can also couple the processor 1204 to a network interface device such as the network interface 1220. The interface can include one or more of a modem or other such network interfaces including, but not limited to those described herein. It will be appreciated that the network interface 1220 may be considered to be part of the computing device 1202 or may be separate from the computing device 1202. The network interface 1220 can include one or more of an analog modem, Integrated Services Digital Network (ISDN) modem, cable modem, token ring interface, satellite transmission interface, or other interfaces for coupling a computer system to other computer systems. In some aspects, the network interface 1220 can include one or more input and/or output (I/O) devices. The I/O devices can include, by way of example but not limitation, input devices such as input device 1216 and/or output devices such as output device 1218. For example, the network interface 1220 may include a keyboard, a mouse, a printer, a scanner, a display device, and other such components. Other examples of input devices and output devices are described herein. In some aspects, a communication interface device can be implemented as a complete and separate computing device.

In operation, the computer system can be controlled by operating system software that includes a file management system, such as a disk operating system. One example of operating system software with associated file management system software is the family of Windows® operating systems and their associated file management systems. Another example of operating system software with its associated file management system software is the Linux™ operating system and its associated file management system including, but not limited to, the various types and implementations of the Linux® operating system and their associated file management systems. The file management system can be stored in the non-volatile memory and/or drive unit and can cause the processor to execute the various acts required by the operating system to input and output data and to store data in the memory, including storing files on the non-volatile memory and/or drive unit. As may be contemplated, other types of operating systems such as, for example, MacOS®, other types of UNIX® operating systems (e.g., BSD™ and descendants, Xenix™, SunOS™, HP-UX®, etc.), mobile operating systems (e.g., iOS® and variants, Chrome®, Ubuntu Touch®, watchOS®, Windows 10 Mobile®, the Blackberry® OS, etc.), and real-time operating systems (e.g., VxWorks®, QNX®, eCos®, RTLinux®, etc.) may be considered as within the scope of the present disclosure. As may be contemplated, the names of operating systems, mobile operating systems, real-time operating systems, languages, and devices, listed herein may be registered trademarks, service marks, or designs of various associated entities.

In some aspects, the computing device 1202 can be connected to one or more additional computing devices such as computing device 1224 via a network 1222 using a connection such as the network interface 1220. In such aspects, the computing device 1224 may execute one or more services 1226 to perform one or more functions under the control of, or on behalf of, programs and/or services operating on computing device 1202. In some aspects, a computing device such as computing device 1224 may include one or more of the types of components as described in connection with computing device 1202 including, but not limited to, a processor such as processor 1204, a connection such as connection 1206, a cache such as cache 1208, a storage device such as storage device 1210, memory such as memory 1214, an input device such as input device 1216, and an output device such as output device 1218. In such aspects, the computing device 1224 can carry out the functions such as those described herein in connection with computing device 1202. In some aspects, the computing device 1202 can be connected to computing devices such as computing device 1224, each of which may also be connected to computing devices such as computing device 1224. Such an aspect may be referred to herein as a distributed computing environment.

The network 1222 can be any network including an internet, an intranet, an extranet, a cellular network, a Wi-Fi network, a local area network (LAN), a wide area network (WAN), a satellite network, a Bluetooth® network, a virtual private network (VPN), a public switched telephone network, an infrared (IR) network, an internet of things (IoT network) or any other such network or combination of networks. Communications via the network 1222 can be wired connections, wireless connections, or combinations thereof. Communications via the network 1222 can be made via a variety of communications protocols including, but not limited to, Transmission Control Protocol/Internet Protocol (TCP/IP), User Datagram Protocol (UDP), protocols in various layers of the Open System Interconnection (OSI) model, File Transfer Protocol (FTP), Universal Plug and Play (UPnP), Network File System (NFS), Server Message Block (SMB), Common Internet File System (CIFS), and other such communications protocols.

Communications over the network 1222, within the computing device 1202, within the computing device 1224, or within the computing resources provider 1228 can include information, which also may be referred to herein as content. The information may include text, graphics, audio, video, haptics, and/or any other information that can be provided to a user of the computing device such as the computing device 1202. In an aspect, the information can be delivered using a transfer protocol such as Hypertext Markup Language (HTML), Extensible Markup Language (XML), JavaScript®, Cascading Style Sheets (CSS), JavaScript® Object Notation (JSON), and other such protocols and/or structured languages. The information may first be processed by the computing device 1202 and presented to a user of the computing device 1202 using forms that are perceptible via sight, sound, smell, taste, touch, or other such mechanisms. In some aspects, communications over the network 1222 can be received and/or processed by a computing device configured as a server. Such communications can be sent and received using PHP: Hypertext Preprocessor (“PHP”), Python™, Ruby, Perl® and variants, Java®, HTML, XML, or another such server-side processing language.

In some aspects, the computing device 1202 and/or the computing device 1224 can be connected to a computing resources provider 1228 via the network 1222 using a network interface such as those described herein (e.g. network interface 1220). In such aspects, one or more systems (e.g., service 1230 and service 1232) hosted within the computing resources provider 1228 (also referred to herein as within “a computing resources provider environment”) may execute one or more services to perform one or more functions under the control of, or on behalf of, programs and/or services operating on computing device 1202 and/or computing device 1224. Systems such as service 1230 and service 1232 may include one or more computing devices such as those described herein to execute computer code to perform the one or more functions under the control of, or on behalf of, programs and/or services operating on computing device 1202 and/or computing device 1224.

For example, the computing resources provider 1228 may provide a service, operating on service 1230 to store data for the computing device 1202 when, for example, the amount of data that the computing device 1202 exceeds the capacity of storage device 1210. In another example, the computing resources provider 1228 may provide a service to first instantiate a virtual machine (VM) on service 1232, use that VM to access the data stored on service 1232, perform one or more operations on that data, and provide a result of those one or more operations to the computing device 1202. Such operations (e.g., data storage and VM instantiation) may be referred to herein as operating “in the cloud,” “within a cloud computing environment,” or “within a hosted virtual machine environment,” and the computing resources provider 1228 may also be referred to herein as “the cloud.” Examples of such computing resources providers include, but are not limited to Amazon® Web Services (AWS®), Microsoft's Azure®, IBM Cloud®, Google Cloud®, Oracle Cloud® etc. In some cases, a point-of-sale service 1234 and/or a merchant computing device 1236 may be available.

Services provided by a computing resources provider 1228 include, but are not limited to, data analytics, data storage, archival storage, big data storage, virtual computing (including various scalable VM architectures), blockchain services, containers (e.g., application encapsulation), database services, development environments (including sandbox development environments), e-commerce solutions, game services, media and content management services, security services, serverless hosting, virtual reality (VR) systems, and augmented reality (AR) systems. Various techniques to facilitate such services include, but are not limited to, virtual machines, virtual storage, database services, system schedulers (e.g., hypervisors), resource management systems, various types of short-term, mid-term, long-term, and archival storage devices, etc.

As may be contemplated, the systems such as service 1230 and service 1232 may implement versions of various services (e.g., the service 1212 or the service 1226) on behalf of, or under the control of, computing device 1202 and/or computing device 1224. Such implemented versions of various services may involve one or more virtualization techniques so that, for example, it may appear to a user of computing device 1202 that the service 1212 is executing on the computing device 1202 when the service is executing on, for example, service 1230. As may also be contemplated, the various services operating within the computing resources provider 1228 environment may be distributed among various systems within the environment as well as partially distributed onto computing device 1224 and/or computing device 1202.

Client devices, user devices, computer resources provider devices, network devices, and other devices can be computing systems that include one or more integrated circuits, input devices, output devices, data storage devices, and/or network interfaces, among other things. The integrated circuits can include, for example, one or more processors, volatile memory, and/or non-volatile memory, among other things such as those described herein. The input devices can include, for example, a keyboard, a mouse, a key pad, a touch interface, a microphone, a camera, and/or other types of input devices including, but not limited to, those described herein. The output devices can include, for example, a display screen, a speaker, a haptic feedback system, a printer, and/or other types of output devices including, but not limited to, those described herein. A data storage device, such as a hard drive or flash memory, can enable the computing device to temporarily or permanently store data. A network interface, such as a wireless or wired interface, can enable the computing device to communicate with a network. Examples of computing devices (e.g., the computing device 1202) include, but is not limited to, desktop computers, laptop computers, server computers, hand-held computers, tablets, smart phones, personal digital assistants, digital home assistants, wearable devices, smart devices, and combinations of these and/or other such computing devices as well as machines and apparatuses in which a computing device has been incorporated and/or virtually implemented.

The techniques described herein may also be implemented in electronic hardware, computer software, firmware, or any combination thereof. Such techniques may be implemented in any of a variety of devices such as general purpose computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods described above. The computer-readable data storage medium may form part of a computer program product, which may include packaging materials. The computer-readable medium may include memory or data storage media, such as that described herein. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices (e.g., a combination of a DSP and a microprocessor), microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for implementing a suspended database update system.

As used herein, the term “machine-readable media” and equivalent terms “machine-readable storage media,” “computer-readable media,” and “computer-readable storage media” refer to media that includes, but is not limited to, portable or non-portable storage devices, optical storage devices, removable or non-removable storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), solid state drives (SSD), flash memory, memory or memory devices.

A machine-readable medium or machine-readable storage medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like. Further examples of machine-readable storage media, machine-readable media, or computer-readable (storage) media include but are not limited to recordable type media such as volatile and non-volatile memory devices, floppy and other removable disks, hard disk drives, optical disks (e.g., CDs, DVDs, etc.), among others, and transmission type media such as digital and analog communication links.

As may be contemplated, while examples herein may illustrate or refer to a machine-readable medium or machine-readable storage medium as a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding, or carrying a set of instructions for execution by the system and that cause the system to perform any one or more of the methodologies or modules of disclosed herein.

Some portions of the detailed description herein may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within registers and memories of the computer system into other data similarly represented as physical quantities within the computer system memories or registers or other such information storage, transmission or display devices.

It is also noted that individual implementations may be described as a process which is depicted as a flowchart, a flow diagram, a data flow diagram, a structure diagram, or a block diagram (e.g., the processes illustrated in FIGS. 10-11, etc.). Although a flowchart, a flow diagram, a data flow diagram, a structure diagram, or a block diagram may describe the operations as a sequential process, many of the operations can be performed in parallel or concurrently. In addition, the order of the operations may be re-arranged. A process illustrated in a figure is terminated when its operations are completed, but could have additional steps not included in the figure. A process may correspond to a method, a function, a procedure, a subroutine, a subprogram, etc. When a process corresponds to a function, its termination can correspond to a return of the function to the calling function or the main function.

In some aspects, one or more implementations of an algorithm such as those described herein may be implemented using a machine learning or artificial intelligence algorithm. Such a machine learning or artificial intelligence algorithm may be trained using supervised, unsupervised, reinforcement, or other such training techniques. For example, a set of data may be analyzed using one of a variety of machine learning algorithms to identify correlations between different elements of the set of data without supervision and feedback (e.g., an unsupervised training technique). A machine learning data analysis algorithm may also be trained using sample or live data to identify potential correlations. Such algorithms may include k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Other examples of machine learning or artificial intelligence algorithms include, but are not limited to, genetic algorithms, backpropagation, reinforcement learning, decision trees, liner classification, artificial neural networks, anomaly detection, and such. More generally, machine learning or artificial intelligence methods may include regression analysis, dimensionality reduction, metalearning, reinforcement learning, deep learning, and other such algorithms and/or methods. As may be contemplated, the terms “machine learning” and “artificial intelligence” are frequently used interchangeably due to the degree of overlap between these fields and many of the disclosed techniques and algorithms have similar approaches.

As an example of a supervised training technique, a set of data can be selected for training of the machine learning model to facilitate identification of correlations between members of the set of data. The machine learning model may be evaluated to determine, based on the sample inputs supplied to the machine learning model, whether the machine learning model is producing accurate correlations between members of the set of data. Based on this evaluation, the machine learning model may be modified to increase the likelihood of the machine learning model identifying the desired correlations. The machine learning model may further be dynamically trained by soliciting feedback from users of a system as to the efficacy of correlations provided by the machine learning algorithm or artificial intelligence algorithm (i.e., the supervision). The machine learning algorithm or artificial intelligence may use this feedback to improve the algorithm for generating correlations (e.g., the feedback may be used to further train the machine learning algorithm or artificial intelligence to provide more accurate correlations).

The various examples of flowcharts, flow diagrams, data flow diagrams, structure diagrams, or block diagrams discussed herein may further be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable storage medium (e.g., a medium for storing program code or code segments) such as those described herein. A processor(s), implemented in an integrated circuit, may perform the necessary tasks.

The various illustrative logical blocks, modules, circuits, and algorithm steps described in connection with the implementations disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

It should be noted, however, that the algorithms and displays presented herein are not inherently related to any particular computer or other apparatus. Various general purpose systems may be used with programs in accordance with the teachings herein, or it may prove convenient to construct more specialized apparatus to perform the methods of some examples. The required structure for a variety of these systems will appear from the description below. In addition, the techniques are not described with reference to any particular programming language, and various examples may thus be implemented using a variety of programming languages.

In various implementations, the system operates as a standalone device or may be connected (e.g., networked) to other systems. In a networked deployment, the system may operate in the capacity of a server or a client system in a client-server network environment, or as a peer system in a peer-to-peer (or distributed) network environment.

The system may be a server computer, a client computer, a personal computer (PC), a tablet PC (e.g., an iPad®, a Microsoft Surface®, a Chromebook®, etc.), a laptop computer, a set-top box (STB), a personal digital assistant (PDA), a mobile device (e.g., a cellular telephone, an iPhone®, and Android® device, a Blackberry®, etc.), a wearable device, an embedded computer system, an electronic book reader, a processor, a telephone, a web appliance, a network router, switch or bridge, or any system capable of executing a set of instructions (sequential or otherwise) that specify actions to be taken by that system. The system may also be a virtual system such as a virtual version of one of the devices that may be hosted on another computer device such as the computer device 802.

In general, the routines executed to implement the implementations of the disclosure, may be implemented as part of an operating system or a specific application, component, program, object, module or sequence of instructions referred to as “computer programs.” The computer programs typically include one or more instructions set at various times in various memory and storage devices in a computer, and that, when read and executed by one or more processing units or processors in a computer, cause the computer to perform operations to execute elements involving the various aspects of the disclosure.

Moreover, while examples have been described in the context of fully functioning computers and computer systems, those skilled in the art will appreciate that the various examples are capable of being distributed as a program object in a variety of forms, and that the disclosure applies equally regardless of the particular type of machine or computer-readable media used to actually effect the distribution.

In some circumstances, operation of a memory device, such as a change in state from a binary one to a binary zero or vice-versa, for example, may include a transformation, such as a physical transformation. With particular types of memory devices, such a physical transformation may include a physical transformation of an article to a different state or thing. For example, but without limitation, for some types of memory devices, a change in state may involve an accumulation and storage of charge or a release of stored charge. Likewise, in other memory devices, a change of state may include a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may include a transformation, such as a physical transformation. Rather, the foregoing is intended as illustrative examples.

A storage medium typically may be non-transitory or include a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting or restricting the subject matter to the precise forms disclosed. Persons skilled in the relevant art can appreciate that many modifications and variations are possible in light of the above disclosure and may be made thereto without departing from the broader scope of the aspects as set forth herein. Numerous specific details are described to provide a thorough understanding of the disclosure. However, in certain instances, well-known or conventional details are not described to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, or any combination of the items in the list.

As used herein, the terms “a” and “an” and “the” and other such singular referents are to be construed to include both the singular and the plural, unless otherwise indicated herein or clearly contradicted by context.

As used herein, the terms “comprising,” “having,” “including,” and “containing” are to be construed as open-ended (e.g., “including” is to be construed as “including, but not limited to”), unless otherwise indicated or clearly contradicted by context.

As used herein, the recitation of ranges of values is intended to serve as a shorthand method of referring individually to each separate value falling within the range, unless otherwise indicated or clearly contradicted by context. Accordingly, each separate value of the range is incorporated into the specification as if it were individually recited herein.

As used herein, use of the terms “set” (e.g., “a set of items”) and “subset” (e.g., “a subset of the set of items”) is to be construed as a nonempty collection including one or more members unless otherwise indicated or clearly contradicted by context. Furthermore, unless otherwise indicated or clearly contradicted by context, the term “subset” of a corresponding set does not necessarily denote a proper subset of the corresponding set but that the subset and the set may include the same elements (i.e., the set and the subset may be the same).

As used herein, use of conjunctive language such as “at least one of A, B, and C” is to be construed as indicating one or more of A, B, and C (e.g., any one of the following nonempty subsets of the set {A, B, C}, namely: {A}, {B}, {C}, {A, B}, {A, C}, {B, C}, or {A, B, C}) unless otherwise indicated or clearly contradicted by context. Accordingly, conjunctive language such as “as least one of A, B, and C” does not imply a requirement for at least one of A, at least one of B, and at least one of C.

As used herein, the use of examples or exemplary language (e.g., “such as” or “as an example”) is intended to more clearly illustrate aspects and does not impose a limitation on the scope unless otherwise claimed. Such language in the specification should not be construed as indicating any non-claimed element is required for the practice of the aspects described and claimed in the present disclosure.

As used herein, where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described above. The elements and acts of the various examples described above can be combined to provide further examples.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further examples of the disclosure.

These and other changes can be made to the disclosure in light of the above Detailed Description. While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

While certain aspects of the disclosure are presented below in certain claim forms, the inventors contemplate the various aspects of the disclosure in any number of claim forms. Any claims intended to be treated under 35 U.S.C. § 112 (f) will begin with the words “means for”. Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various examples given in this specification.

Without intent to further limit the scope of the disclosure, examples of instruments, apparatus, methods and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object including a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples may also relate to an object that is produced by a computing process described herein. Such an object may comprise information resulting from a computing process, where the information is stored on a non-transitory, tangible computer readable storage medium and may include any implementation of a computer program object or other data combination described herein.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

Specific details were given in the preceding description to provide a thorough understanding of various implementations of systems and components for a contextual connection system. It will be understood by one of ordinary skill in the art, however, that the implementations described above may be practiced without these specific details. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail to avoid obscuring the aspects.

The foregoing detailed description of the technology has been presented for purposes of illustration and description. It is not intended to be exhaustive or to limit the technology to the precise form disclosed. Many modifications and variations are possible in light of the above teaching. The described aspects were chosen to best explain the principles of the technology, its practical application, and to enable others skilled in the art to utilize the technology in various aspects and with various modifications as are suited to the particular use contemplated. It is intended that the scope of the technology be defined by the claim.

What is claimed is:

1. A computer-implemented method, comprising:
accessing history data associated with a profile;
generating, using the history data and a machine learning model, a set of options, wherein the generating includes:
providing the history data associated with the profile to the machine learning model; and
receiving, from the machine learning model, the set of options;
receiving, at a computing device, an indication of a selection of an object from the set of options;
identifying detail information associated with the selected object, wherein the detail information includes one or more numerical values; and
encoding a link to the detail information in a machine-readable representation, thereby generating a flexible linked object that is associated with the machine-readable representation.

2. The computer-implemented method of claim 1, further comprising:
receiving, at the computing device, input data including bar code data for an additional object received via a camera of the computing device, wherein the detail information is identified by querying a merchant database using the bar code data.

3. The computer-implemented method of claim 1, further comprising:
associating the flexible linked object with a recipient; and
transmitting, to a recipient device, a communication that associates the flexible linked object with the recipient, wherein when the communication is received at a recipient device, the recipient device extracts the detail information from the machine-readable representation and generates an activation request to activate the flexible linked object, wherein the history data is associated with history information for the recipient device.

4. The computer-implemented method of claim 3, further comprising:
receiving a notification from the recipient device that the recipient device has activated the flexible linked object, wherein when the notification is received from the recipient device; and
updating the flexible linked object based on the notification.

5. The computer-implemented method of claim 1, further comprising:
receiving a second selection of a second object from the set of options; and
identifying second detail information associated with the second object, wherein the second detail information includes a second value; and wherein the link further facilitates access to the second detail information via the machine-readable representation.

6. The computer-implemented method of claim 1, further comprising:
receiving, at the computing device, second input data associated with a second object;
updating the set of options in real-time as the second input data is received to generate and updated set of options using the machine learning model with the second input data; and
generating a user interface including detail information for each object selected from the updated set of options.

7. The computer-implemented method of claim 1, further comprising:
facilitating a transaction associated with the one or more numerical values and the selected object.

8. A system comprising:
memory; and
one or more processors of a serverless cloud-based system coupled to the memory, the one or more processors configured to perform operations comprising:
accessing history data associated with a profile;
generating, using the history data and a machine learning model, a set of options, wherein the generating includes:
providing the history data associated with the profile to the machine learning model; and
receiving, from the machine learning model, the set of options;
receiving, at a computing device, an indication of a selection of an object from the set of options;
identifying detail information associated with the selected object, wherein the detail information includes one or more numerical values; and
encoding a link to the detail information in a machine-readable representation, thereby generating a flexible linked object that is associated with the machine-readable representation.

9. The system of claim 8, wherein the one or more processors are further configured to perform operations comprising:
receiving, at the computing device, input data including bar code data for an additional object received via a camera of the computing device, wherein the detail information is identified by querying a merchant database using the bar code data.

10. The system of claim 8, wherein the one or more processors are further configured to perform operations comprising:
associating the flexible linked object with a recipient; and
transmitting, to a recipient device, a communication that associates the flexible linked object with the recipient, wherein when the communication is received at a recipient device, the recipient device extracts the detail information from the machine-readable representation and generates an activation request to activate the flexible linked object, wherein the history data is associated with history information for the recipient device.

11. The system of claim 10, wherein the one or more processors are further configured to perform operations comprising:
receiving a notification from the recipient device that the recipient device has activated the flexible linked object, wherein when the notification is received from the recipient device; and
updating the flexible linked object based on the notification.

12. The system of claim 8, wherein the one or more processors are further configured to perform operations comprising:
receiving a second selection of a second object from the set of options; and
identifying second detail information associated with the second object, wherein the second detail information includes a second value; and wherein the link further facilitates access to the second detail information via the machine-readable representation.

13. The system of claim 8, wherein the one or more processors are further configured to perform operations comprising:
receiving, at the computing device, second input data associated with a second object;
updating the set of options in real-time as the second input data is received to generate and updated set of options using the machine learning model with the second input data; and
generating a user interface including detail information for each object selected from the updated set of options.

14. The system of claim 8, wherein the one or more processors are further configured to perform operations comprising:
facilitating a transaction associated with the one or more numerical values and the selected object.

15. A non-transitory computer readable storage medium comprising instructions that, when executed by one or more processors of a serverless cloud-based system, cause performance of operations comprising:
accessing history data associated with a profile;
generating, using the history data and a machine learning model, a set of options, wherein the generating includes:
providing the history data associated with the profile to the machine learning model; and
receiving, from the machine learning model, the set of options;
receiving, at a computing device, an indication of a selection of an object from the set of options;
identifying detail information associated with the selected object, wherein the detail information includes one or more numerical values; and
encoding a link to the detail information in a machine-readable representation, thereby generating a flexible linked object that is associated with the machine-readable representation.

16. The non-transitory computer readable storage medium of claim 15, wherein when executed by the one or more processors, the instructions cause performance of operations comprising:
receiving, at the computing device, input data including bar code data for an additional object received via a camera of the computing device, wherein the detail information is identified by querying a merchant database using the bar code data.

17. The non-transitory computer readable storage medium of claim 15, wherein when executed by the one or more processors, the instructions cause performance of operations comprising:
associating the flexible linked object with a recipient; and
transmitting, to a recipient device, a communication that associates the flexible linked object with the recipient, wherein when the communication is received at a recipient device, the recipient device extracts the detail information from the machine-readable representation and generates an activation request to activate the flexible linked object, wherein the history data is associated with history information for the recipient device.

18. The non-transitory computer readable storage medium of claim 17, wherein when executed by the one or more processors, the instructions cause performance of operations comprising:
receiving a notification from the recipient device that the recipient device has activated the flexible linked object, wherein when the notification is received from the recipient device; and
updating the flexible linked object based on the notification.

19. The non-transitory computer readable storage medium of claim 15, wherein when executed by the one or more processors, the instructions cause performance of operations comprising:
receiving a second selection of a second object from the set of options; and
identifying second detail information associated with the second object, wherein the second detail information includes a second value; and wherein the link further facilitates access to the second detail information via the machine-readable representation.

20. The non-transitory computer readable storage medium of claim 15, wherein when executed by the one or more processors, the instructions cause performance of operations comprising:
receiving, at the computing device, second input data associated with a second object;
updating the set of options in real-time as the second input data is received to generate and updated set of options using the machine learning model with the second input data; and
generating a user interface including detail information for each object selected from the updated set of options.
